(19) United States
(12) Patent Application Publication
(10) Pub. No.: US 2017/0061402 A1
(43) Pub. Date: Mar. 2, 2017

(54) SYSTEM AND METHOD FOR FACILITATING WISH ATTAINMENT

(71) Applicant: WishExpress, Inc., Redwood City, CA (US)

(72) Inventors: Farzad MOBIN, PALO ALTO, CA (US); Karl BELLON, PLEASANTON, CA (US)

(21) Appl. No.: 15/008,373

(22) Filed: Jan. 27, 2016

Related U.S. Application Data
(60) Provisional application No. 62/108,061, filed on Jan. 27, 2015.

(51) Int. Cl. G06Q 20/10; G06Q 30/06

(52) U.S. Cl. CPC G06Q 20/102; G06Q 30/0643; G06Q 50/01

(57) ABSTRACT

A system and method for tracking and fulfilling wishes. The method includes receiving a request for a wish and an associated task from a wish receiving user. The wish has a first currency value and the associated task has a second currency value, and wherein the wish receiving user has a plurality of wishes. The method further includes receiving a payment for currency to be assigned to a first account and receiving an indication of completion of the associated task. The method further includes transferring a portion of the currency in an amount of the second currency value from the first account to a second account and determining that the second account has a currency balance that is at least one of greater than and equal to a respective amount of currency associated with each of the plurality of wishes. The method further includes determining that the second account has a currency balance that is at least one of greater than or equal to the first currency value and transferring an amount of the currency associated with the wish to a third account. The method further includes sending payment associated with the selected wish to a merchant of an item associated with the wish for fulfillment.

### RELATED U.S. APPLICATIONS

This application claims the benefit of and priority to the copending provisional patent application, Ser. No. 62/108,061, Attorney Docket Number WISH-0001-00.00US, entitled “SYSTEM AND METHOD TO FACILITATE WISH ATTAINMENT,” with filing date Jan. 27, 2015, which is hereby incorporated by reference in its entirety.

### FIELD

Embodiments of the present invention are generally related to wishes and associated tasks, completion of tasks, and fulfillment of wishes.

### BACKGROUND

As computer systems have advanced, computer systems have become more capable thereby enabling their use in a variety of new areas. Computer systems have been able to make many things more convenient and information more accessible. At the same time, areas such as raising, teaching, and motivating others has remained a challenging area for those in charge. For example, a parent may wish that their child goes to bed at a particular time each day. While the parent may try to tell the child to go to bed each day at the particular time, the child may resist and/or not be motivated to listen to the parent. The parent may try to motivate the child by promising that if the child goes to bed on time for a week, then the parent will buy the child a toy. If the child goes to bed on time for a week, the child expects the toy but the parent may not follow with buying the toy or the parent may find it challenging to get to the toy store due to a busy schedule.

### SUMMARY

Accordingly, what is needed is a solution to allow exchanges of wishes and associated tasks, activities, etc., while allowing tracking and simplified fulfillment.

Embodiments allows for submission of wishes and associated tasks, tracking of accomplishment of the tasks, and fulfillment of wishes. Embodiments further allow transfer of currency upon accomplishment and/or verification of accomplishment of a task associated with a wish. After sufficient currency has been earned, e.g., by a child, for completing one or more tasks, embodiments facilitate fulfillment of the wish by exchanging a predetermined amount of currency for payment to a wish supplier, e.g., merchant, who ships an item associated with the wish. Embodiments thus allow fulfillment of a wish, e.g., a purchase of an item, without placing a burden on others, e.g., a parent.

An embodiment is directed to a method for fulfilling a wish. The method includes receiving a request for the wish and an associated task from a wish receiving user. The wish has a first currency value and the associated task has a second currency value. The method may further include sending a notification to a wish granting user of the wish and the associated task and receiving a payment for currency to be assigned to a first account. The first account is associated with the wish granting user. The method may further include receiving an indication of completion of the associated task and sending a confirmation request associated with the completion of the associated task. The method may further include in response to receiving a confirmation of completion of the associated task, transferring a portion of the currency in an amount of the second currency value from the first account to a second account associated with the wish receiving user and determining if the second account has a currency balance that is at least one of greater than and equal to the first currency value. The method may further include in response to determining that the second account has the currency balance is at least one of greater than and equal to the first currency value, transferring an amount of the first currency value to a third account and sending payment associated with the wish to a supplier of the wish for fulfillment thereof.

In some embodiments, the first account is associated with a parent and the second account is associated with a child. In some embodiments, the supplier is a business and the wish is associated with an item for purchase. In some embodiments, the method further includes publishing the wish and the associated task to a social network. In some embodiments, the wish is associated with an experience. In some embodiments, the sending of the notification of the wish and associated task to the wish granting user further comprises sending a request for approval of the wish and the associated task. In some embodiments, the first value of currency is based on a tax rate, a shipping cost associated with an item, and a price of the item, wherein the item is associated with the wish.

Another embodiment is directed toward a system for facilitating wish fulfillment. The system includes a processor and a wish discovery engine, executing on the processor, configured to receive a wish discovery request and configured to generate in response, to the wish discovery request, a list of wishes that are available from a wish supplier, and configured to receive a wish request from the list of wishes. The system further includes a currency transaction engine, executing on the processor, configured to exchange currency, wherein the currency transaction engine is further configured to transfer currency among a plurality of users and to transfer currency from a user to a wish supplier in exchange for a wish supplier providing a wish to the user, and wherein the wish supplier is a merchant.

In some embodiments, the system further includes a social network component, executing on the processor, configured to receive a wish and configured to publish the wish to a social network. In some embodiments, the user is a child and the wish supplier is an online merchant. In some embodiments, the wish is associated with a task for completion by the child. In some embodiments, the system further includes a tracking engine, executing on the processor, configured to track accomplishment of the task associated with the wish. In some embodiments, the system further includes a suggestion engine, executing on the processor, configured to generate suggestions to aid and encourage desired behavior from the user.

In some embodiments, the currency transaction engine is further configured to transfer currency to the merchant based on a first amount of currency of the user being at least one of greater than or equal to a second amount of currency associated with the wish. In some embodiments, the wish is associated with a physical item. In some embodiments, the system further includes a recommendation engine, executing on the processor, configured to generate a recommended listing of wishes, wherein the listing of wishes comprises a plurality of products that the wish supplier is capable of selling.

An embodiment is implemented as a method for tracking and fulfilling a wish. The method includes receiving a request for a wish and an associated task from a wish receiving user. The wish has a first currency value and the associated task has a second currency value, and wherein the wish receiving user has a plurality of wishes. The method further includes receiving a payment for currency to be assigned to a first account and receiving an indication of completion of the associated task. The method further includes transferring a portion of the currency in an amount of the second currency value from the first account to a second account and determining that the second account has a currency balance that is at least one of greater than and equal to a respective amount of currency associated with each of the plurality of wishes. The method further includes determining that the second account has a currency balance that is at least one of greater than or equal to the first currency value and transferring an amount of the currency associated with the wish to a third account. The method further includes sending payment associated with the selected wish to a merchant of an item associated with the wish for fulfillment.

In some embodiments, the method further includes sending a notification of the wish and the associated task to a user account associated with a parent. In some embodiments, the method further includes sending a confirmation request associated with the completion of the associated task and in response to receiving a confirmation of completion of the associated task, performing the transferring of the portion of the currency in the amount of the second currency value from the first account to the second account. In some embodiments, the method further determining a plurality of wishes that can be fulfilled based on the currency balance of the second account being at least one of greater than or equal to each respective currency value of each of the plurality of wishes and sending a respective indicator for each wish of the plurality of wishes that can be fulfilled. The method further includes receiving a selected wish from the plurality of wishes that can be fulfilled and in response to the selected wish, sending payment to the merchant for fulfillment of the selected wish.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIGS. 1A-K show user interface webpages and a workflow in accordance with one or more embodiments.

FIGS. 2A-E show user interface webpages and a workflow in accordance with one or more embodiments.

FIG. 3 shows a diagram of different views during different stages of redemption, in accordance with one or more embodiments.

FIGS. 4A-D show user interface webpages and a workflow in accordance with one or more embodiments.

FIGS. 5A-E show user interface webpages and a workflow in accordance with one or more embodiments.

FIGS. 6A-B show user interface webpages in accordance with one or more embodiments.

FIGS. 7A-C show user interface webpages and a workflow in accordance with one or more embodiments.

FIGS. 8A-H show user interface webpages and a workflow in accordance with one or more embodiments.

FIGS. 9A-E show user interface webpages and a workflow in accordance with one or more embodiments.

FIGS. 10A-D show user interface webpages and a workflow in accordance with one or more embodiments.

FIGS. 11A-E show a user interface webpage and mobile webpage in accordance with one or more embodiments.

FIGS. 12A-D show user interface webpages and a workflow in accordance with one or more embodiments.

FIGS. 13A-L show user interface webpages and a workflow in accordance with one or more embodiments.

FIGS. 14A-F show a diagram of a workflow in accordance with one or more embodiments.

FIGS. 15A-D show user interface webpages and a workflow in accordance with one or more embodiments.

FIGS. 16A-B show user interface webpages and a workflow in accordance with one or more embodiments.

FIG. 17 shows a legend for user interface webpages in accordance with one or more embodiments.

FIG. 18 shows a user interface webpage including curated content in accordance with one or more embodiments.

FIGS. 19-21 shows a various systems, components, and configurations, in accordance with one or more embodiments.

FIGS. 22A-B show flow diagrams in accordance with one or more embodiments.

FIG. 23 shows an exemplary computer system, in accordance with various embodiments.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments.

### NOTATION AND NOMENCLATURE

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

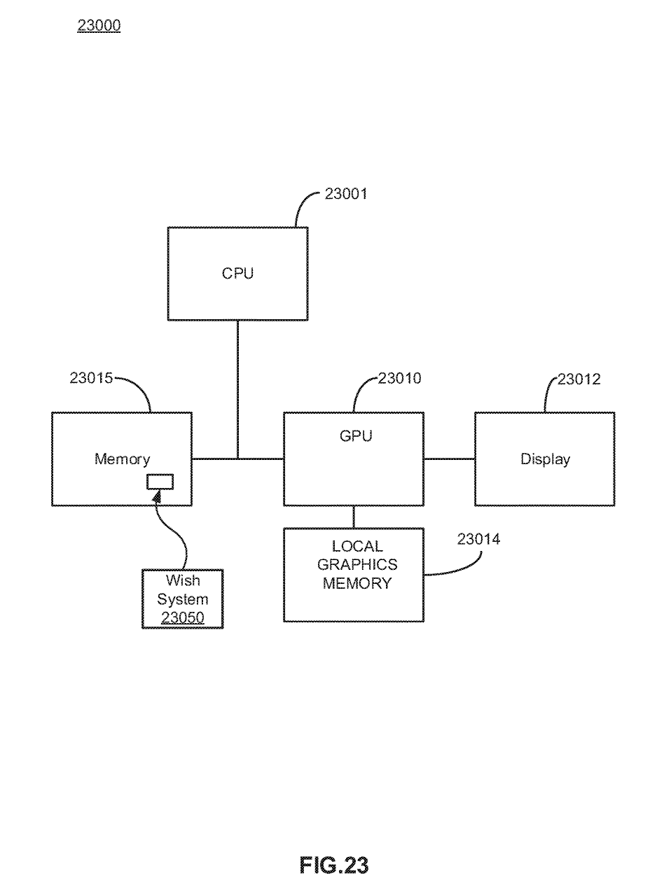

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing,” “determining,” “sending,” “receiving,” “transferring,” “performing,” “accessing,” “executing,” “storing,” or “rendering” or the like, refer to the action and processes of an integrated circuit (e.g., computing system 23000 of FIG. 23), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods for Facilitating Wish Attainment

Embodiments allows for submission of wishes and associated tasks, tracking of accomplishment of the tasks, and fulfillment of wishes. Embodiments further allow transfer of digital currency upon accomplishment and/or verification of accomplishment of a task associated with a wish. After sufficient digital currency has been earned, e.g., by a child, for completing one or more tasks, embodiments facilitate fulfillment of the wish by exchanging a predetermined amount of digital currency for payment to a wish supplier, e.g., merchant, who ships an item associated with the wish. Embodiments thus allow fulfillment of a wish, e.g., a purchase of an item, without placing a burden on others, e.g., a parent.

A user may be desirous of having a wish fulfilled. A wish may be anything a user wants. A wish may be products, consumer goods, retailer credits, and gift cards. A wish may be services, which may include arts, entertainment, travel, dining, etc. A wish may also be favors, assistance, changes by an individual, and activities with an individual. A wish may also be the acquisition of knowledge from classes, lessons, and tutorials. A wish may further be personal betterments and improvements in behavior, and encouragement and strengthening of individuals seeking personal betterments and improvements in behavior.

In general, in one aspect, an embodiment includes a system for fulfilling a wish including a processor and a wish discovery engine executing on the processor and configured to receive from a user, via a user interface, a wish discovery request and configured to generate, in response to a wish discovery request, a list of wishes that may be provided from one or more wish suppliers. The wish discovery engine is further configured to receive from a user, via a user interface, a wish request from the list of wishes. The system further includes a digital currency transaction engine executing on the processor and configured to exchange digital currency. The system further includes a social network application executing on the processor and configured to receive, from the user, one or more wishes and to publish such wishes to a social network having users. The digital currency transaction engine can further be configured to transfer digital currency among users, in response to wish publishing, and to transfer digital currency from a user to a wish supplier in exchange for a wish supplier providing a wish to a user.

In general, in one aspect, an embodiment includes a system for fulfilling a wish including a processor and a wish discovery engine executing on the processor and configured to receive from a user, via a user interface, a description of a task for a user to accomplish and an amount of digital currency desired in exchange for accomplishing the task. The system further includes a social network application executing on the processor and configured to receive, from the user, one or more tasks and digital currency amounts for accomplishment of the one or more tasks and to publish the same to a social network having users. The system further includes a tracking engine executing on the processor and configured to track accomplishment of one or more tasks and to publish the same to the social network having users. The system further includes a digital currency transaction engine executing on the processor and configured to transfer digital currency among users, in response to publishing, and configured to transfer digital currency from a user to a wish supplier in exchange for a wish supplier providing a wish to a user.

In general, in one aspect, an embodiment includes a method for fulfilling a wish including receiving from a user, via a user interface, a wish discovery request, and generating, in response to receiving the wish discovery request, a list of wishes that may be provided by one or more wish suppliers. The method further includes receiving from the user one or more wish requests from the list of wishes and publishing the one or more wish requests to a social network application having users. The method further includes receiving, in response to publishing, and from at least one social network user, a grant of digital currency, and transferring digital currency from a user to a wish supplier in exchange for the wish supplier providing a wish to the user.

In general, in one aspect, an embodiment includes a method for fulfilling a wish including receiving from a user, via a user interface, a task for a user to accomplish and an amount of digital currency desired in exchange for accomplishing the task and publishing a description of one or more tasks and a desired digital currency amount for accomplishment of the one or more tasks to a social network application having users. The method further includes tracking accomplishment of the one or more tasks and publishing the accomplishment to a social network application. The method further includes receiving, in response to publishing, from at least one social network user, a grant of digital currency, and transferring digital currency from a wish receiving user to a wish supplier in exchange for the wish supplier providing a wish to the wish receiving user.

In general, in one aspect, an embodiment includes a non-transitory computer readable storage medium storing instructions for fulfilling a wish, the instructions executable on a processor and including functionality for receiving from a user, via a user interface, a wish discovery request and generating, in response to receiving the wish discovery request, a list of wishes that may be provided by one or more wish suppliers. The instructions further include functionality for receiving from the user one or more wish requests from the list of wishes and publishing one or more wish requests to a social network application having users. The instructions further include functionality for receiving, in response to publishing, and from at least one social network user, a grant of digital currency, and transferring digital currency from a user to a wish supplier in exchange for the wish supplier providing the wish to the user.

In general, in one aspect, an embodiment includes a non-transitory computer readable storage medium storing instructions for fulfilling a wish, the instructions executable on a processor and including functionality for receiving from a user, via a user interface, a description of a task for a user to accomplish and an amount of digital currency desired in exchange for accomplishing the task and publishing one or more tasks and a desired digital currency amount for accomplishment of the one or more tasks to a social network application having users. The instructions further include functionality for tracking accomplishment of the one or more tasks and publishing the accomplishment to a social network application. The instructions further include functionality for receiving, in response to publishing, from at least one social network user, a grant of digital currency, and transferring digital currency from a wish receiving user to a wish supplier in exchange for the wish supplier providing the wish to the wish receiving user.

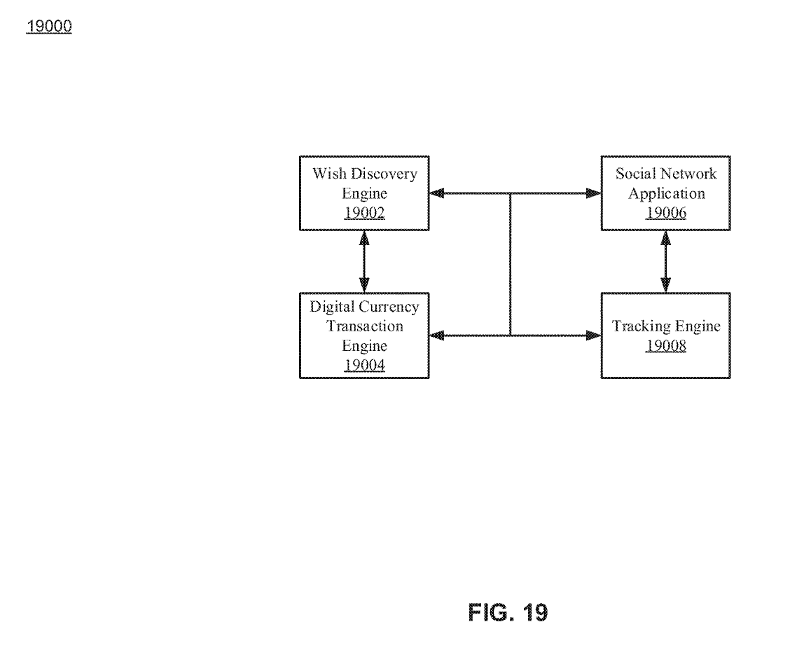

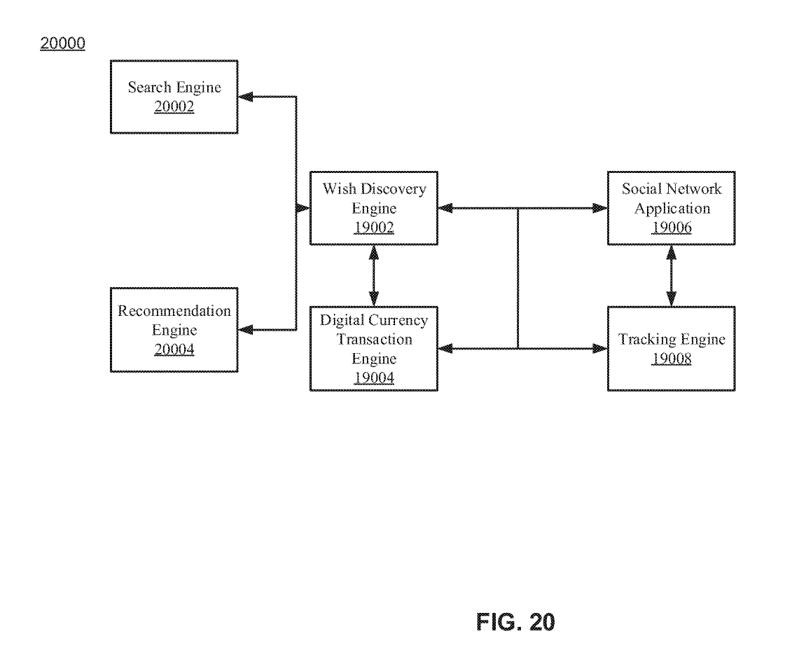

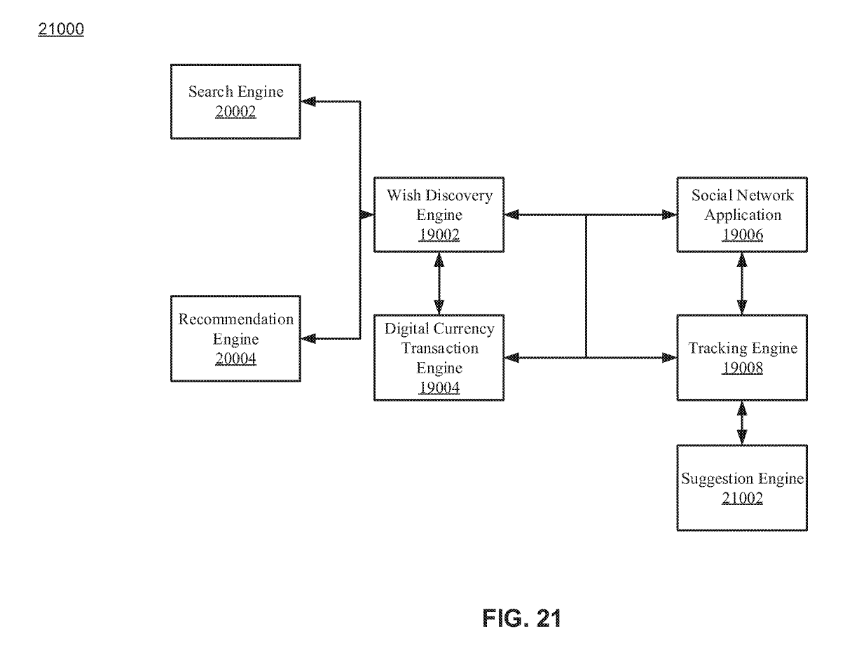

FIGS. 19-21 illustrate exemplary components of various embodiments. Although specific components are disclosed in computing systems 19000-21000, it should be appreciated that such components are examples. That is, embodiments are well suited to having various other components or variations of the components recited in computing system 19000-21000. It is appreciated that the components in computing systems 19000-21000 may operate with other components than those presented, and that not all of the components of systems 19000-21000 may be required to achieve the goals of computing system 19000-21000.

FIGS. 19-21 shows a various systems, components, and configurations, in accordance with various embodiments. The systems 19000-21000 can include components such as: a wish discovery engine 19002 configured to receive a wish discovery request from a wish receiving user and wishes available from a wish supplier, a digital currency transaction engine 19004 configured to transfer digital currency among one or more wish receiving users, wish granting users and wish suppliers, a tracking engine 19008 configured to track user participation in a wish-related task, and a social network application 19006, interfacing with these components to engage prospective wish receiving users and prospective wish granting users, and each of these components being in electronic communication with each other. These components are described below and may be located on the same device (e.g., a server, mainframe, personal computer, mobile computing device, smartphone and any other device). These components may also be located on separate devices connected by a network (e.g., the Internet, a local area network and a wide area network). In one or more embodiments, there may be a plurality of wish receiving users, wish suppliers, and social network application 19006 users (e.g., wish granting users) interfacing with each other to fulfill a plurality of wishes.

Wish Discovery Engine

In one or more embodiments, a wish receiving user engages with a user interface of a wish discovery engine 19002 to discover a wish. Wish entry into the user interface may include web entry, e-mail, SMS, mobile device app, and social network application 19006. The wish discovery engine 19002 comprises mechanisms that allows a user to find and choose wishes from a listing of wishes that may be made available by a wish supplier. A wish supplier may be any entity that may supply a wish, including an online retailer or other merchant whose products and services are listed in an electronic format that may be processed by the wish discovery engine 19002. A wish supplier may be an individual who may list a wish that it will supply by entering the wish into a user interface of the wish discovery engine 19002. Wish entry into the supplier's user interface may include web entry, e-mail, SMS, mobile device app, and social network application 19006.

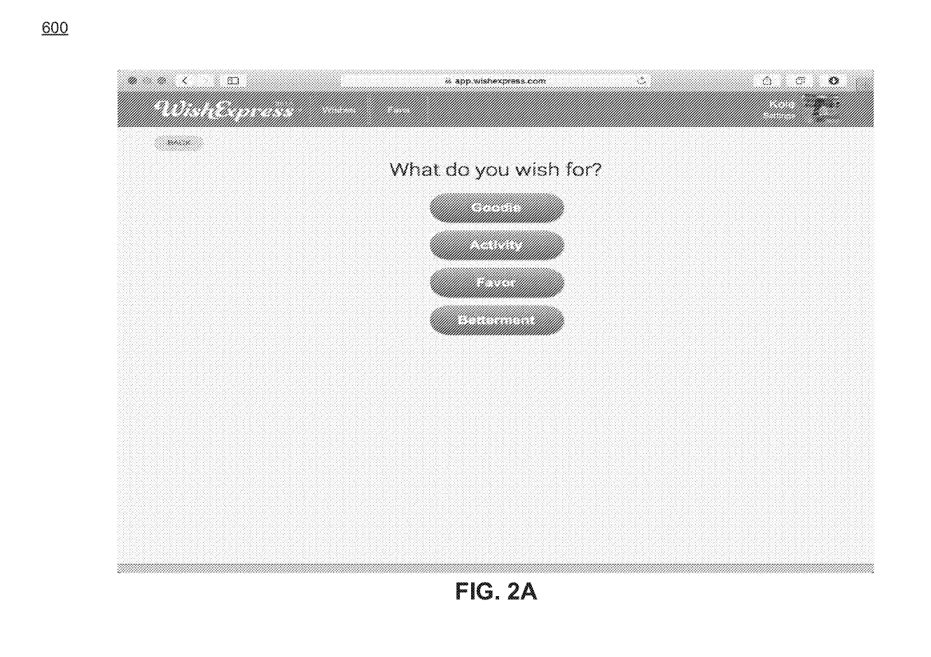

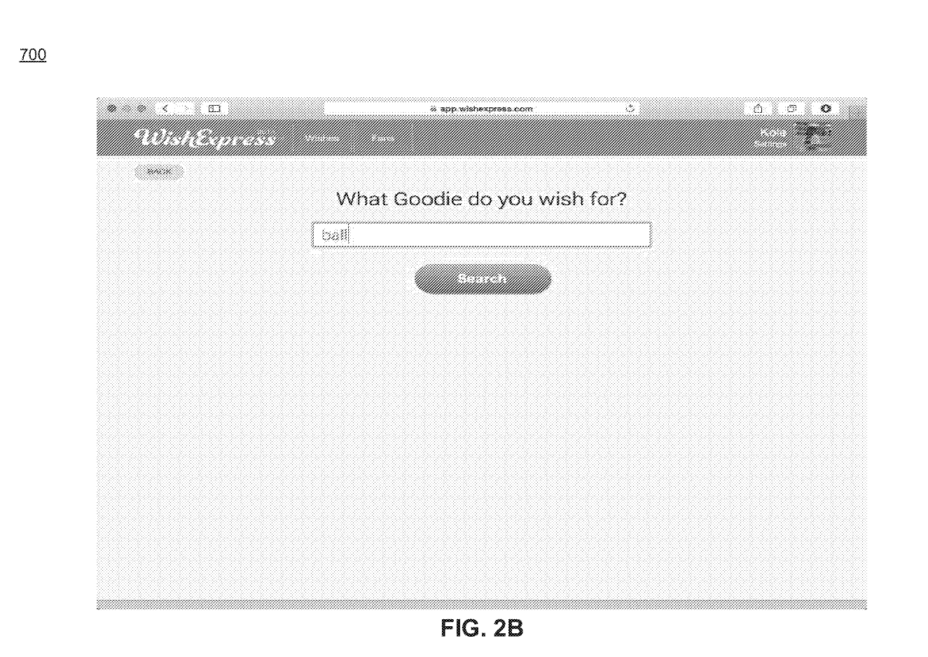

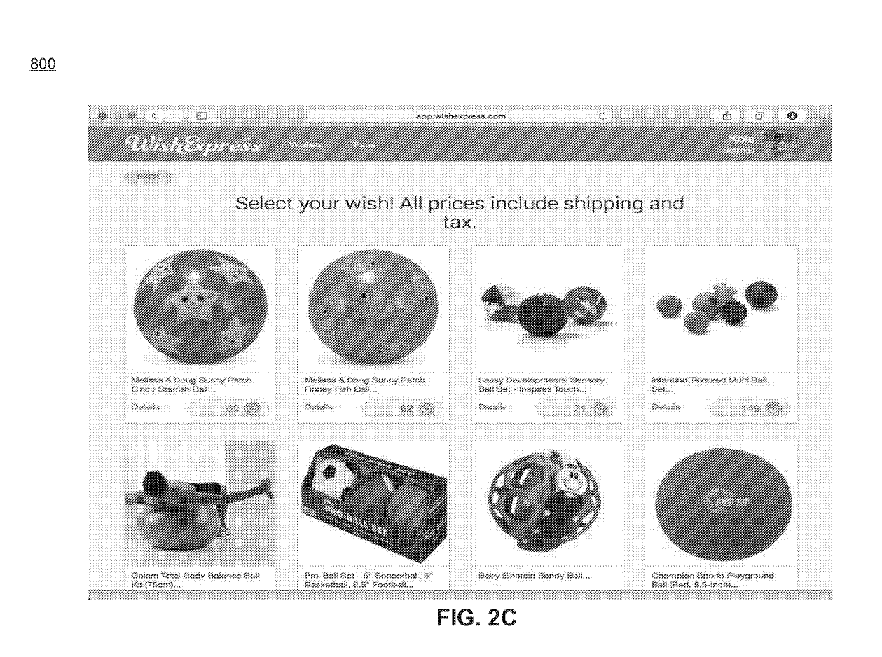

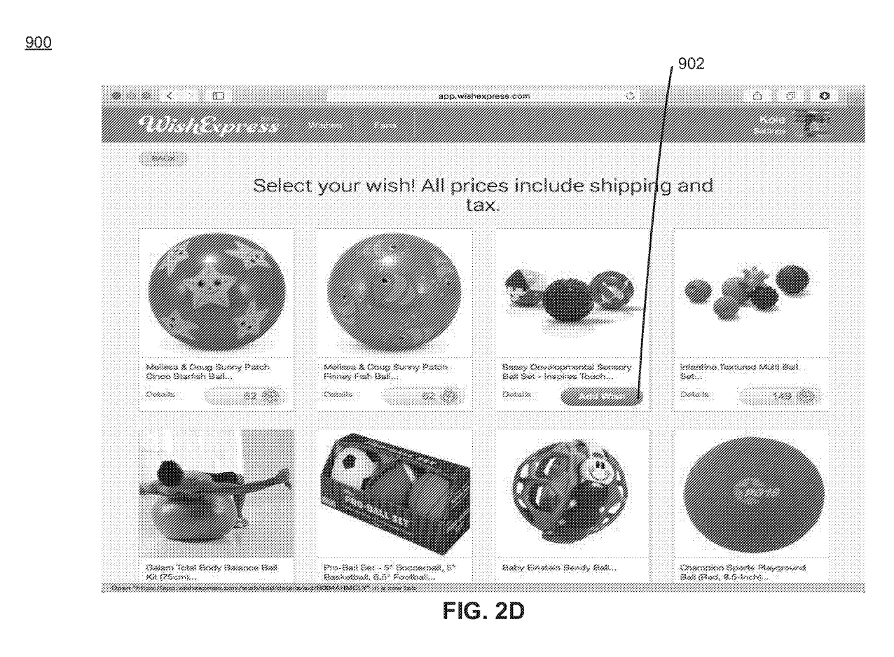

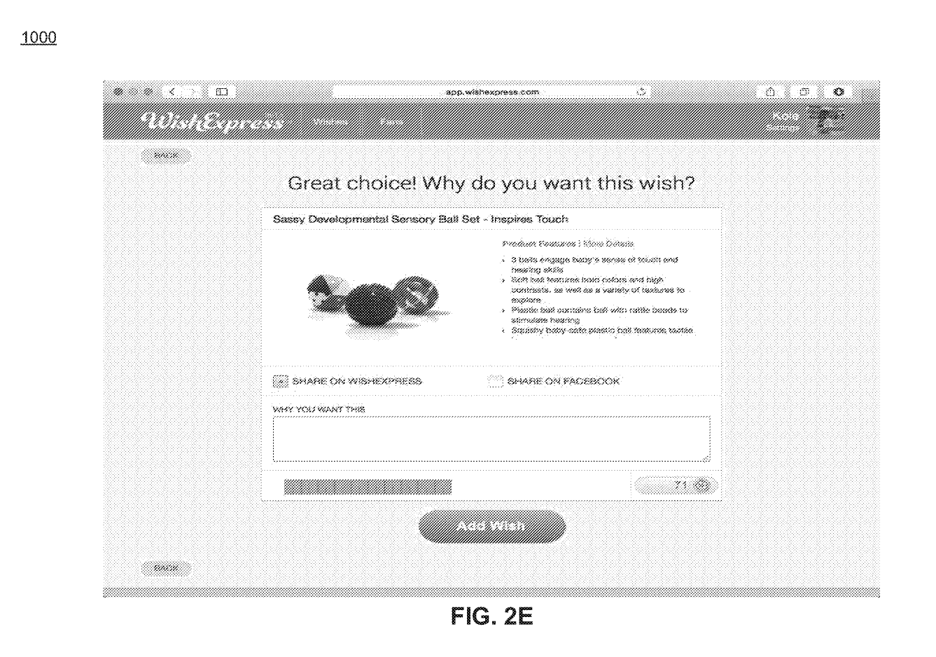

A user interface may interact with a search engine (e.g., the search engine 20002) configured to receive wish search terms entered by the user and search a listing of wishes (e.g., FIG. 2B). A user interface may also interact with a categorized listing of wishes, including but not limited to categories such as ‘most popular wishes,’ ‘top toy wishes,’ and ‘wishes for a better planet.’ A user interface may also interact with a recommendation engine 20004 that may generate a recommended listing of wishes. A listing of wishes may be provided from at least one wish supplier who provides a listing of wishes that it may make available. In one or more embodiments, a user interface may display wish attributes such as images, product, title, cost, description (e.g., FIGS. 2C-E). A user interface may also display a link to a wish supplier's web page and other wish information. Those skilled in the art will appreciate that the wish discovery engine 19002 may receive wish discovery requests and wishes from entities beyond those disclosed and may perform other functions beyond those disclosed.

The user interface may also include a text entry mechanism for wishes that may not be in a listing of wishes. In one or more embodiments, a wish receiving user may enter a wish via a text entry mechanism. The wish receiving user-entered wish may be transmitted through a supplier's user interface to a wish supplier who may choose to supply such a wish at its discretion. In one or more embodiments, the wish discovery engine 19002 may be in electronic communication with other components as dictated by activity, including a digital currency transaction engine 19004, a recommendation engine 20004, a tracking engine 19008, a suggestion engine 21002, and a social network application 19006, such that user interactions with the wish discovery engine 19002 correspond to those with other components.

In one or more embodiments, a recommendation engine 20004 may be configured to work with the wish discovery engine 19002 to recommend a listing of wishes to a user. A recommendation engine 20004 may be configured to generate wish recommendations based upon pattern recognition, machine learning, and data including a wish receiving user's past behavior, a wish receiving user's stated interest, a wish receiving user's interest inferred from data entered (e.g., preferences) and other available data, a wish receiving user's other wishes, a wish receiving user's activities in one or more social networks, and market trends. In one or more further embodiments, a recommendation engine 20004 may be configured to generate wish discovery queries to determine a user's motivations and make wish recommendations to the user. Such queries may include, for example, “where do you want to travel?,” “what bothered you yesterday that you want to fix?,” “what social cause do you care about most?,” “what is your child performing worst at?,” “what do you want to learn how to do?,” “what could you do this week to make your spouse happy?,” and “how do you want to compliment your friend?” In one or more embodiments, a recommendation engine 20004 may be in electronic communication with other components as dictated by activity, including the wish discovery engine 19002, the digital currency transaction engine 19004, the tracking engine 19008, the suggestion engine 21002, and the social network application 19006, such that user interactions with the recommendation engine 20004 correspond to those with other components. Those skilled in the art will appreciate that a recommendation engine 20004 may use criteria and queries beyond those disclosed and may perform other functions beyond those disclosed.

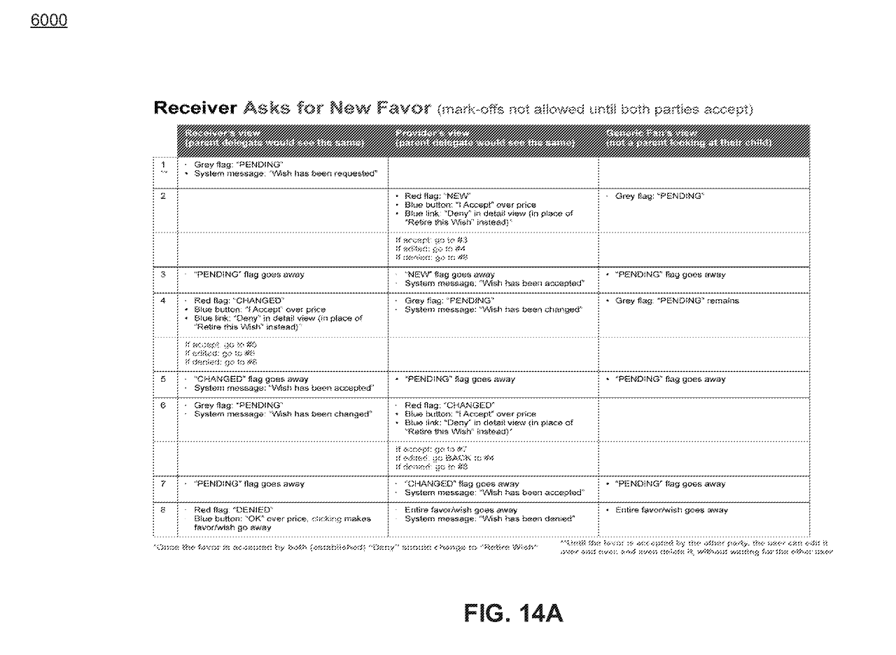

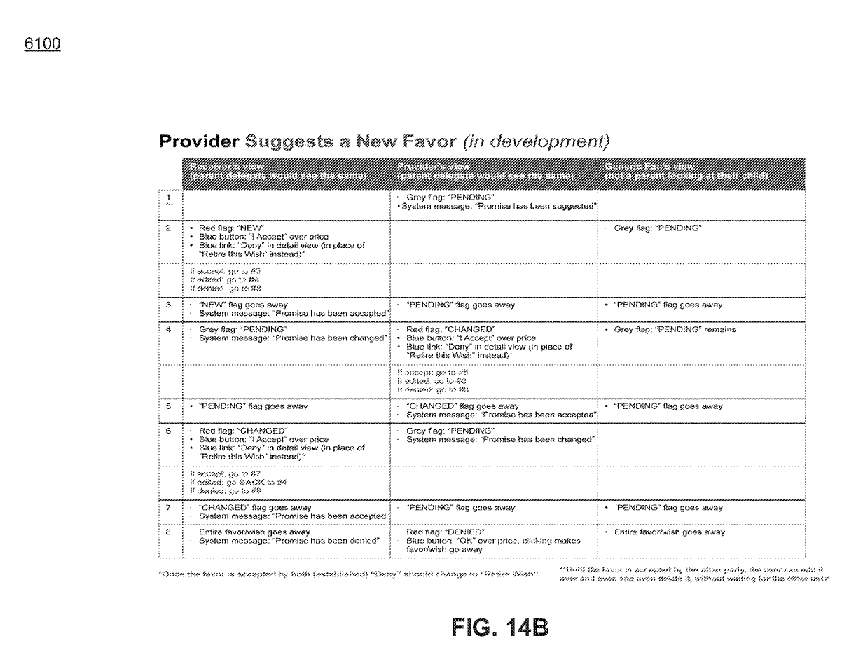

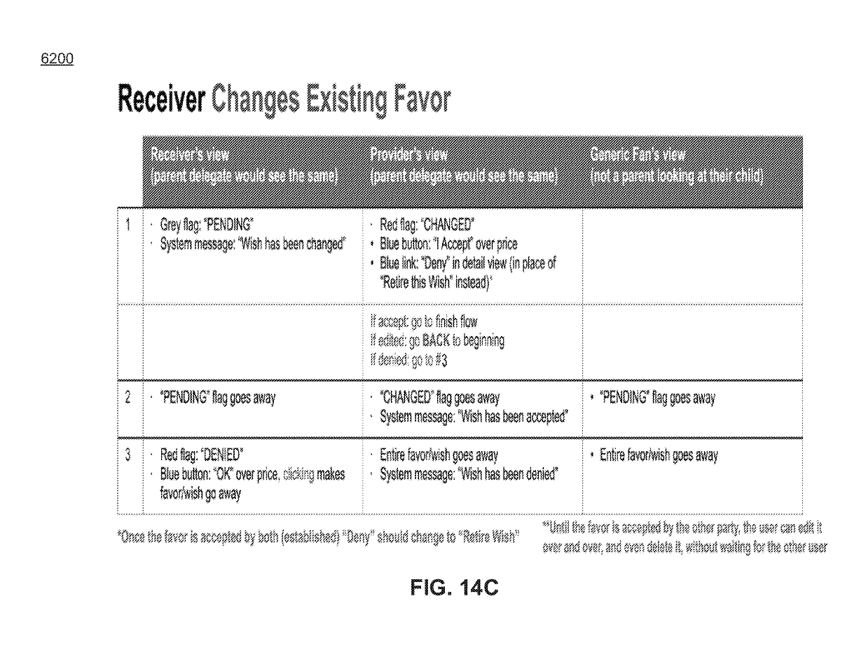

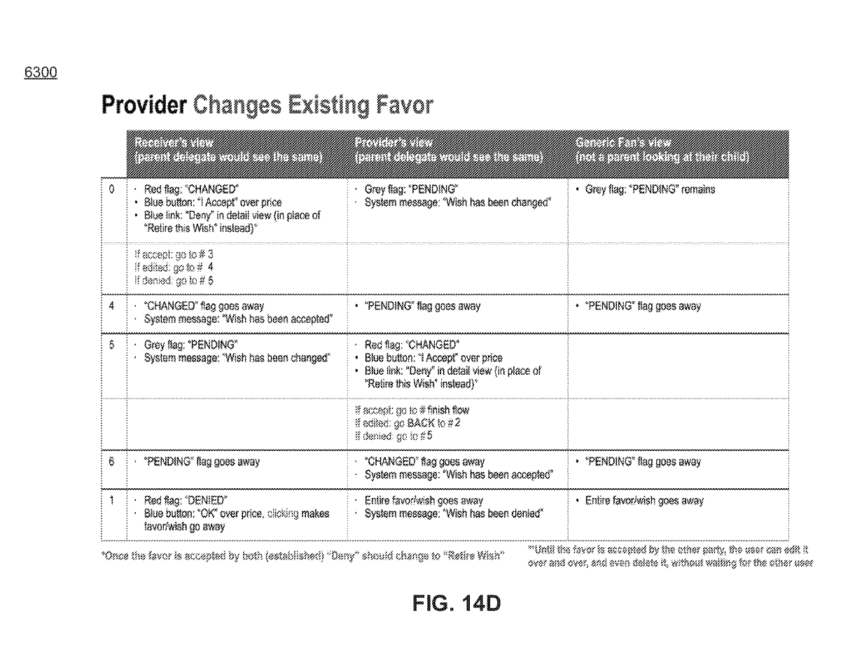

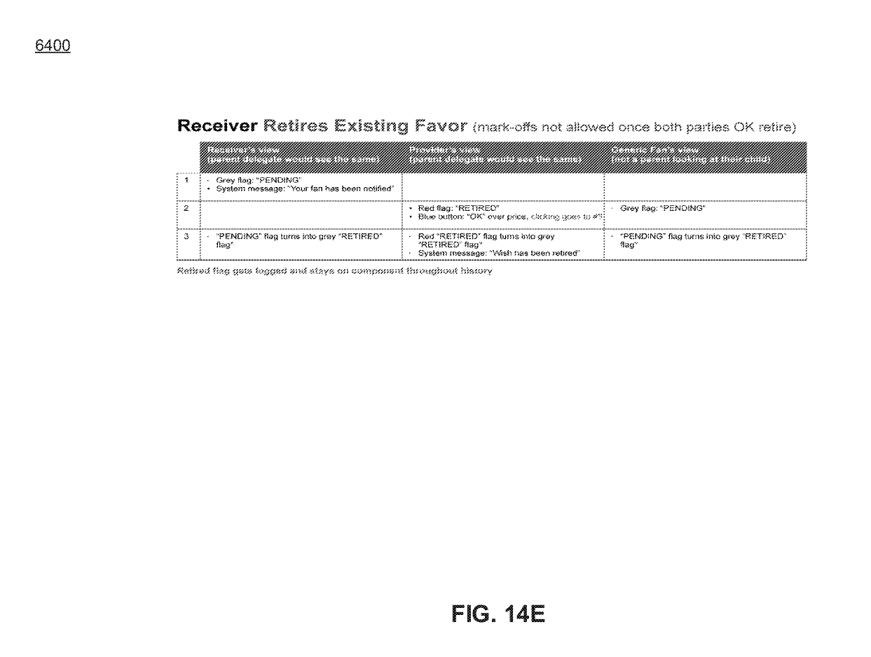

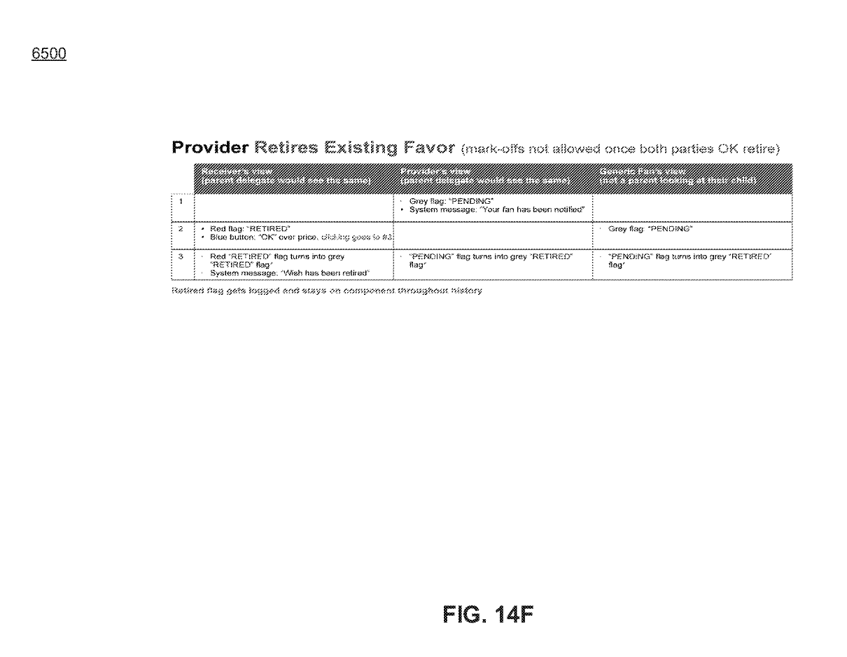

In one or more embodiments, the wish discovery engine 19002 may be configured to facilitate wish negotiation between a wish granting user and a wish receiving user. A wish receiving user may propose a wish that it wants a wish granting user to provide. A wish granting user may propose a task that it wants a wish receiving user to accomplish in exchange for granting a wish. For example, a child may propose a wish for a new toy and a parent may propose a task of the child cleaning his or her bedroom and going to be at a particular time. Negotiation may be facilitated for these users to reach an agreement on wishes to be provided and tasks to be accomplished. FIGS. 14A-F show a workflow and describe user interface views for a wish negotiation. Views and activities are shown for wish receiving users (shown as “receivers”), wish granting users (shown as “providers”), parent delegates for children users, and wish providing users who are not parents of a wish receiving child (shown as “generic fans”). Those skilled in the art will appreciate that the wish discovery engine 19002 may perform other negotiation functions beyond those disclosed.

Digital Currency Transaction Engine

In one or more embodiments, a digital currency transaction engine 19004 is configured to exchange digital currency for a wish. The digital currency transaction engine 19004 may also be configured to exchange a digital system currency between wish receiving users and wish granting users within the system. The digital currency transaction engine 19004 may be configured to have accounts for exchanging digital currency between wish suppliers, wish receiving users and wish granting users. Digital system currency may be stored value. Stored value is funds or monetary value represented in digital electronics format (whether or not specially encrypted) and stored or capable of storage on electronic media in such a way as to be retrievable and transferable electronically. Digital system currency may be purchased using payment services including credit card, debit card, money transfer and online payment services. In one or more embodiments, the digital system currency may also have no monetary value.

Digital system currency may be purchased by a wish granting user and held in an account within or managed by the digital currency transaction engine 19004. A wish granting user may transfer digital system currency from its account to a wish receiving user via a user account within the engine. A wish granting user may transfer digital system currency to a wish receiving user because the wish receiving user earned digital system currency by accomplishment of a task that a wish granting user desires to support, e.g., passing a class, completing a chore, achieving a goal. An amount of digital system currency transferred may correspond to a portion of task that has been accomplished. For example, a parent may transfer digital system currency to a child for getting a high grade on a math test. A wish granting user may also gift digital system currency to a wish receiving user, transferring digital system currency to a wish receiving user without need of participation in a task. A wish granting user may gift any amount of digital system currency, including an amount sufficient to exchange outright for a wish. A plurality of wish granting users may transfer digital currency to a wish receiving user, e.g., crowdfunding or other family members. A wish receiving user may also purchase digital system currency itself to exchange for a wish.

The digital currency transaction engine 19004 may further be configured to convert a digital system currency into a currency that may be exchanged outside of the system, including national and multinational currencies, Bitcoin and other exchangeable monetary mediums. The digital currency transaction engine 19004 may exchange an amount of digital system currency for a wish by a wish receiving user designating a wish discovered through the wish discovery engine 19002 and accumulating sufficient digital system currency in a user account to purchase the wish, where on instruction from a user, the digital currency transaction engine 19004 exchanges digital system currency for a currency acceptable by a wish supplier, transfers the acceptable currency to the wish supplier via payment services including wire transfer, online payment system, electronic funds transfer and credit card, completing the purchase of the wish, which is then fulfilled by the wish supplier. The digital currency transaction engine 19004 may further be configured to accept instruction for purchase of a wish before a wish receiving user account has sufficient digital system currency to do, and to make such purchase without further input once the account has sufficient digital system currency to make the purchase. In one or more embodiments, the digital currency transaction engine 19004 may be in electronic communication with other components as dictated by activity, including the wish discovery engine 19002, the recommendation engine 20004, the tracking engine 19008, the suggestion engine 21002 and the social network application 19006, such that user interactions with the digital currency transaction engine 19004 correspond to those with other components. Those skilled in the art will appreciate that the digital currency transaction engine 19004 may perform other functions beyond those disclosed.

Tracking Engine

In one or more embodiments, a tracking engine 19008 records a wish receiving user's accomplishment of a task and accomplishment of a portion of a task. The tracking engine 19008 may be configured to allow a wish receiving user to enter an accomplishment of its own and a wish granting user to enter an accomplishment of a wish receiving user. The tracking engine 19008 may also be configured so that a wish granting user may approve an entry of an accomplishment by a wish receiving user (e.g., as a confirmation that a wish receiving user is actually accomplishing a task). The tracking engine 19008 may track accomplishments of portions of tasks through accomplishment of an entire task. The tracking engine 19008 may communicate with a digital currency transaction engine 19004 to permit and instruct transfer of digital system currency from a wish granting user account to a user account upon entry of an accomplishment of a task or a portion of a task. In one or more embodiments, a task may be renewed such that the tracking engine 19008 will track a wish receiving user accomplishing the task again. In one or more embodiments, the tracking engine 19008 may be in electronic communication with other components as dictated by activity, including the wish discovery engine 19002, digital currency transaction engine 19004, recommendation engine 20004, suggestion engine 21002 and social network application 19006, such that user interactions with the tracking engine 19008 correspond to those with other components. Those skilled in the art will appreciate that a tracking engine 19008 may perform other functions beyond those disclosed.

Social Network Application

In one or more embodiments, a social network application 19006 having user interfaces or interfaces with other components to engage social network users who are prospective wish receiving users and prospective wish granting users, resulting in at least a wish receiving user and a wish granting user interacting within the invention. The social network application 19006 may be internal with the other components of the system. The social network application 19006 may also be an external application including but not limited to Facebook available from Facebook, Inc. of Menlo Park, Calif., Google+ available from Google, Inc. of Mountain View, Calif., Twitter available from Twitter, Inc. of San Francisco, Calif., Pinterest available from Pinterest, Inc. of San Francisco, Calif. and LinkedIn available from LinkedIn, Inc. of Mountain View, Calif.

Engagement of social network users may be via invitation across the social network application 19006. A wish receiving user may invite a social network user to be a wish granting user, requesting that a prospective wish granting user transfer digital currency to the wish receiving user for its wish request. A wish granting user may invite a social network user to be a wish receiving user, requesting that a prospective wish receiving user accomplish a task for a transfer of digital currency. A wish receiving user may also invite a social network user to see a list of wish receiving user's wish requests for which it may transfer digital currency. The system may be configured such that a wish receiving user may also be a wish granting user towards other wish receiving users and that a wish granting user may be a wish receiving user towards other wish granting users. Engagement of social network users may also be via a wish receiving user posting wish information on the social network application 19006 as a notice of a wish and a notice of a task to be accomplished by a wish receiving user. Such notice posting may be an open invitation to a plurality of social network users to become a wish granting user. Wish information may include a wish request, a list of wishes and recently achieved wishes, and a reason why a wish is desired. In one or more embodiments, the social network application 19006 may be in electronic communication with other components as dictated by activity, including the wish discovery engine 19002, the digital currency transaction engine 19004, the recommendation engine 20004, the suggestion engine 21002 and the tracking engine 19008, such that user interactions with the social network application 19006 correspond to those with other components. Those skilled in the art will appreciate that the social network application 19006 may perform other functions beyond those disclosed.

Social Network Public Profile Including Wishes

In one or more embodiments, the social network application 19006 may be configured to display a public wish profile of a wish receiving user that is accessible by social network users. A public wish profile may include at least one wish desired by a wish receiving user. A public wish profile may also include at least one task a wish receiving user is willing to accomplish and has accomplished. A public wish profile may also include background information of the wish receiving user, reasons why a wish receiving user desires having a wish granted. A social network user may become a wish granting user by virtue of being a friend, family member, colleague and other fan of a wish receiving user that has some form of relationship with the wish receiving user. A social network user who is a stranger to a wish receiving user may become a wish granting user by virtue of being impressed with a wish desired, background of a wish receiving user, reasons why a wish is desired, content posted by a wish receiving user and actions taken by a wish receiving user. In one or more embodiments, the wish discovery engine 19002 in communication with the social network application 19006 may be configured to recommend that a social network user with similar interests to a wish receiving user become a wish granting user for that wish receiving user. Those skilled in the art will appreciate that the social network application 19006 and wish discovery engine may perform functions beyond those disclosed.

Features to Encourage Task Accomplishment and Wish Fulfillment

Wish Gamification

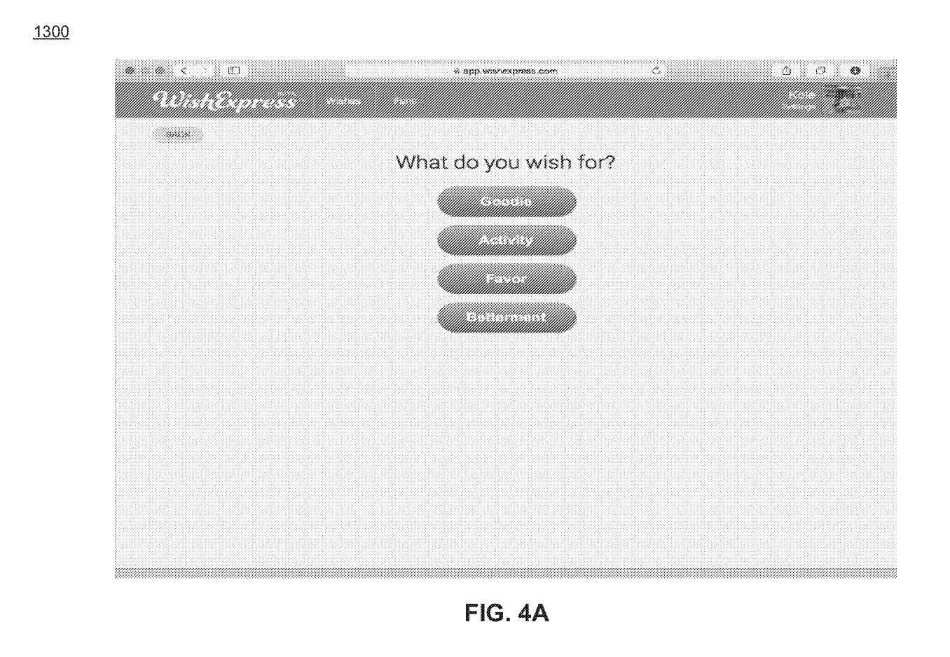

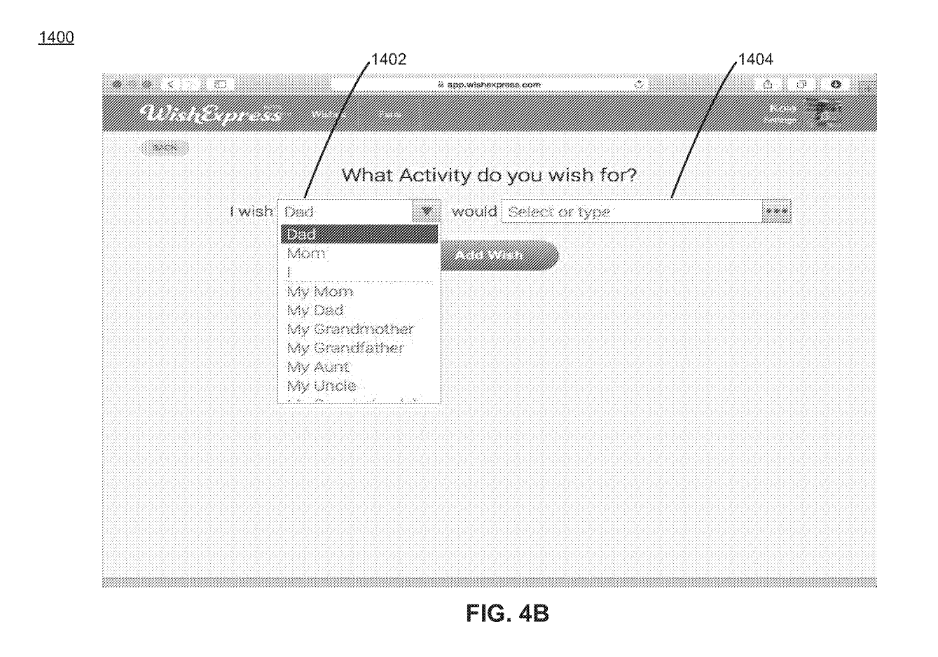

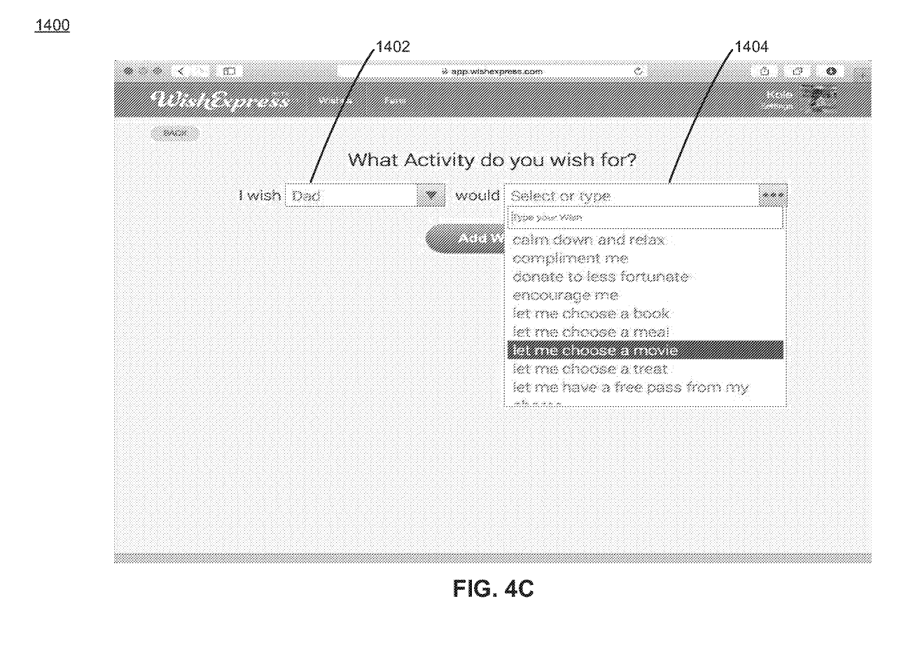

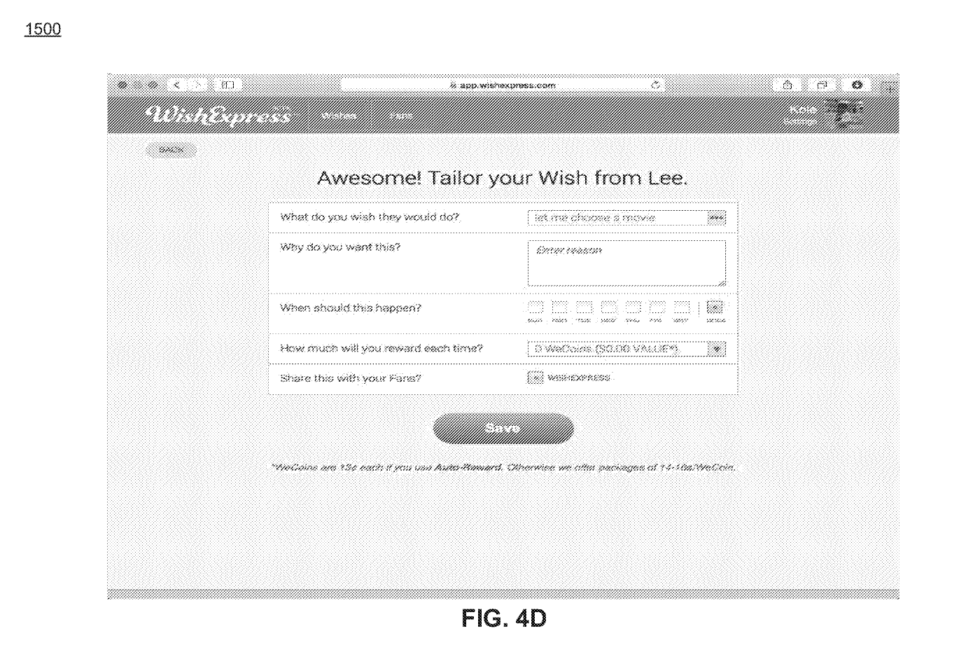

In one or more embodiments, the system may employ wish fulfillment gamification to encourage desired behavior from a wish receiving user, e.g., to accomplish tasks, engage in personal betterments and undertake improvements in behavior (e.g., FIGS. 4A-D). Gamification is the application of game design, game thinking and game mechanics in non-game contexts to make them fun and engaging and encourage user participation. The tracking engine 19008 may be configured to gamify task accomplishment data, such that accomplishing a task is like winning a game. The tracking engine 19008 may be further configured to track quality of performance of a task and portion of a task. Quality of performance data may include time and date, percentage completion of a task, letter grades (A, B, C, D, E, and/or F), numerical ranking (1-10), and text descriptions. The tracking engine 19008 may be configured to receive quality of performance data from a wish receiving user via a user interface for self-tracking of user's performance of a task or portion of a task. The tracking engine 19008 may also be configured to receive quality of performance data from a wish granting user via a user interface for tracking a wish receiving user's performance of a task and a portion of a task. In one or more embodiments, a wish receiving user is a child and a wish granting user is an adult with a responsible relationship with the child, including parent and guardian.

The recommendation engine 20004 may be configured to make behavioral recommendations to a wish receiving user and a wish granting user based upon analyzing quality of performance of a task and portion of a task, to aid accomplishment of a task and portion of a task. Quality of performance criteria may include time, completeness, and effort. The recommendation engine 20004 may also be configured to make behavioral recommendations to a wish receiving user and a wish granting user based upon analyzing quality of performance of a task and portion of a task, indicating when a task has been sufficiently accomplished to achieve a desired behavior. The recommendation engine 20004 may be configured to gamify task accomplishment data, such that accomplishing a task is like winning a game. In one or more embodiments, the recommendation engine 20004 may analyze quality of performance of a task and for low grades and ratings (e.g., C, D, E, 1-7) for quality of performance may generate suggestions for both the wish receiving user and the wish granting user to aid in raising grades and ratings. The recommendation engine 20004 may also analyze quality of performance of a task and for high grades and ratings (e.g., A, B, 8-10) for quality of performance may generate a recommendation that a task be retired and recommendations for other tasks to be performed. The recommendation engine 20004 may also be configured to aggregate user profile data, task data including quality of performance data, display it to a wish granting user for benchmarking (e.g., wish per average age) and generate suggestions (e.g., curated content, tips, etc.) to aid in accomplishment of a task or portion of a task. Those skilled in the art will appreciate that the tracking engine 19008 and the recommendation engine 20004 may perform other gamification functions beyond those disclosed.

Wish and Task Expiration

In one or more embodiments, the wish discovery engine 19002 and the tracking engine 19008 may be configured such that a wish and a task may be active indefinitely and set to expire after a triggering criterion has been met. A wish may be set to expire after a triggering criterion of a set period of time has elapsed. A task may be set to expire after a triggering criterion of a set period of time has elapsed. A set period of time may include a user determined expiration date and an expiration date based upon a wish no longer being available (e.g., tickets to a specific sporting event that occurs on a specific date). A task may also be set to expire after a triggering criterion of being accomplished one or more times has been met. Another triggering criterion may be unavailability of a wish (e.g., a product that is sold out). In one or more embodiments, the wish discovery engine 19002 and the tracking engine 19008 may be configured to recommend a triggering criterion via a user interface. For example, if a task from a wish receiving user is brushing teeth, a recommendation that the task expire may be generated after 30 consecutive accomplishments of the task, because at this point a wish receiving user has developed a desired behavior of daily brushing their teeth. In one or more embodiments, the wish discovery engine 19002 and the tracking engine 19008 may be configured to provide, via a user interface, notification of wish and task expiration related information including time of expiration, encouragement to finish a task, a suggestion on how to accomplish a task, and a suggestion to pick a new wish. Those skilled in the art will appreciate that the wish discovery engine 19002 and the tracking engine 19008 may be configured to perform other functions beyond those disclosed.

Commenting

In one or more embodiments, the wish discovery engine 19002 and the social networking application 19006 may be configured to facilitate messaging between wish granting users and wish receiving users. A first configuration may send messages directly between users. Another configuration may post comments from a wish receiving user on a webpage viewable by wish granting users and potential wish granting users as a social network community type of communication. Yet another configuration may post comments from a wish receiving user on a webpage viewable on a public network, e.g., the Internet. Comments may include encouragement to accomplish a task and fulfill a wish, congratulations for a task accomplishment, and congratulations for an occasion such as a birthday, graduation and holiday. Comments may further include reviews of wishes that are products and services and questions pertaining to wishes. Those skilled in the art will appreciate the wish discovery engine 19002 and the social networking application 19006 may be configured to facilitate communication between users in manners beyond those disclosed.

Happiness Level

In one or more embodiments, the wish discovery engine 19002 may be configured to collect a wish receiver's degree of happiness. A degree of happiness may be based on a multi-level scale represented in emoticons (e.g., frown, neutral, smile, laugh, etc.). Degree of happiness measurements may be taken when a user:

1.) adds a wish: querying a user's expected level of happiness if they were to receive the wish;

2.) receives/is receiving a wish: querying a user's level of happiness as they get the wish;

3.) is looking back after receiving a wish: querying a user's level of happiness long after they received the wish (e.g., 12 months later).

Degree of happiness measurements may be provided to a user to help them understand what truly brings them joy in the long term, and may be provided to a plurality of users anonymously as wish reviews to provide an idea of the degree of happiness that a specific wish may bring. Those skilled in the art will appreciate the wish discovery engine 19002 may be configured to collect other user emotional responses to wishes in manners beyond those disclosed.

Suggestion Engine to Aid Wish Achievement

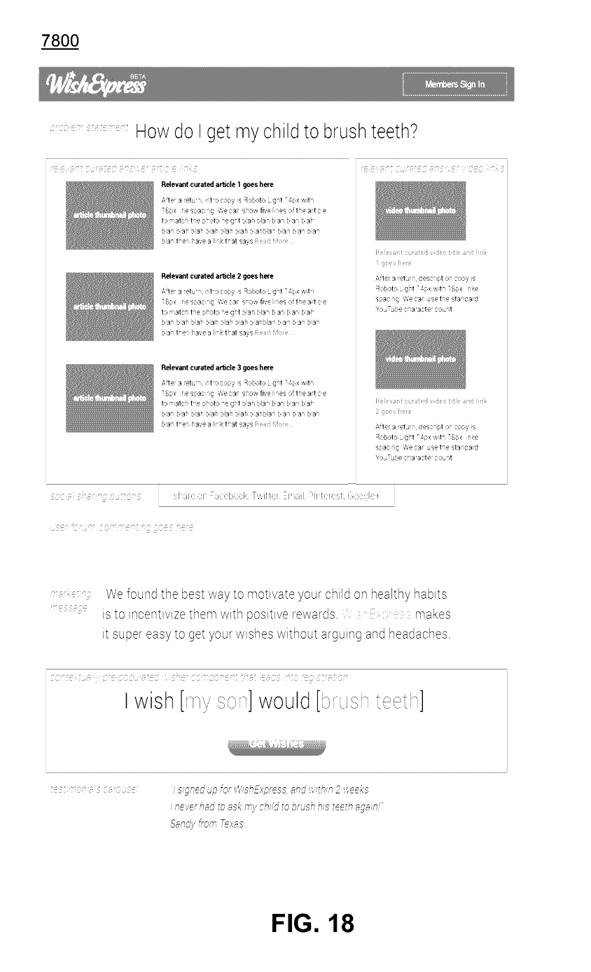

In one or more embodiments, the suggestion engine 21002 may be configured to generate suggestions to aid and encourage desired behavior from a wish receiving user, e.g., to accomplish tasks, engage in personal betterments and undertake improvements in behavior. The suggestion engine 21002 may be configured to generate suggestions on how to optimize efforts to accomplish a task including hints, tips, tricks, how-to instructions and reminder notifications. The suggestion engine 21002 may be further configured to generate suggestions in a format that can be displayed to a user via a user interface, including landing pages, videos, articles, professional advice, text, graphics, and visualizations of collected anonymous user data. The suggestion engine 21002 may be still further configured to generate suggestions in the form of curated content. The suggestion engine 21002 may be additionally configured to receive suggestion information from a user of the system for display to another user via a user interface. Suggestion information may be in the form of a testimonial. The suggestion engine 21002 may be still additionally configured to receive suggestion information from the social network application 19006 having users, such that suggestions are generated by social network users and displayed to a user of the system via a user interface. FIG. 18 shows a user interface webpage including a landing page for a suggestions on how to have a wish receiving user complete a task, “How do I get my child to brush his teeth,” links to curated articles and video suggestions and user testimonials. It also shows functionality to share suggestions across one or more social network applications and e-mail, and to post comments to a forum of users. In this embodiment, a parent is acting as a delegate for a wish receiving user child in that the parent is seeing the suggestions on how the child can accomplish a task. In another embodiment, a trick may be suggested. For example, if a task is “keeping your room clean,” a trick of “never leave anything on the floor” may be suggested to the wish receiving user to help them accomplish the task. Table II (below) shows an exemplary spreadsheet of task and wishes, described as “favors,” that may be used to generate suggestions in the form of curated content.

In one or more embodiments, the suggestion engine 21002 may be in electronic communication with other components as dictated by activity, including the wish discovery engine 19002, the digital currency transaction engine 19004, the recommendation engine 20004, the tracking engine 19008, and the social network application 19006, such that user interactions with the suggestion engine 21002 correspond to those with other components. Those skilled in the art will appreciate that the suggestion engine 21002 may perform other functions beyond those disclosed.

Digital System Currency without Monetary Value Configuration

In one or more embodiments, a digital system currency may have no monetary value. In one or more embodiments where gamification is employed to encourage desired behavior from a wish receiving user, e.g., to accomplish tasks, engage in personal betterments and undertake improvements in behavior, the digital system currency may not have monetary value and may not be converted into a currency that may be exchanged outside of the system. A wish granting user may transfer digital system currency not having monetary value from its account to a wish receiving user via a user account within the engine. A wish granting user may transfer digital system currency to a wish receiving user because the wish receiving user earned digital system currency not having monetary value by accomplishment of a or a portion of a task that a wish granting user desires to support, e.g., passing a class, completing a chore, achieving a goal. The digital system currency not having monetary value may represent units of scoring in a game where accomplishment of tasks, engagement in personal betterments and improvements in behavior are done to win the game.

Trial Configuration

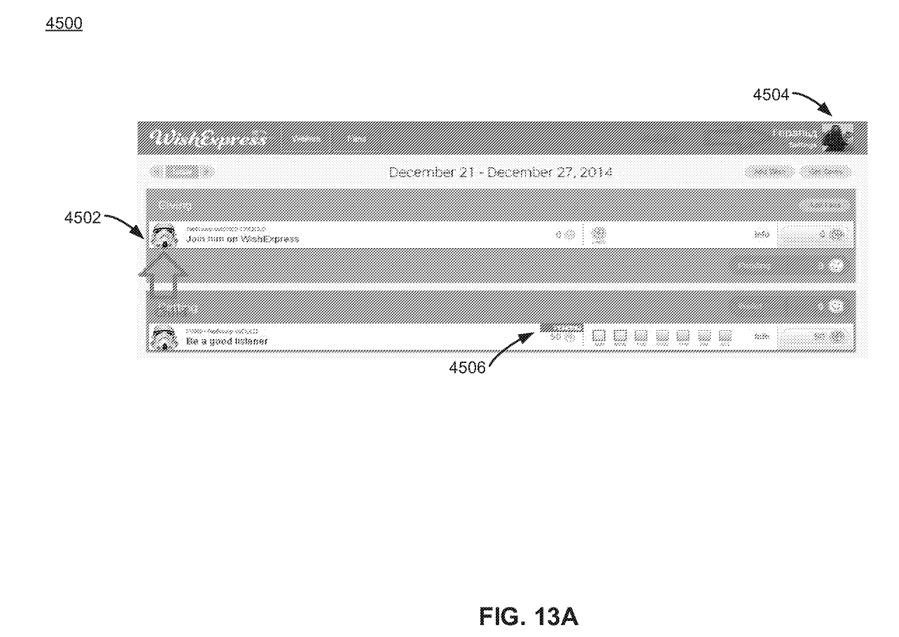

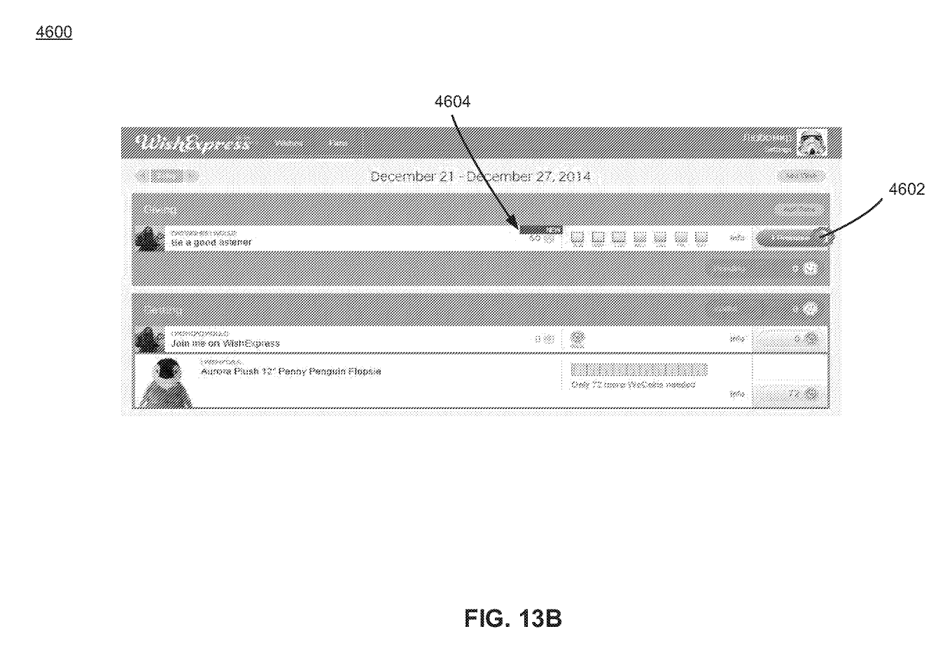

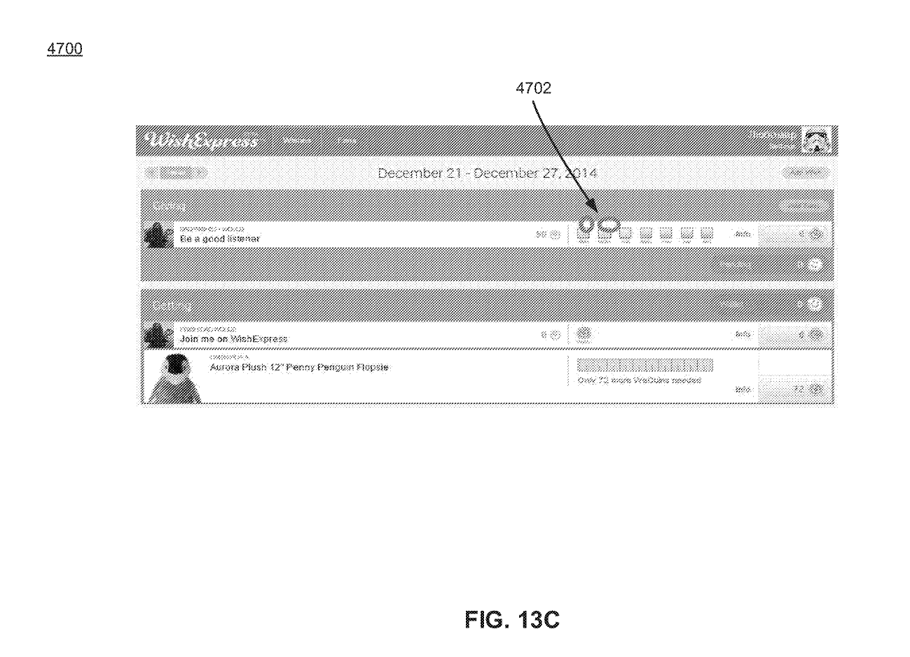

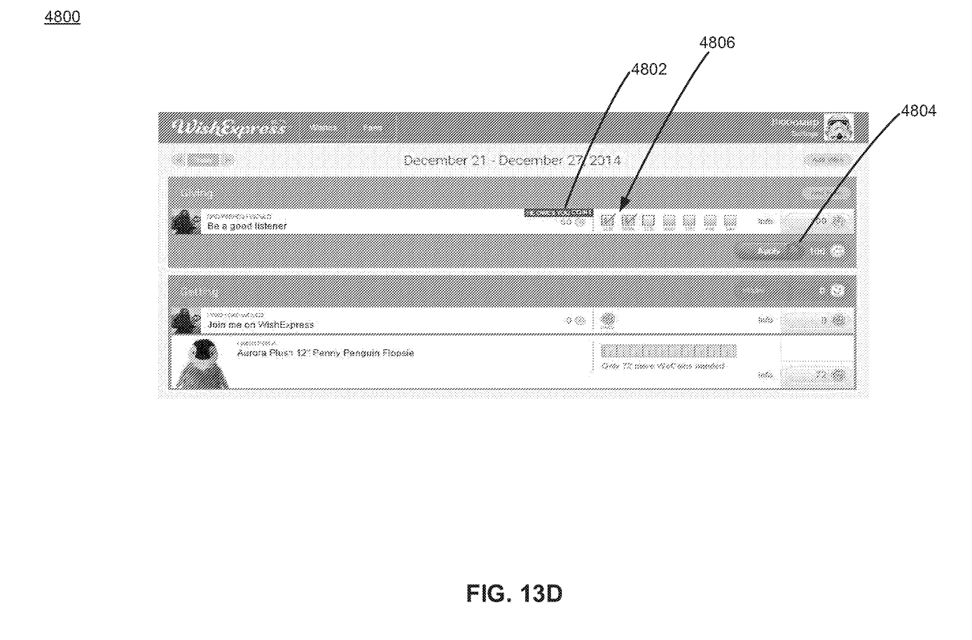

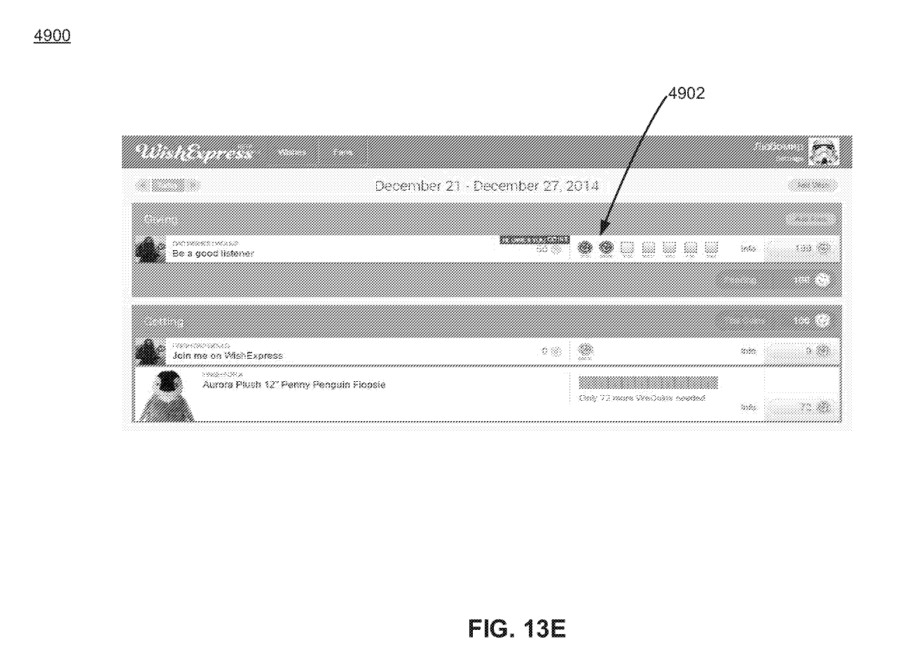

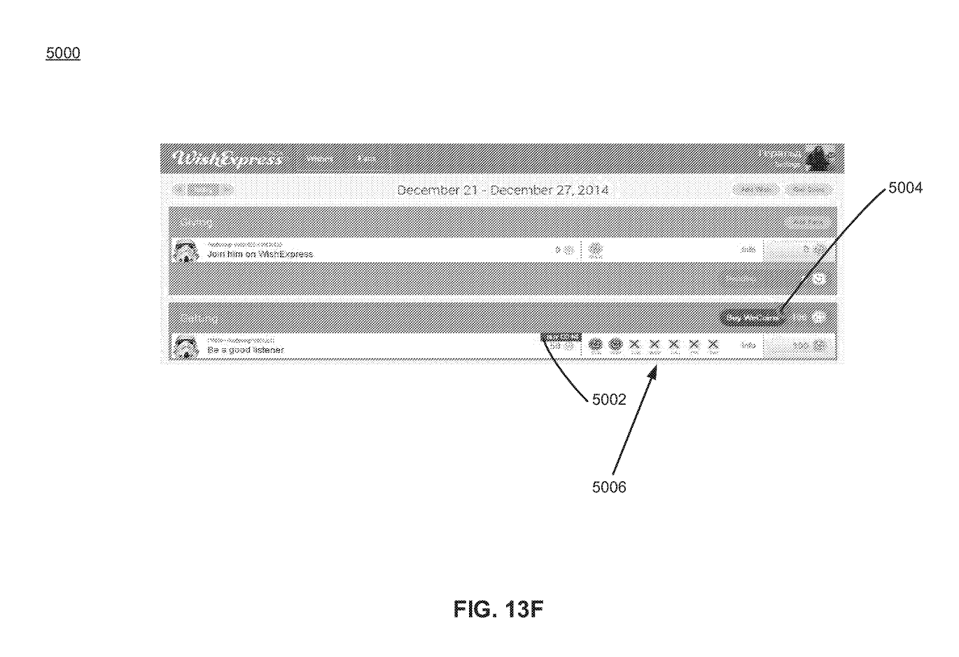

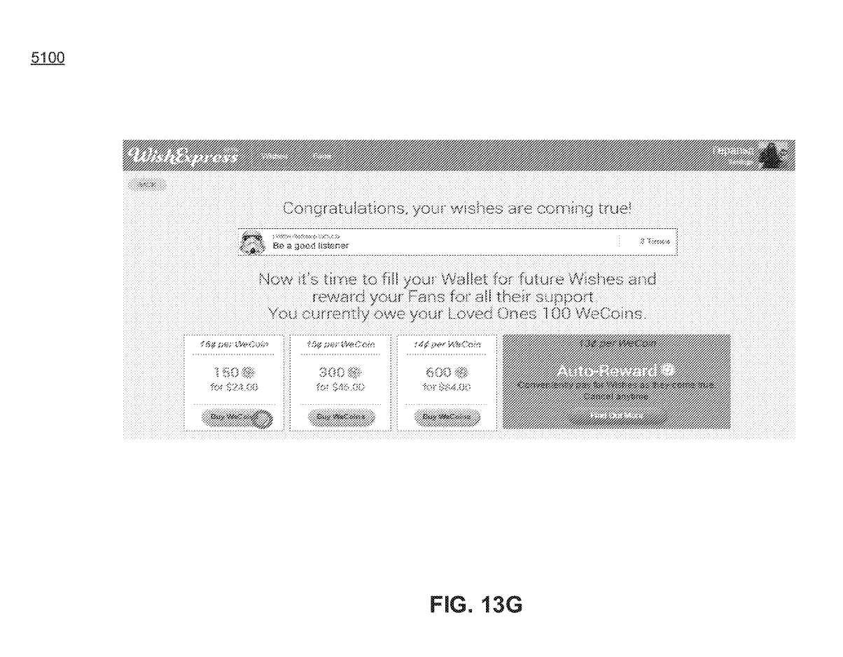

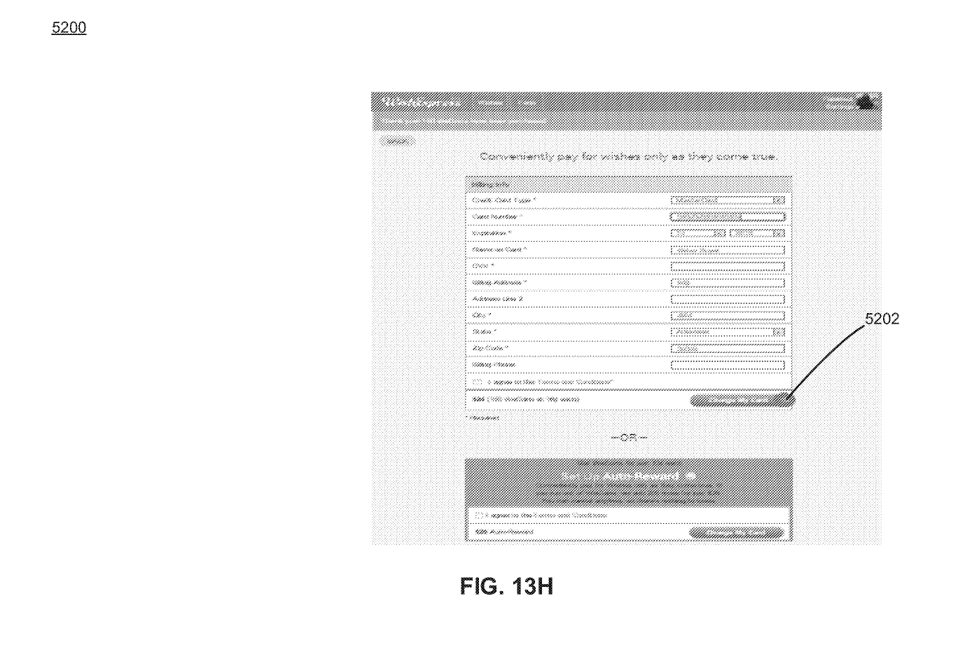

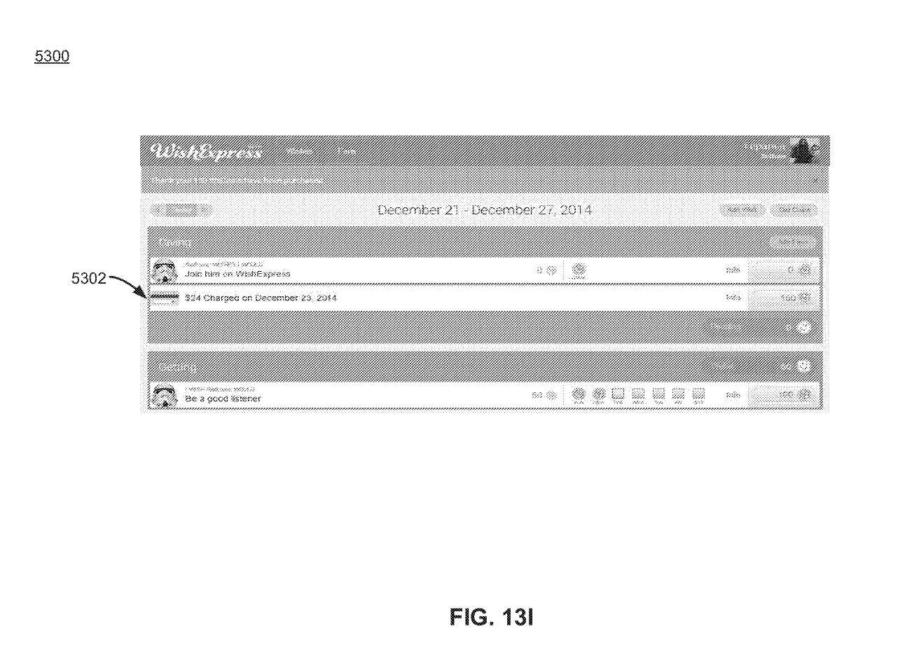

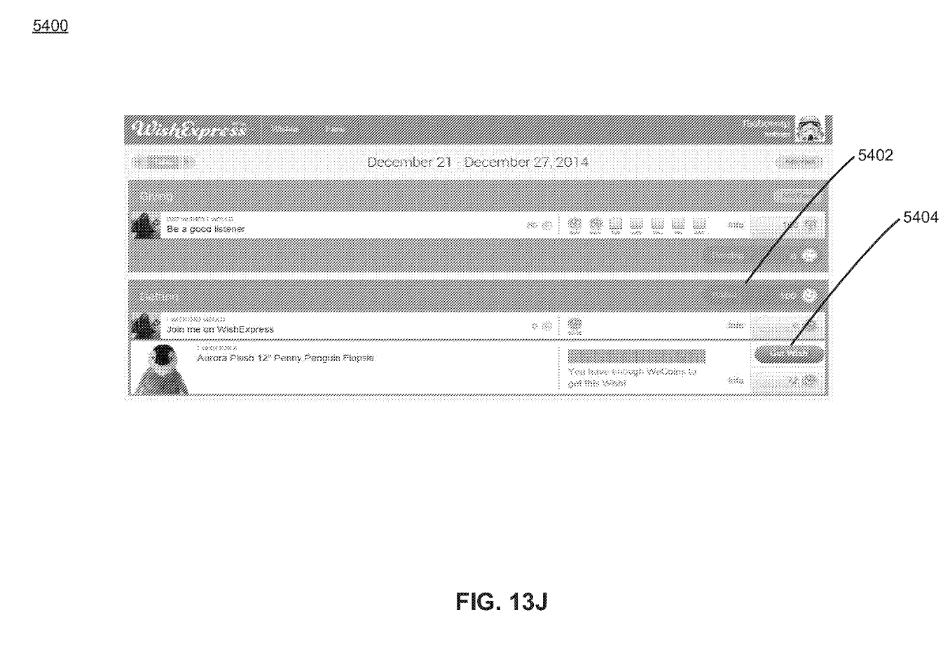

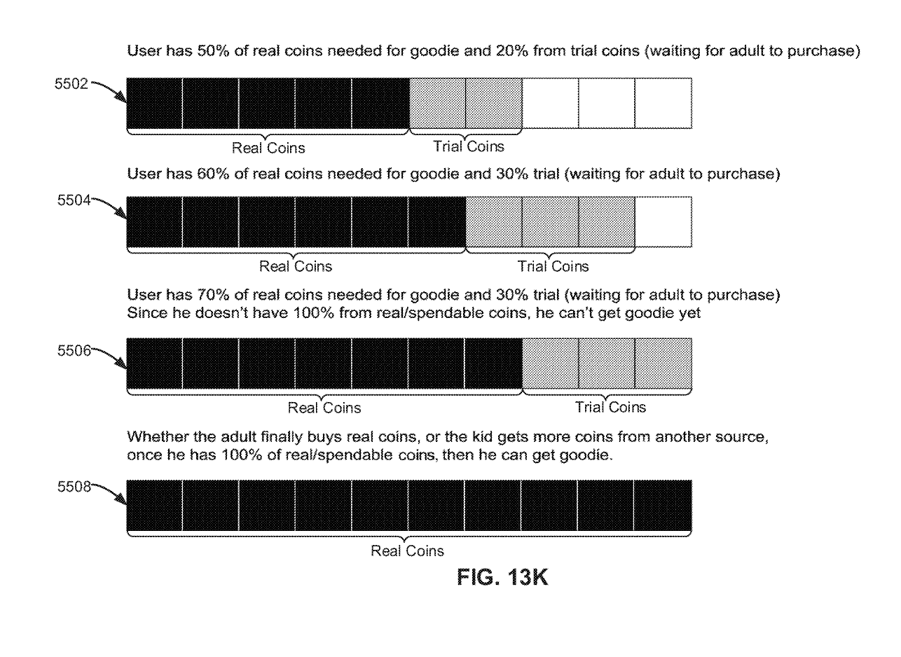

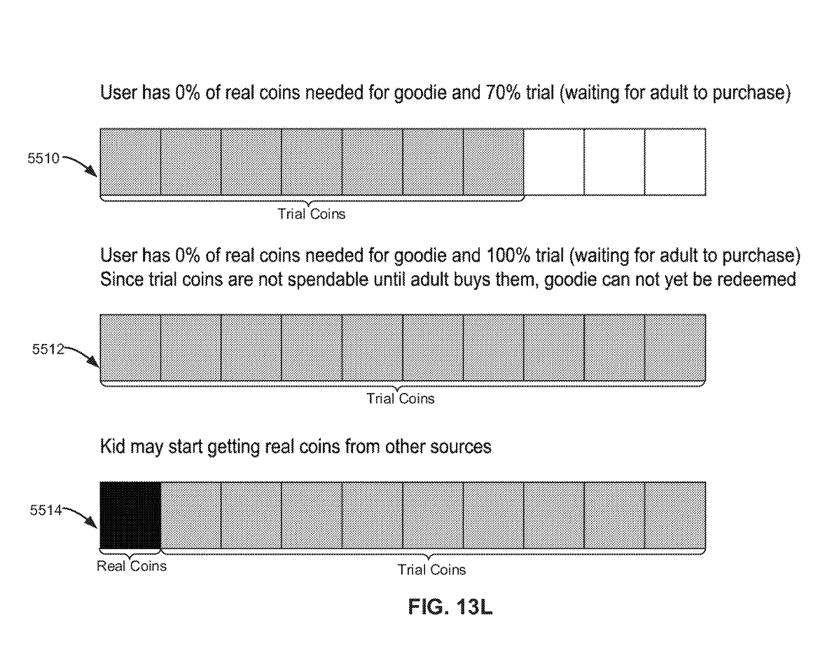

In one or more embodiments, a new wish granting user may engage in a trial of the system using placeholder digital system currency. The digital currency transaction engine 19004 may be configured to generate placeholder digital system currency. Placeholder digital system currency has no monetary value and may be visually represented differently from spendable digital system currency (e.g., FIGS. 13K-L). A new wish granting user may use placeholder currency within the system until a predetermined threshold amount is reached. Once a threshold amount is reached, a trial comes to a stop and a wish granting user is presented with a webpage to purchase digital system currency. A trial user may also be a wish receiver and receive wishes from other users with their placeholder digital system currency. Spendable digital system currency may be purchased using the digital currency transaction engine 19004. Upon such purchase, the digital currency transaction engine 19004 may automatically convert placeholder digital system currency to spendable digital system currency, which may be used in the system in ways disclosed herein. During a trial, a user may receive spendable digital system currency from others (earned, gifted), which it may spend on wishes in the system in ways disclosed herein. FIGS. 13A-J show user interface webpages and a workflow in accordance with one or more embodiments, including configurations for trial use. FIGS. 13K and L show exemplary trial scenarios using placeholder digital system currency and spendable digital system currency. Those skilled in the art will appreciate that the digital system currency engine may perform other trial functions beyond those disclosed.

Specific Wish Funding

In one or more embodiments, digital system currency may be purchased by a wish granting user and held in an account within the digital currency transaction engine 19004. A wish granting user may transfer digital system currency from its account to a wish receiving user via a user account within the engine. A wish granting user may limit the use of digital system currency granted to a wish receiving user to a specific wish of a wish receiving user. Further, a wish granting user may recover digital system currency granted if a wish receiving user changes the wish it desires from a specific wish that a wish granting user desired to fund. For example, a grandparent may not want to fund a new wish for a toy that the grandparent deems to be too dangerous. Additionally, a wish granting user may apply recovered digital system currency to a different specific wish. Also, a wish granting user may apply recovered digital system currency to a wish receiving user account without limitation. Those skilled in the art will appreciate that the digital system currency engine may perform other funding functions beyond those disclosed.

Wish Bidding

In one or more embodiments, the wish discovery engine 19002 and the digital currency transaction engine 19004 may be configured such that a wish supplier may bid on a wish receiving user's wish to enhance the likelihood of the wish supplier being selected to supply a wish. A wish receiving user may have a particular wish that it indicates in the wish discovery engine 19002, wherein the wish has set price of a certain amount of digital system currency. A wish supplier who may provide that particular wish wants to close a wish-related transaction as soon as possible. To facilitate this, the wish discovery engine 19002 and the digital currency transaction engine 19004 may be configured so that the wish supplier may transmit an offer via a user interface to the wish receiving user to provide the wish for a discounted amount of digital currency. For example, a wish receiving user may have a particular toy as product wish that it put on a list of its desired wishes at a cost of 200 units of digital system currency. The manufacturer of the toy, who is a wish supplier, wants to close a wish-related transaction as soon as possible. To facilitate this, the wish discovery engine 19002 and the digital currency transaction engine 19004 may be configured so that the wish supplier may transmit an offer via a user interface to the wish receiving user to sell the toy for a discounted amount of digital currency, in this case, 180 units of digital currency. The wish receiving user is incentivized to purchase the toy over other wishes because of its 20 unit discounted price.

Alternatively, the wish discovery engine 19002 and the digital currency transaction engine 19004 may be configured such that a wish supplier may offer to provide a wish for a discounted amount of digital currency for a set period of time. Additionally, the wish discovery engine 19002 and the digital currency transaction engine 19004 may be configured such that a wish supplier may offer to provide a wish for a discounted amount of digital system currency if a wish receiving user will make the purchase as soon as its account reaches the discounted amount of digital system currency necessary to make the purchase, automatically making the purchase when this criteria is met. In one or more embodiments, the wish discovery engine 19002 and the digital currency tracking engine 19008 may be configured such that a wish receiving user may offer to purchase a specific wish for a set amount of digital system currency and wish suppliers may choose to accept such an offer, such that upon acceptance by a wish supplier, a wish transaction is automatically transacted and the specific wish is provided in exchange for the offered set amount of digital system currency. Those skilled in the art will appreciate that the wish discovery engine 19002 and the tracking engine 19008 may be configured to perform other functions beyond those disclosed.

Cross-Promotion of Wishes

In one or more embodiments, a listing of wishes may be generated by the recommendation engine 20004. The recommendation engine 20004 may generate wish recommendations based upon a relationship with a preexisting wish. For example, if a user has a preexisting wish for “a hiking trip with their family,” the recommendation engine 20004 may generate recommendations for a related product wish, such as a tent and a backpack. The recommendation engine 20004 may further be configured to generate advertisements and offers based upon a relationship with a preexisting wish. Offers and advertisements may be provided by wish suppliers. For example, the recommendation engine 20004 may generate an offer for “100 units of digital system currency towards the purchase of an “‘XYZ’ brand tent or backpack” from a specific wish supplier. A relationship with a preexisting wish may include complimentary, chronological (next in time), serial (next in series), logical progression, and competitive (from competing wish suppliers) types of relationships.

Offers and advertisements may also be provided through third-parties, such as advertising insertion engines, retailers and service providers that are not wish suppliers within the system. For example, if a user has a preexisting wish of “go to a movie with John,” the recommendation engine 20004 may generate an offer for “20% off 2 regular price tickets at ‘ABC’ neighborhood cinema” in the form of an electronic coupon from an external advertising insertion engine. In a further embodiment, the recommendation engine 20004 may be configured to monetize generation of advertisements and offers, such that wish suppliers and third-party advertising insertion engines, retailers and service providers may purchase advertising and offer space within the user interface of the system. Those skilled in the art will appreciate that the recommendation engine 20004 may be configured to perform other promotion functions beyond those disclosed.

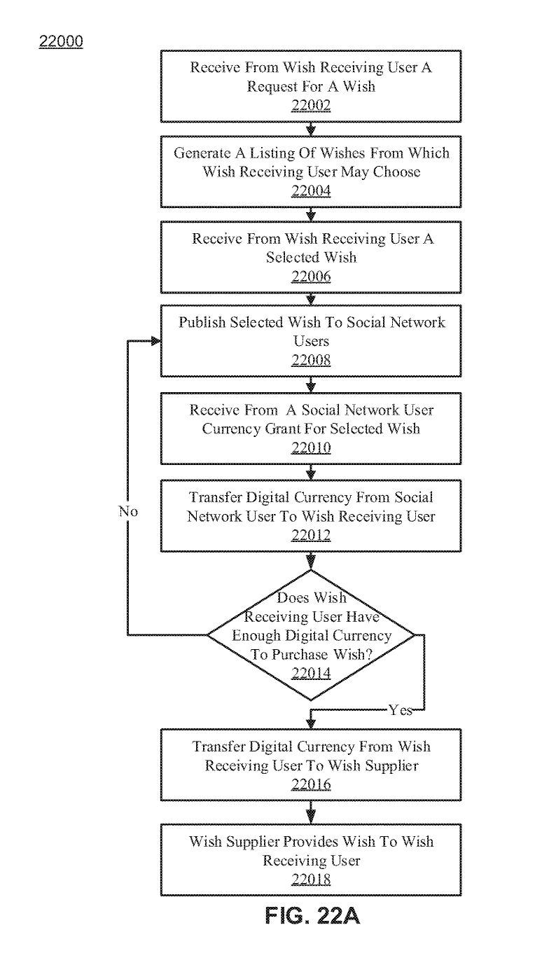

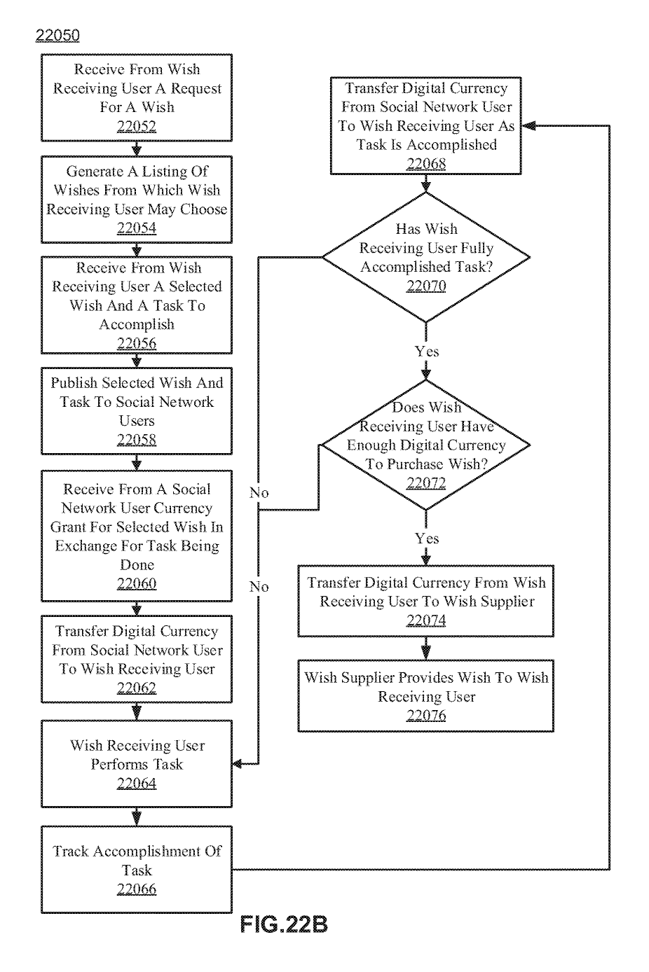

With reference to FIGS. 22A-B, flowcharts 2200-2250 illustrate example functions used by various embodiments. Although specific function blocks (“blocks”) are disclosed in flowcharts 2200-2250, such steps are examples. That is, embodiments are well suited to performing various other blocks or variations of the blocks recited in flowcharts 2200-2250. It is appreciated that the blocks in flowcharts 2200-2250 may be performed in an order different than presented, and that not all of the blocks in flowcharts 2200-2250 may be performed.

FIGS. 22A-B shows flow diagrams in accordance with one or more embodiments.

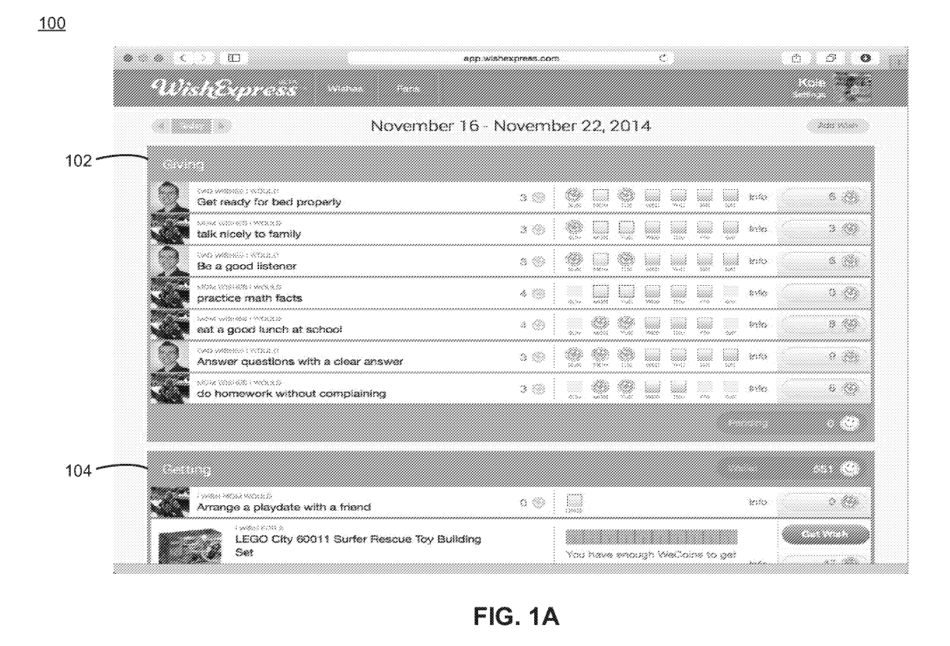

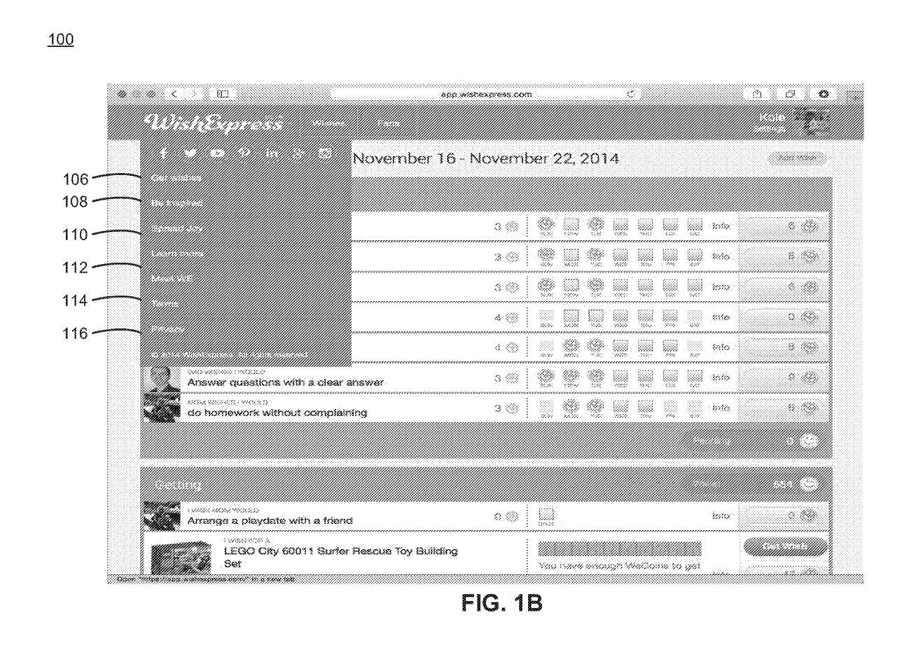

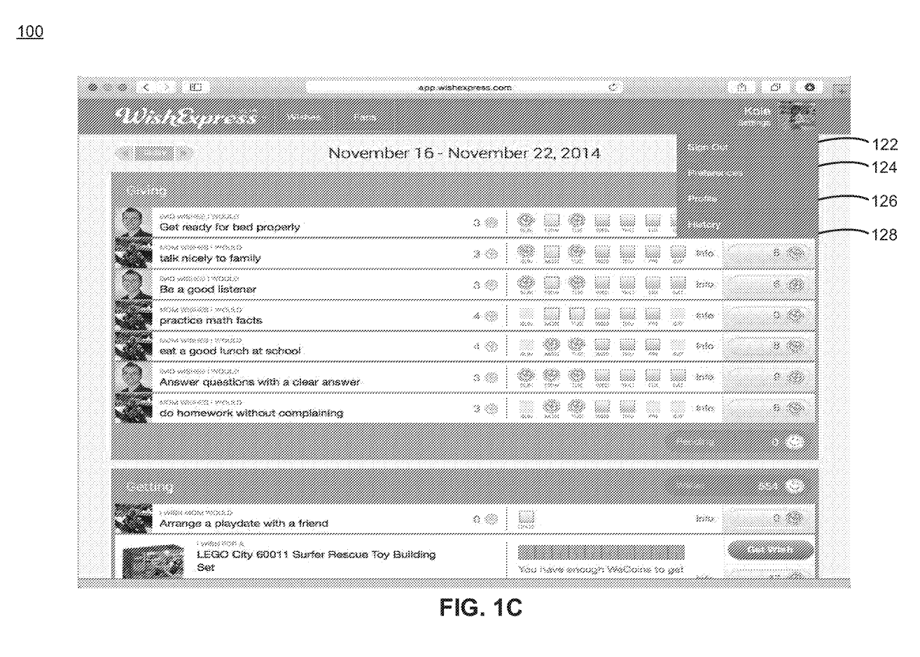

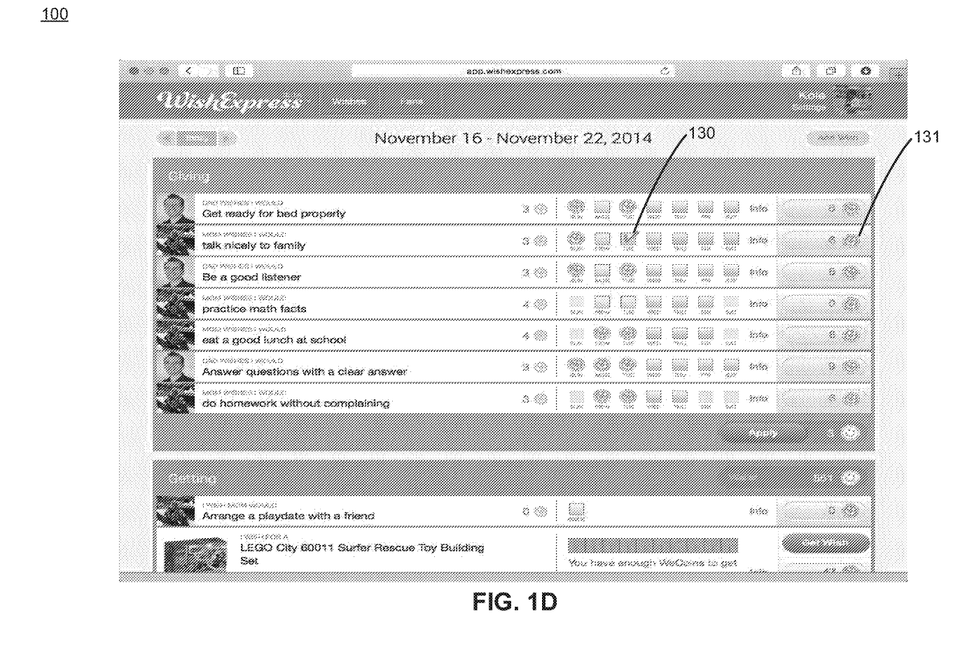

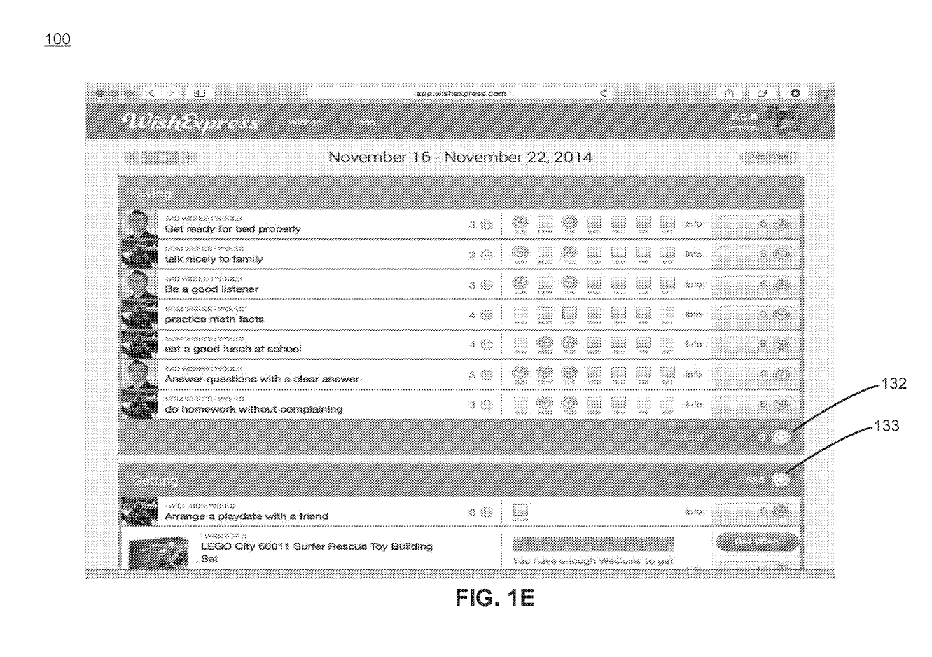

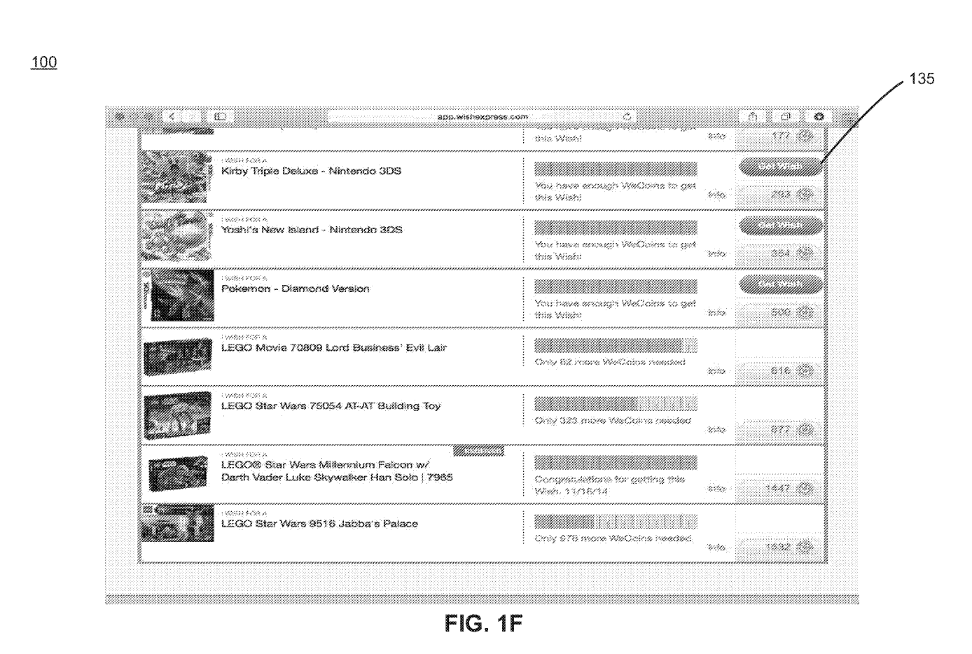

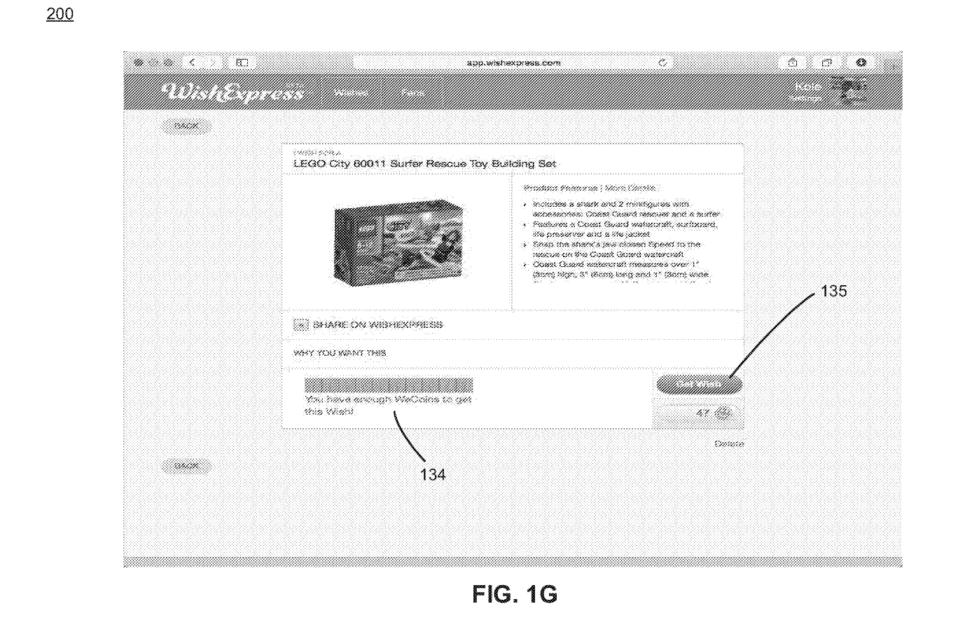

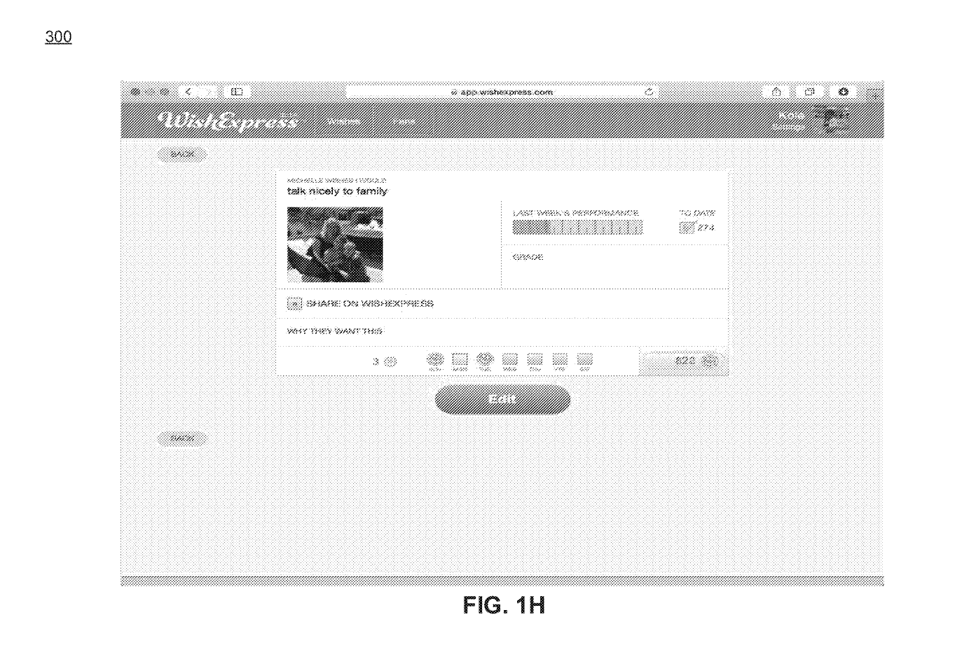

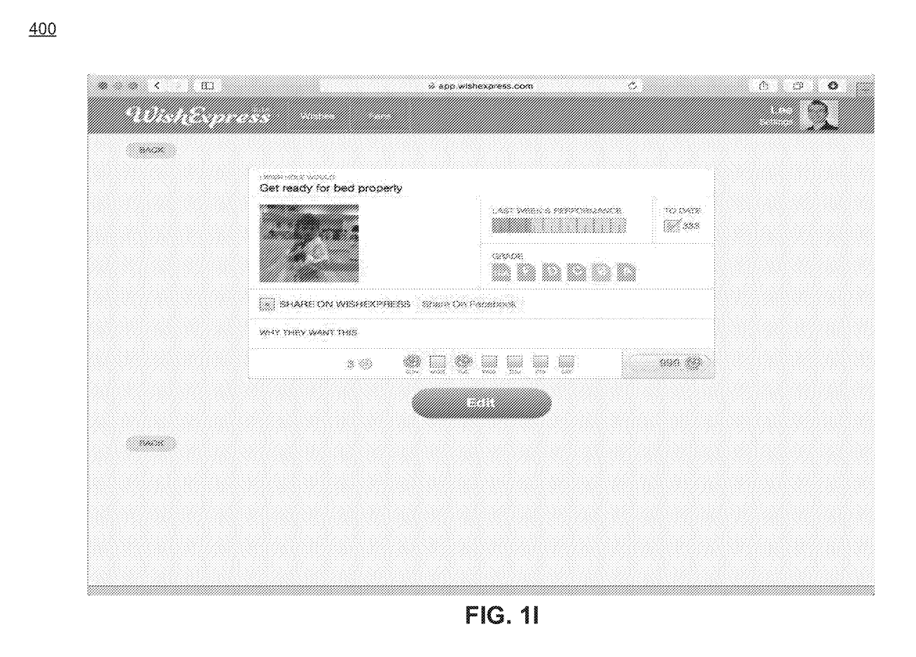

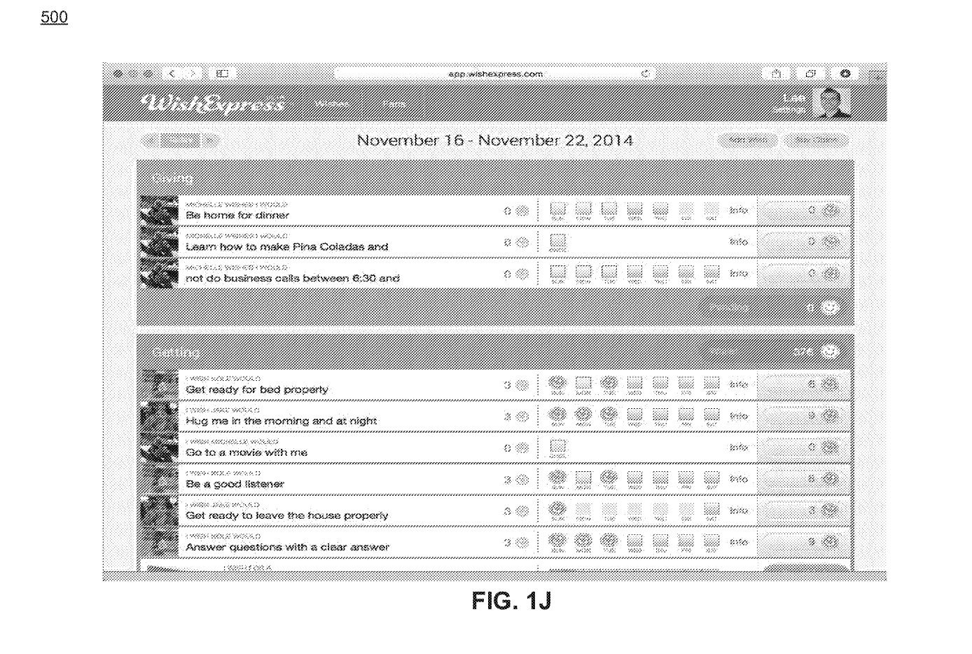

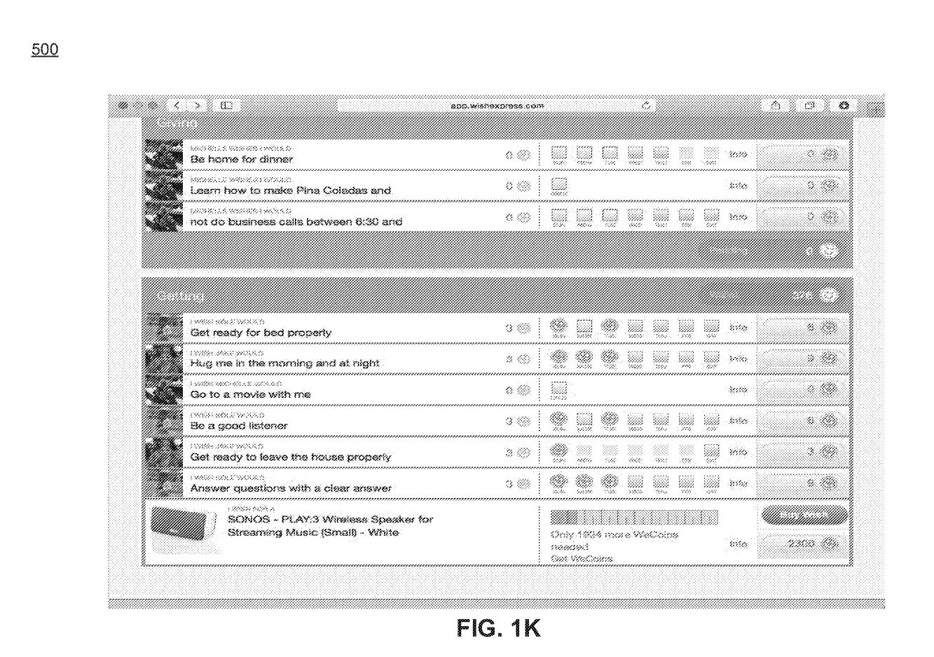

FIG. 22A shows an exemplary computer controlled process for receiving currency associated with a wish and fulfilling the wish, in accordance with various embodiments. FIG. 22A depicts a process 22000 for selection of a wish, receiving digital currency associated with the wish, and fulfillment of the wish. It is appreciated that a plurality of steps of process 22000 may be performed by a server based on requests and other communications received from a client, e.g., a web browser displaying one or more of the graphical user interfaces of FIGS. 1A-18. For example, the graphical user interfaces of FIGS. 1A-18 may be sent from the server.

At block 22002, a request for a wish is received from a wish receiving user. For example, a child may submit a request for a wish which is received by a server of a wish management system (e.g., WishExpress), as described herein.

At block 22004, a listing of wishes is generated from which the wish receiving user may choose. In some embodiments, a computing system, e.g., server (e.g., systems 19000-21000), generates and sends a listing of wishes for display in a graphical user interface in a web browser, e.g., FIG. 2C, as described herein.

At block 22006, a selected wish is received from the wish receiving user. In some embodiments, a child selects a wish, e.g., a product, and the selected wish or product information is received by the computing system, e.g., server, as described herein.

At block 22008, the selected wish is (optionally) published to one or more social network users. In some embodiments, information about the product that the child wishes for is published to a social network (e.g., Facebook) and allows others on the social network to see the child's wish.

At block 22010, a currency grant is received from a social network user. In some embodiments, a social network user, e.g., a grandmother of the child, purchases digital currency that is sent to a wish management system (e.g., systems 19000-21000), as described herein.

At block 22012, a transfer of digital currency is made from the social network user to the wish receiving user. In some embodiments, the wish management system transfers the digital currency to an account of the wish receiving user, e.g., child, as described herein.

At block 22014, whether the wish receiving user has enough digital currency to purchase the wish is determined. For example, if the wish is for a product that costs 100 units of digital currency, the wish receiving user's account will be checked to see if there is 100 units of digital currency in the wish receiving user's account. If the wish receiving user has enough digital currency to purchase the wish, block 22016 is performed. If the wish receiving user does not have enough digital currency to purchase the wish, block 22008 is performed.

At block 22016, digital currency is transferred from the wish receiving user to the wish supplier. In some embodiments, the digital currency is transferred from the wish receiving user's account to an account of the wish management system and then the wish management system transfers an associated amount of money (e.g., US dollars) to the wish supplier, e.g., a merchant, as described herein.

At block 22018, the wish supplier provides the wish to the wish receiving user. In some embodiments, the providing of the wish by the wish supplier to the wish receiving user includes the wish supplier shipping a product, e.g., a toy, associated with wish to the wish receiving user, e.g., child, as described herein. Advantageously, the social network user, e.g., the grandmother, that granted the currency to the child, is not involved in the purchase of the wish, e.g., the toy, thereby removing any need for involvement of the social network user. Further, the child has been able to use the digital currency to purchase an item, experience, etc., that the child wished for instead of his or her grandmother purchasing an item that she thinks the child may desire.

FIG. 22B shows an exemplary computer controlled process for tracking accomplishment associated with a wish and fulfilling the wish, in accordance with various embodiments. FIG. 22B depicts a process 22050 of selection of a wish, tracking accomplishment of a task associated with the wish, receiving digital currency associated with the task, and fulfillment of the wish. It is appreciated that a plurality of steps of process 22050 may be performed by a server (e.g., system 19000-21000) based on requests and other communications received from a client, e.g., a web browser with graphical user interfaces of FIGS. 1A-18. For example, the graphical user interfaces of FIGS. 1A-18 may be sent from the server.

At block 22052, a request for a wish is received from a wish receiving user. For example, a child may submit a request for a wish which is received by a server of a wish management system (e.g., systems 19000-21000), as described herein.

At block 22054, a listing of wishes is generated from which the wish receiving user may choose. In some embodiments, a computing system, e.g., server, generates and sends a listing of wishes for display in a graphical user in a web browser, e.g., FIG. 2C, as described herein.

At block 22056, a selected wish and a task to accomplish is received from the wish receiving user. In some embodiments, a child selects a wish, e.g., a product, and a task to accomplish, e.g., cleaning his or her room or getting an ‘A’ in mathematics class, and the selected wish and/or product information and task is received by the computing system, e.g., server, as described herein.

At block 22058, the selected wish and task is published to social network users. In some embodiments, information about the product that the child wishes for and the task is published to a social network (e.g., Facebook) and allows others on the social network to see the child's wish, as described herein.

At block 22060, a currency grant for the selected wish and the task being done is received from a social network user. In some embodiments, a social network user, e.g., a parent of the child, performs a purchase of digital currency that is sent to a wish management system, as described herein. For example, the parent may purchase digital currency to be stored in a digital wallet associated with the parent which can then be transferred to the child upon completion of one or more tasks.

At block 22062, an optional transfer of digital currency is made from the social network user to the wish receiving user. In some embodiments, the social network user, e.g., parent, may decide to gift or transfer digital currency from his or her account to wish receiving user, e.g., child, as described herein.

At block 22064, the wish receiving user performs the task. For example, a child may perform the task of going to bed on time, cleaning up his or her room, or getting an ‘A’ in mathematics class at school, as described herein.

At block 22066, accomplishment of the task is tracked. As described herein, the tracking of accomplishment of the task may include a child marking off that the task has been completed (e.g., FIG. 1D) and a parent confirming completion of the task. For example, in response to the receiving an indication that the task has been completed, a confirmation request may be sent to a parent.

At block 22068, a transfer of digital currency is made from the social network user to the wish receiving user as task is accomplished. In some embodiments, after completion of a task or subtask has been confirmed or validated, e.g., by a parent, digital currency is transferred from an account of the social network user, e.g., the parent, to the account of the wish receiving user, e.g., child, as described herein.

At block 22070, whether the wish receiving user has fully accomplished the task is determined. For example, if the task was for the child to go to bed on time for a month, the task will not be fully accomplished until the particular month is over. If the wish receiving user has fully accomplished the task, block 22074 is performed. If the wish receiving user has not fully accomplished the task, block 22064 is performed. In some embodiments, block 22070 may be optional.

At block 22072, whether the wish receiving user has enough digital currency to purchase the wish is determined. For example, if the wish is for a product that costs 100 units of digital currency, the wish receiving user's account will be checked to see if there is 100 units of digital currency in the wish receiving user's account. In some embodiments, the ability to fulfill one or more wishes is indicated with a visual attribute of a graphical user interface (e.g., Get Wish button 135 of FIG. 1F). If the wish receiving user has enough digital currency to purchase the wish, block 22074 is performed. If the wish receiving user does not have enough digital currency to purchase the wish, block 22064 is performed.

At block 22074, digital currency is transferred from the wish receiving user to the wish supplier. In some embodiments, the digital currency is transferred from the wish receiving user's account to an account of the wish management system and then the wish management system transfers an associated amount of money (e.g., US dollars) to the wish supplier, e.g., a merchant, as described herein.

At block 22076, the wish supplier provides the wish to the wish receiving user. In some embodiments, the providing of the wish by the wish supplier to the wish receiving user includes the wish supplier shipping a product, e.g., a toy, associated with wish to the wish receiving user, e.g., child, as described herein. Advantageously, the social network user, e.g., the parent, that granted the currency to the child, is not involved in the purchase of the wish, e.g., the toy, thereby removing any need for involvement of the social network user, e.g., parent. Thus, the child has been able to use the digital currency to purchase an item, experience, etc., that the child wished for instead of having to remind, nag, or burden the parent to purchase the item.

FIGS. 1A-K show user interface webpages and a workflow in accordance with one or more embodiments. A system in accordance with one or more embodiments is shown as “WishExpress” and “WE.” The WishExpress system is available from WishExpress, Inc. of Redwood City, Calif.

FIGS. 1A-F show a graphical user interface 100 known as a “user dashboard.” Users are shown as “members.” Tasks to be accomplished by a user are shown as “wishes” the user is “giving” (e.g., or granting). Wishes the user desires are shown as “wishes” the user is “getting” (e.g., or receiving). Wish granting users are shown as “fans.” Referring to FIG. 1A, each WishExpress (WE) member has a dashboard with wishes he or she is “giving” and “getting.” In some embodiments, the week's current date displays in the middle of the page and members can navigate to last week and next week using the arrows along the left side. A “giving” module or portion 102 consists of wishes that the member may be providing to their family and friends. A “getting” module or portion 104 includes wishes that the member wants to get (e.g., to be granted).

Referring to FIG. 1B, the top navigation bar or header of graphical user interface 100 can include a dropdown menu for publicly accessible pages. FIG. 1B depicts a left side header dropdown menu. This dropdown menu may also be on a marketing site. The dropdown menu can include a plurality of social links 106, a get wishes menu item 108, a be inspired menu item 110, a spread joy menu item 112, a learn more item 114, a meet WE menu item 116, a terms menu item 118, and a privacy menu item 120. The plurality of social links 106 provides links to WE associated social links (e.g., the WE Facebook page).

The get wishes menu item 108 upon selection brings unauthenticated users to a sign in page and brings signed in users to the dashboard (e.g., FIG. 1A). The be inspired menu item 110 upon selection brings a user to a be inspired page (e.g., http://www.wishexpress.com/be-inspired). The spread joy menu item 112 upon selection brings a user to a spread joy page (e.g., http://www.wishexpress.com/spread-joy) which allows a user to spread news and information about WE. The learn more item 114 upon selection brings a user to a learn more page (e.g., http://www.wishexpress.com/learn-more). which allows a user to learn more about wishes and WE. The meet WE menu item 116 upon selection brings a user to a meet WE page (e.g., http://www.wishexpress.com/meet-we). The terms menu item 118 upon selection brings a user to a page with terms and/or conditions of use of WE (e.g., http://www.wishexpress.com/terms). The privacy menu item 120 upon selection brings a user to a privacy information page (e.g., http://www.wishexpress.com/privacy).

FIG. 1C shows a right side header dropdown menu including a sign out menu item 122, a preferences menu item 124, a profile menu item 126, and a history menu item 128. An unauthenticated user sees a “Sign in” button along the top right of the GUI 100 when visiting a public-facing page. An authenticated member or user will see his or her name, avatar, and link to settings. The sign out menu item 122 upon selection signs out a user. The preferences menu item 124 upon selection brings a user to a preferences configuration page (e.g., http://app.wishexpress.com/user/preferences). The profile menu item 126 upon selection brings a user to his or her profile (e.g., http://app.wishexpress.com/user/profile). The history menu item 128 upon selection brings a user to a history page (e.g., http://app.wishexpress.com/user/wishes/history) which may include past wishes.

FIGS. 1D-F shows a user dashboard and exemplary workflow between the wish discovery engine 19002, the digital currency transaction engine 19004 and the tracking engine 19008. A digital system currency is shown as “WeCoins,” a digital system currency account is shown as a “wallet” and product wishes are shown as “goodies.”

FIG. 1D shows a graphical user interface 100 with a marked off item, in accordance with various embodiments. A user clicks on a box to mark off completion of a task and the graphical user interface 100 indicates completion with check mark 130. As a member or user accomplishes their promise to another (e.g., its “Fans” wish), the member checks off or marks off the item. In some embodiments, item or tasks that are expected on a particular day, or a “once” item, may appear in a blue box. Blue boxes can be marked off and other color boxes cannot. Other than a once item, blue boxes may only appear for today and in the past up to the beginning of last week. In some embodiments, items older than last week cannot be marked off but are visible, as read-only, in the member's history.

Items or tasks expected in the future can be represented with a grey box with a dark grey outline. Grey boxes can communicate what is coming up but cannot be marked off Future items may not be marked off. If an item is not expected on a particular day, then it can be represented with a light grey box with no outline. As the member marks off items, the sub-total along the right side increases. If an item is deselected, then the sub-total 131 goes down. The total number of un-applied but marked off items displays along the bottom of the “Giving” module 102 next to a blue “Apply” button. In some embodiments, the “Apply” button only appears when there is an unsubmitted mark-off.

FIG. 1E shows a graphical user interface 100 after the “Apply” button has been selected, in accordance with some embodiments. Once the mark-off has been applied (and approved, e.g., by a parent) the checkmark 130 (e.g., green) becomes a WeCoin icon (e.g., smiley face). In some embodiments, the applied and approved tasks cannot be un-applied (or undone). The member can continue to make mark-offs whenever he or she has unchecked blue boxes regardless of session. If the Fan has opted to approve mark-offs, WeCoins held in the “Pending” area 132 until approved. As WeCoins flow into the member's “Wallet” 133, the WeCoins are now spendable on any of his or her wishes.

FIG. 1F shows a graphical user interface 100 after scrolling down the member's wish-list (e.g., “Getting”) module 104, in accordance with some embodiments. “Goodies” are products that the wish management system (e.g., from WishExpress) can order and deliver to members if they have enough WeCoins. A visual meter 134 displays how close the member is to being able to get the item compared to the coins in their wallet. In some embodiments, goodies are displayed in the list from least expensive at the top to most expensive at the bottom. For kid users, once they have enough coins, the “Get Wish” 135 button displays. In some embodiments, adults can buy more coins whenever they want, therefore they always see the “Get Wish” button per item.

The messages and states associated with some embodiments are explained with FIGS. 14A-F.

FIG. 1G shows a goodie detail page 200, describing a goodie or item as a wish, in accordance with various embodiments. From the dashboard 100, if a member clicks on the goodie's “Info” they see the product's detail page 200. A larger image is displayed along with longer product description. The member also has the ability to turn off sharing on WishExpress and read the reason they wanted this item when originally adding it to their wish-list. This screen also contains the “Delete” link if they want to remove the item from their list. The “More Details” link opens the supplier's product page in a new window. “Back” buttons take the member back to their dashboard.

FIG. 1H shows a favor detail page 300, describing a favor as a wish as displayed to a wish granting user, in accordance with some embodiments. From the dashboard 100, if a member clicks on the favor's “Info” link, the detail page 300 is displayed. A larger image is displayed along with other descriptions. The member has the ability to turn off sharing on WE and read the reason why this wish was originally requested. This screen also contains the “Edit” link if they want to change any of the attributes. In some embodiments, deleting is possible once in Edit mode. “To Date” is the number of times that the item has been delivered or accomplished in total. “Last Week's Performance” is the ratio of delivered tasks compared to the expected delivered tasks. “Back” buttons take the member back to their dashboard.

FIG. 1I shows a favor detail page 400, describing a favor as a wish as displayed to a wish receiver (e.g., receiver's view), in accordance with various embodiments. The receiver's view of a favor is very similar to the provider's with the exception that they set and see the “Grade.” Sharing on a social network (e.g., Facebook) is also possible. Only FB users should see this option though. In some embodiments, when the favor is between two adults, both adults must agree to share in order for it to be shared on a social network (e.g., Facebook). Parents, however, can share their kid's progress.

FIGS. 1J and 1K show another embodiment of a user dashboard 100, specifically tailored for use by adults, in accordance with various embodiments. FIG. 1J shows an adult version 500 of the dashboard 100, in accordance with various embodiments. In some embodiments, the only difference for an adult's perspective is they have the “Buy Coins” button along the top right. It is noted that Kids are getting a “Get Coins” option. Adults and kids can both have goodies and favors in their wish list. The receiver of a wish can also mark off an item that they got from their fan. FIG. 1K shows an adult version 500 of a user dashboard 100 scrolled down, in accordance with various embodiments.

FIGS. 2A-E show user interface webpages and a workflow in accordance with one or more embodiments, including the wish discovery engine 19002 configured to enter a product wish, shown as a “goodie.”

FIG. 2A shows a user interface 600 for adding a wish, in accordance with various embodiments. The interface 600 allows selection of a goodie, an activity, a favor, and a betterment (e.g., self-improvement). From their dashboard 100, a member can click the “Add Wish” button along the top right. After that, they see this wish selection page 600. This is where they select the category of wish they want. The “Back” button goes back to the dashboard.

FIG. 2B shows a user interface 700 for searching for a goodie or item, in accordance with various embodiments. From the wish selection page, if the member clicks “Goodie” then they see this goodie search page. The member can type in whatever goodie they want and initiate a search. In some embodiments, the system can prohibit all members from searching for derogatory (racist, homophobic, etc.) and illegal (weapons, drugs, criminal, etc.) items. Kids can be furthermore prohibited from using terms that are age-inappropriate (e.g., sexual, etc.). These “blacklist” of terms is managed by WE in the system admin console. The “Back” button goes back to the wish selection page.

FIG. 2C shows a user interface 800 for selecting a goodie or item from a plurality of search results, in accordance with various embodiments. After the member has clicked the “Search” button on the goodie search page, they see the associated search results. WE aggregates and displays relevant merchandise from our suppliers. Per item, the product photo, product title, and WeCoin price are displayed. The price is determined by the dollar-to-WeCoin calculator, configurable in the system admin console. The “Details” link shows more product information. The “Back” button goes back to the goodie search page.

FIG. 2D shows an exemplary graphical user interface 900, where a goodie or item during mouse-over, in accordance with various embodiments. Rolling over an item reveals the “Add Wish” button 902. Clicking this button shows the detail page with request to confirm (e.g., FIG. 2E).

FIG. 2E shows an exemplary user interface 1000 for confirming selection of a goodie or item, in accordance with various embodiments. In some embodiments, before confirming the goodie and adding it to the member's dashboard “Getting” module, the user is prompted to enter “why” they want it. The member also has the ability to over-ride their sharing preferences per the particular goodie. Sharing defaults can be configured by the user in their preferences. Clicking “Add Wish” places the goodie in their wish-list. The “Back” button goes back to the goodie results page.

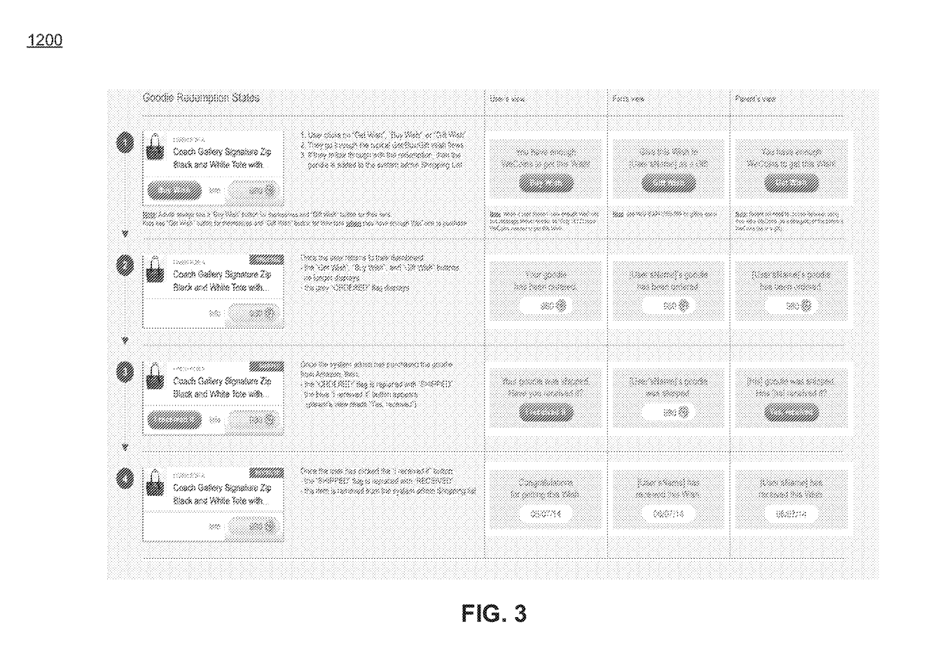

FIG. 3 shows a workflow 1200 in accordance with one or more embodiments for redemption of product wishes, shown as “goodies.” It shows what will populate the user interface views of various users. It shows a wish receiving user as “user” and a wish granting user as a “fan.” It also shows a parent user as a “parent,” where a parent may act as a wish granting user. It further shows that a parent may act as a delegate user for a child wish receiving user.

FIGS. 4A-D show user interface webpages and a workflow in accordance with one or more embodiments, including the wish discovery engine 19002 configured to enter a wish, shown as a “favor.”

FIG. 4A shows an exemplary user interface 1300 for a user to add a wish, in accordance with various embodiments. The interface 1300 allows selection of a goodie, an activity, a favor, and a betterment (e.g., self-improvement). In some embodiments, user interface 1300 is substantially similar to user interface 600. From their dashboard, a member can click the “Add Wish” button along the top right. After that, they see this wish selection page 1300. This is where they select the category of wish they want. The “Back” button goes back to the dashboard.

FIG. 4B shows a graphical user interface 1400 that is displayed after selection of an activity for the category that is being wished for, in accordance with various embodiments. Other than “Goodies”, adding any other wish-type can be the same (“Activities”, “Favors”, “Betterments”, etc.). The second word in the headline is associated with the wish type entered on the wish selection screen previously. The first dropdown 1402 identifies the relationship type. The first set of options within the list contain existing connections (e.g., connected social network users). The second set of options contains other relationships that can be invited. The “Back” button goes back to the wish selection page.

FIG. 4C shows an exemplary graphical user interface 1400 that is displayed for selecting a type of activity, in accordance with some embodiments. The second dropdown 1404 contains wish types. The member can freeform type whatever they want or select from the system's examples. The list of wishes in the second dropdown is informed by the relationship type in the first dropdown. In this example, the list of wishes is fed by the database of kid-to-parent in the category of “Activity.”

FIG. 4D shows a graphical user interface 1500 for tailoring a wish, in accordance with various embodiments. FIG. 4D also includes a user interface with the digital currency transaction engine 19004 configured to allow a currency value to be assigned to a wish, shown as a “favor.”

Once the member establishes who they want the wish from and what the wish is, then they can setup the other details. On this page, they can still change “What” the wish is during setup. It is noted that, in some embodiments, later in edit mode, this cannot be changed however. The next components are “Why” they want this particular wish and “When” this should happen. The options can include particular days of the week, or “Once”. The member can select the wish's value from a dropdown list. The value can be zero up to whatever they can afford. The member can override their sharing defaults (e.g., configured in their preferences). Once they're done setting up the wish's attributes they click “Save”, which sends the request to the other party. The “Back” button goes back to the favor setup page.

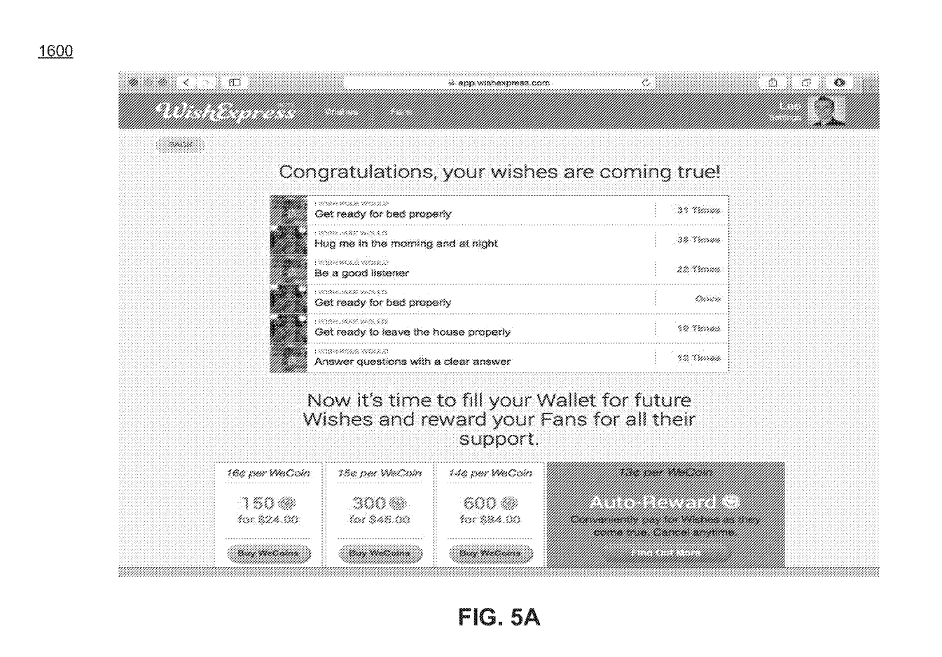

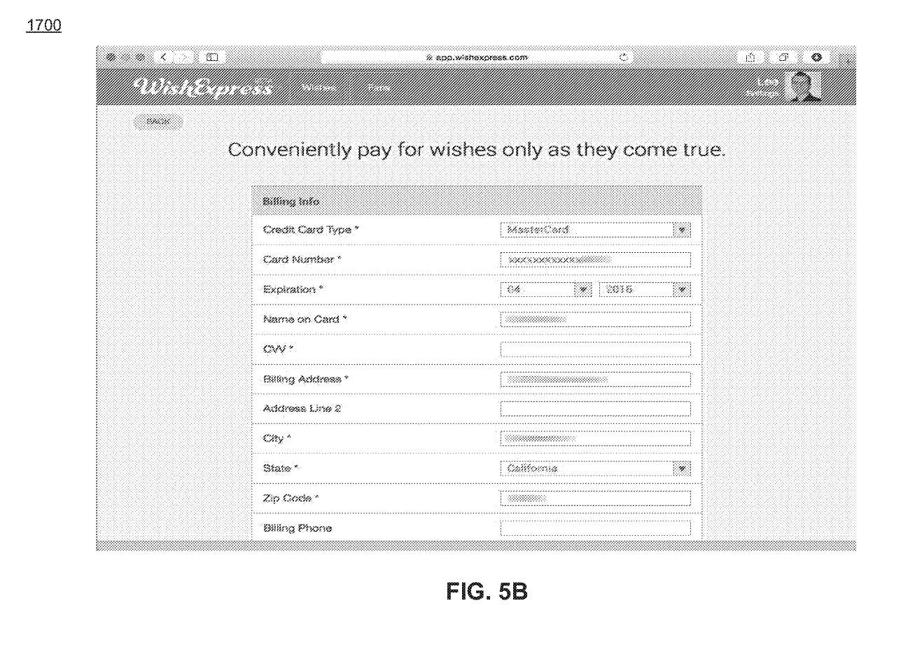

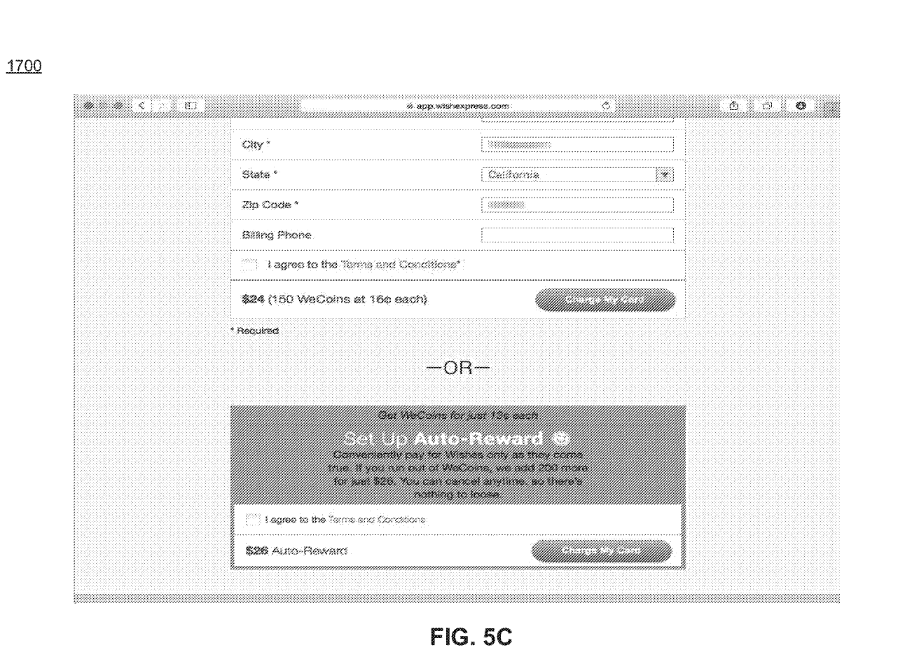

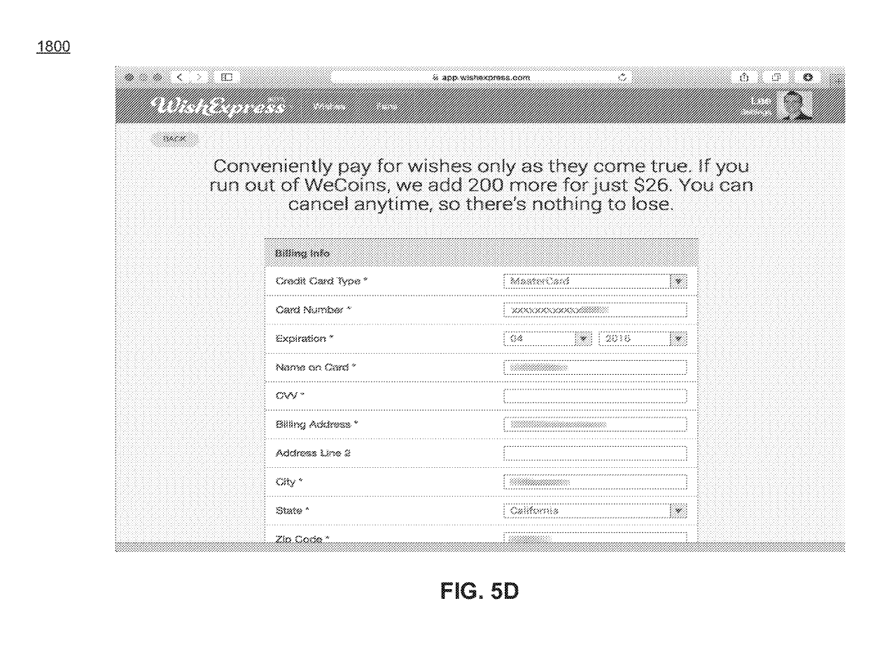

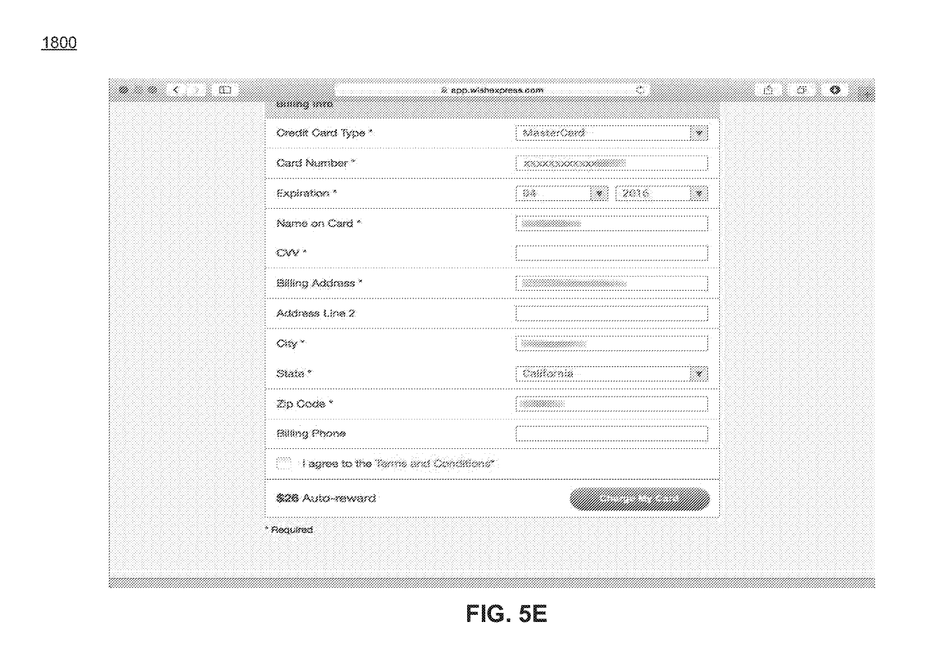

FIGS. 5A-E show user interface webpages and a workflow in accordance with one or more embodiments, including the digital currency transaction engine 19004 configured so that a wish granting user may purchase digital system currency, shown as “WeCoins,” using a credit card.

FIG. 5A shows an exemplary graphical user interface 1600 for purchasing digital currency (e.g., WeCoins), in accordance with various embodiments. Adult members have the opportunity to buy WeCoins and kids cannot. On the purchase page, the member may be displayed the last set of wishes that were received since last time buying WeCoins. Each wish item contains the number of times it was received. In some embodiments, the headlines are different the first time the member sees the purchase page after registering. In some embodiments, four different WeCoin packages are available for purchase. The “Back” button goes back to the dashboard.

FIG. 5B shows an exemplary graphical user interface 1700 for performing a payment, in accordance with various embodiments. Upon clicking one of the first three packages, the member is displayed graphical user interface 1700 where they can enter their payment information. In some embodiments, fields with asterisks are required while other fields are optional. The “Back” button goes back to the purchase page.

FIG. 5C shows another portion of the exemplary graphical user interface 1700 for performing a payment, in accordance with various embodiments. The member completes their payment information, agrees to the terms and conditions, then clicks the “Charge My Card” button. In some embodiments, there are three different pages for the different package values. A receipt can be emailed and be available in their history. An upsell to “Auto-Reward” can also be displayed.

FIG. 5D shows an exemplary graphical user interface 1800 for configuring automatic payments, in accordance with various embodiments. The graphical user interface 1800 can be used, for example, by a parent to automatically purchase digital currency (e.g., WeCoins) whenever his or her wallet drops below a threshold (e.g., preselected or predetermined) amount. The parent's wallet may thus be replenished automatically. Upon clicking the fourth/auto-reward package (e.g., FIG. 5A), the member is displayed graphical user interface 1800 where they can enter their payment information. In some embodiments, fields with asterisks are required while other fields are optional. The “Back” button goes back to the purchase page.

FIG. 5E shows another portion of the exemplary graphical user interface 1800 for configuring automatic payments, in accordance with some embodiments. The member completes their payment information, agrees to the terms and condition, then clicks the “Charge My Card” button. A receipt can be emailed and be available in their history.

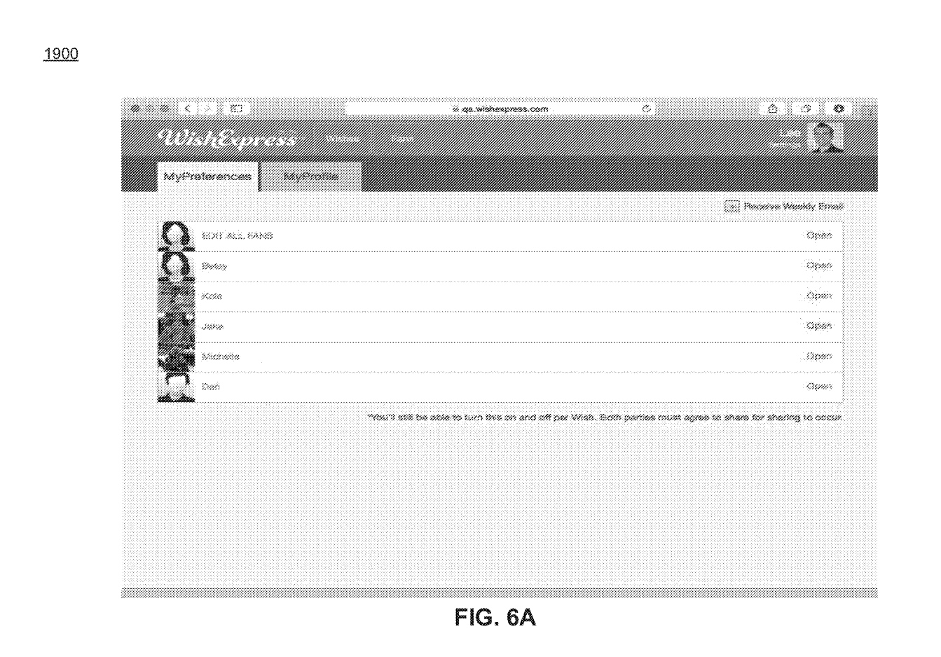

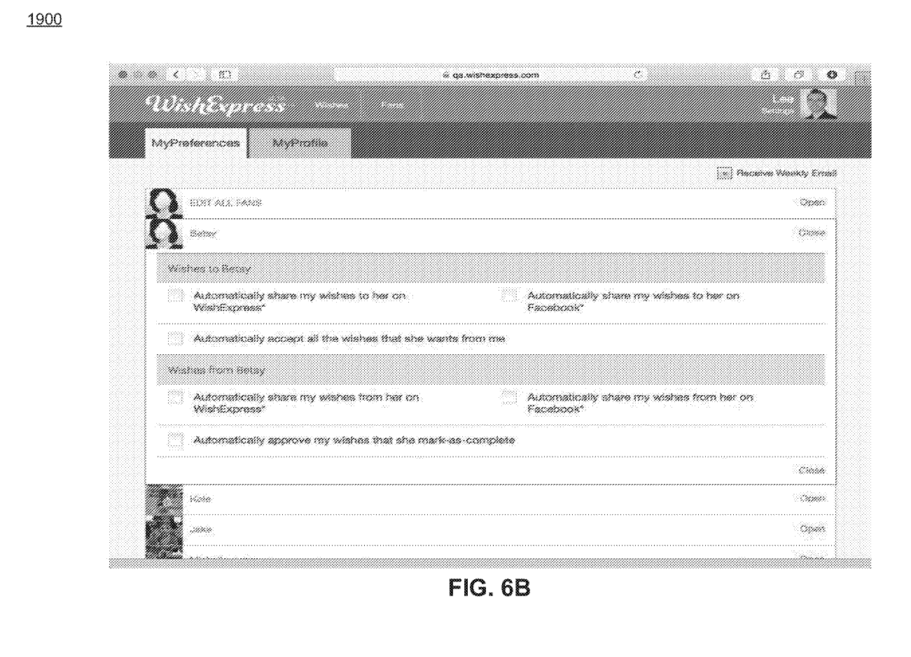

FIGS. 6A-B show user interface webpages in accordance with one or more embodiments, including user preference webpages configured to control wish interactions between wish granting users and wish receiving users.

FIG. 6A shows an exemplary graphical user interface 1900 for configuring preferences, in accordance with various embodiments. The preferences section is where the member sets various defaults for their application interactions (e.g., within the wish management systems and on social networks) with their Fans. This page also can include a single notification toggle (on/off) for receiving the weekly email. In some embodiments, upon arriving at the page, all components are collapsed. The member can expand any particular fan for editing by clicking “Open”. Using the “EDIT ALL FANS” makes the same configurations for all their fans be displayed simultaneously. In other words, it over-rides all individual settings like an edit-all function.

FIG. 6B shows the graphical user interface 1900 and options to control sharing of whether wishes to a wish granting user, shown as a “fan,” are shared and whether wishes from a fan are shared over social network applications, specifically an internal WishExpress social network and external, third-party social network, e.g., Facebook. In some embodiments, once a particular Fan is expanded, edits can be made. The configurations are described in the descriptions. In some embodiments, the * (asterisk) items require both parties to agree for sharing (e.g., on a social network) to take place. Also, the member can over-ride these defaults per wish when adding and editing the wish. The “Close” link collapses the component.

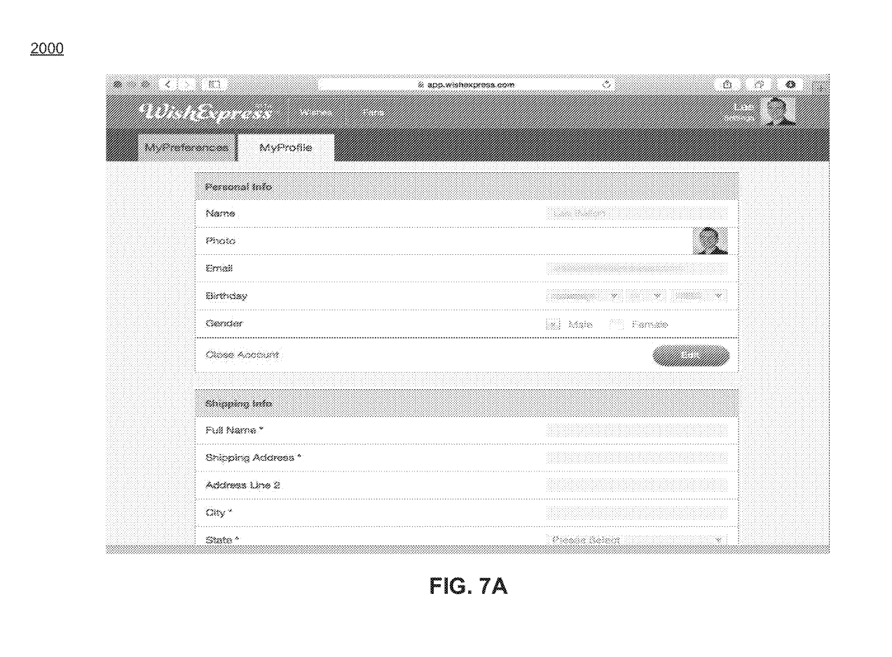

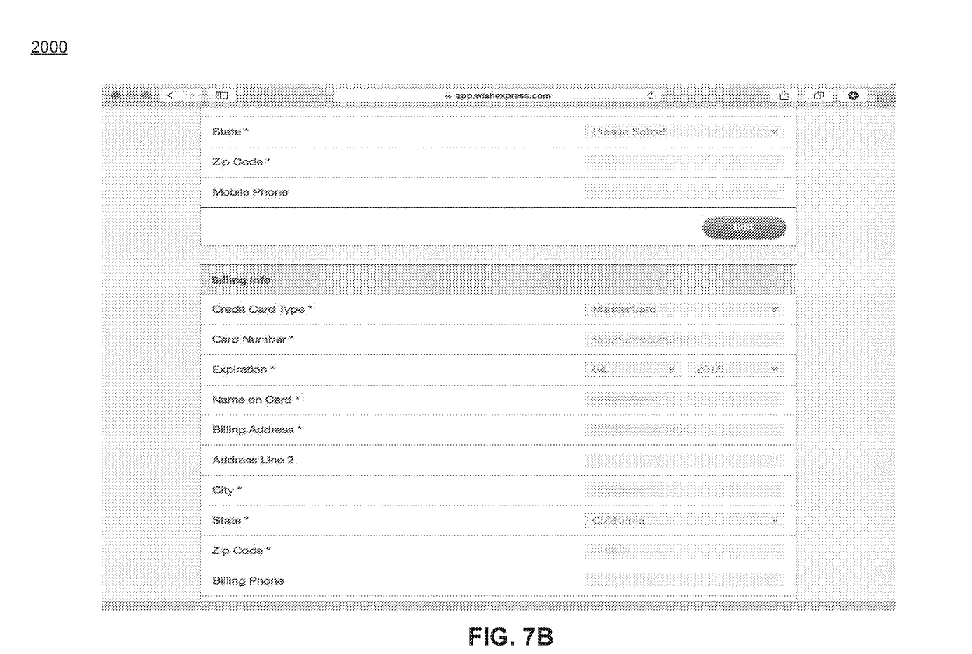

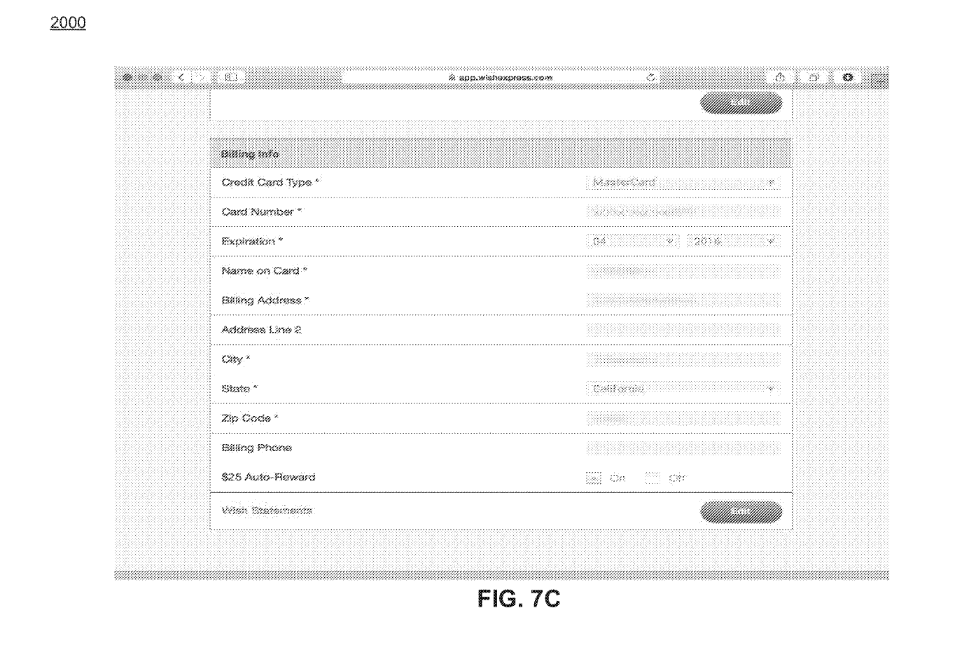

FIGS. 7A-C show user interface webpages and a workflow in accordance with one or more embodiments, including setting up a user profile, including name, email address, birthday, gender, shipping information and billing information.

FIG. 7A shows an exemplary graphical user interface 2000 for configuring a user or member profile, in accordance with various embodiments. The member's profile page is where they can review and edit their account. In some embodiments, the “Personal Info” is originally supplied by Facebook-Connect for Facebook users. Kids without Facebook can enter this info during registration. The items can be changed by clicking “Edit” then making changes, then clicking “Save” to lock edits. “Revert” during editing will disregard changes. “Shipping Info” is entered by the member during their first goodie redemption. This address is then used as a default for future goodie redemptions. The member can edit the shipping per goodie redemption. They can also change the default here by clicking “Edit” then making changes, then clicking “Save” to lock edits. “Revert” during editing will disregard changes.

FIG. 7B shows another portion of the exemplary graphical user interface 2000 for configuring a user or member profile, in accordance with various embodiments. In some embodiments, adult members can review and edit their billing information. In some embodiments, billing information and associated entry areas are not displayed for child users. In some embodiments, the billing info is entered by the member during their first WeCoin purchase. Unless changed later, this info is then used with a payment processing system (e.g., PayPal) as a default for all future purchases. The member can edit their billing info by clicking “Edit” then making changes, then clicking “Save” to lock edits. “Revert” during editing will disregard changes. The member also has the chance to turn Auto-Reward on or off “Wish Statements” text link goes to their history page.

FIG. 7C shows another portion of the exemplary graphical user interface 2000 for configuring a user or member profile, in accordance with various embodiments. In some embodiments, a portion of the graphical user interface 2000 is substantially similar to the graphical user interface 1800 of FIG. 5E.

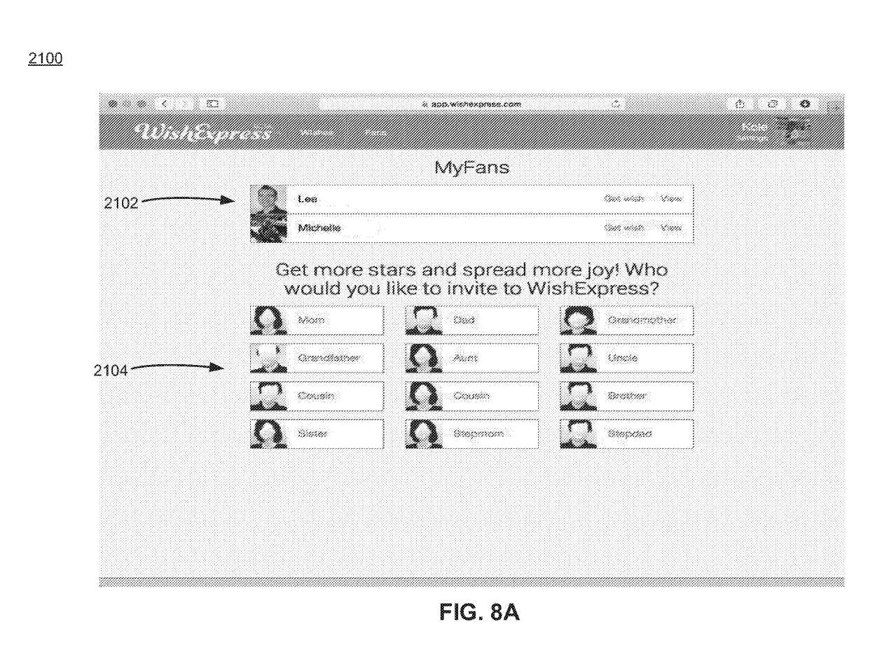

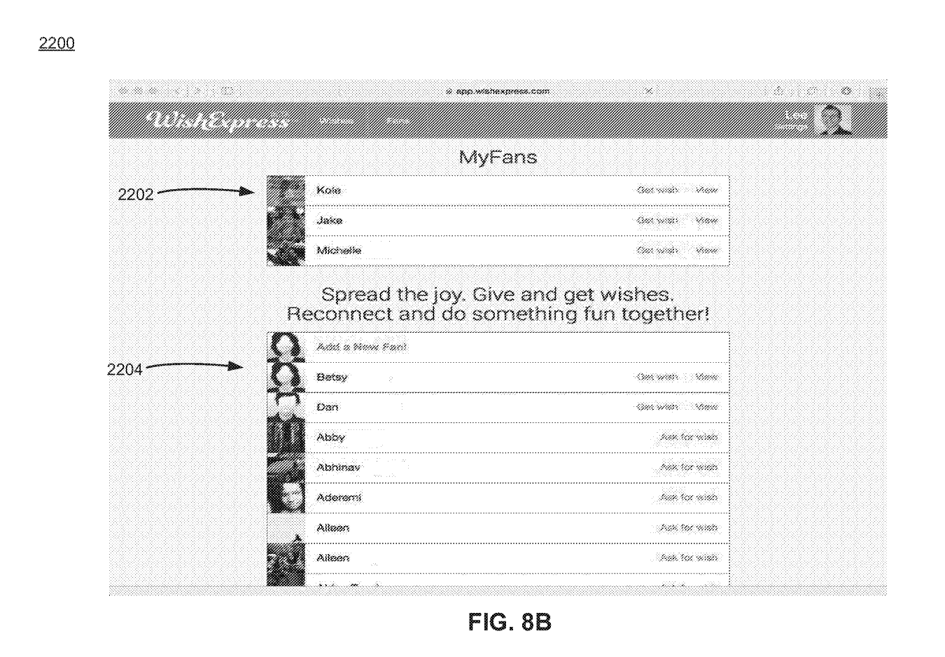

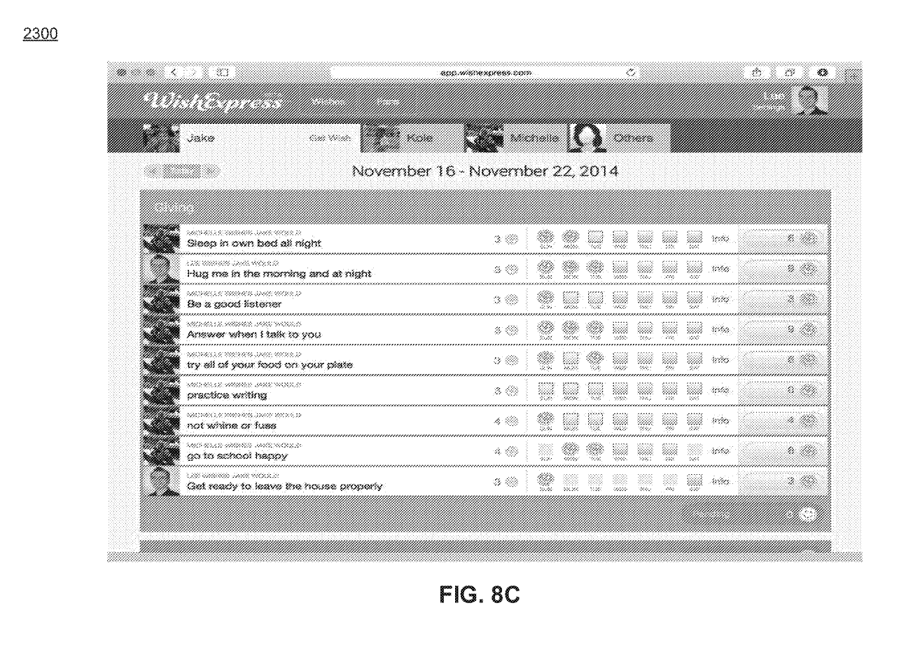

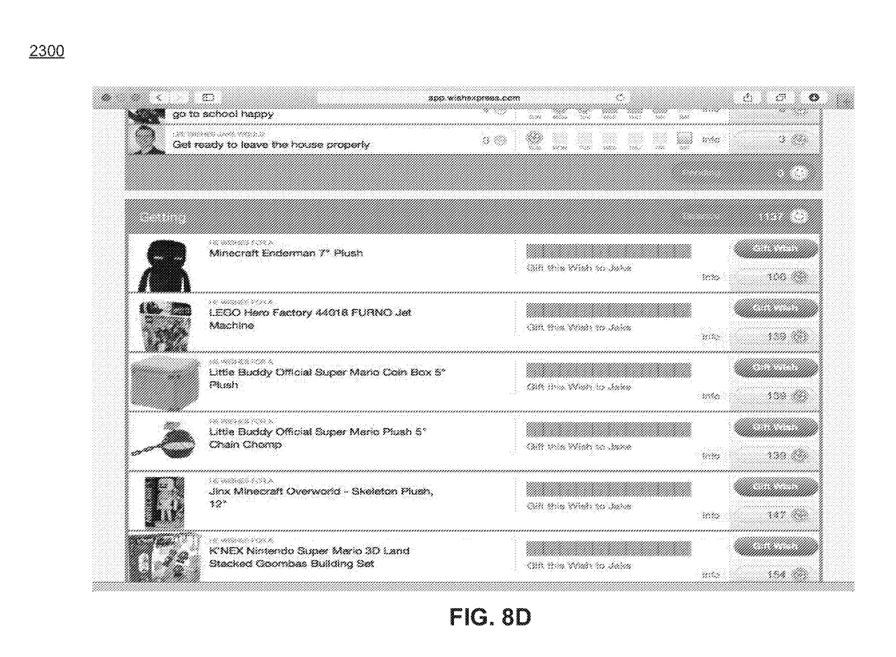

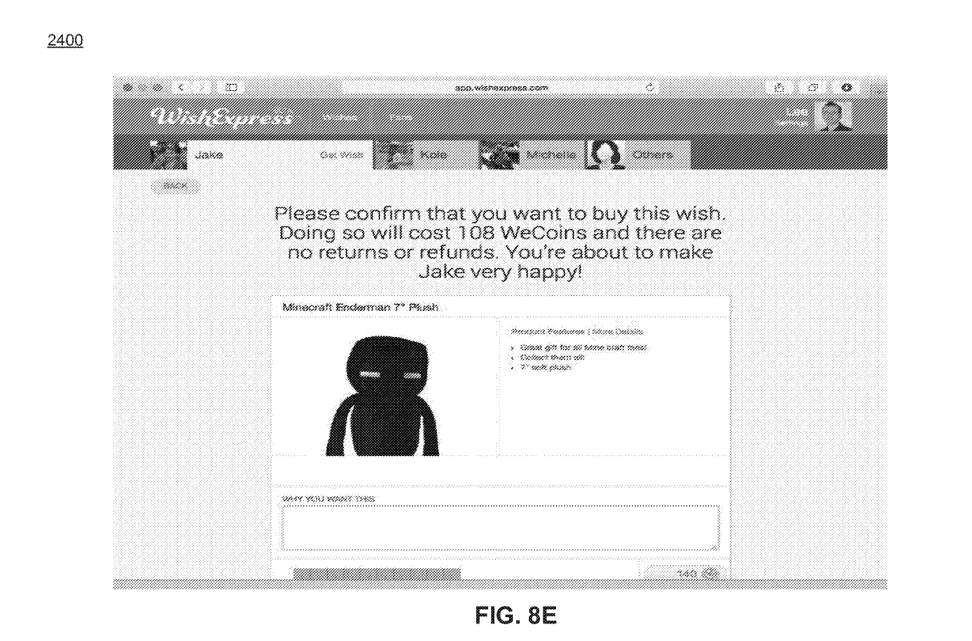

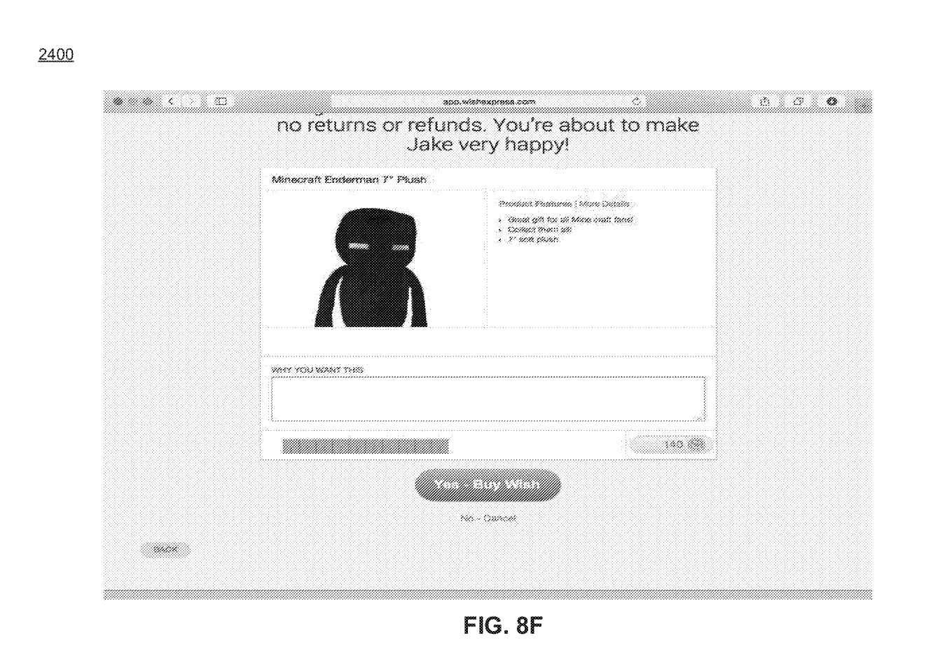

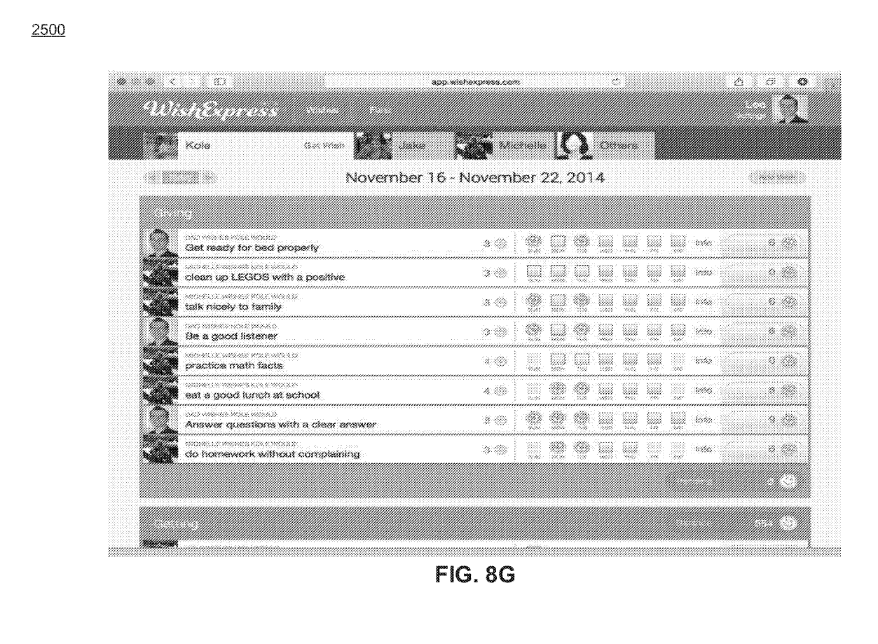

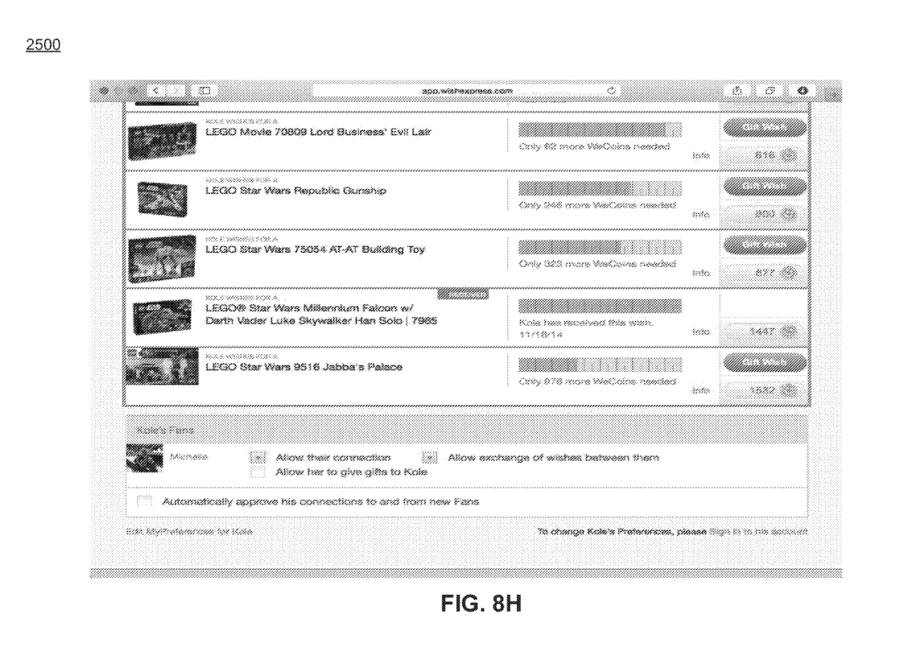

FIGS. 8A-H show user interface webpages and a workflow in accordance with one or more embodiments, including selecting wish granting users, shown as “fans,” viewing of a wish receiving user's list of desired wishes, a fan gifting a wish and parental control over a child's fan interaction.

FIG. 8A shows an exemplary user interface 2100 for a child for viewing and selecting fans, in accordance with various embodiments. The user interface 2100 includes a current fans portion 2102 and a portion 2104 for inviting others to a wish management system (e.g., WishExpress). “Fans” are the connections that members have (e.g., within the wish management system). Members see their active connections up top in the current fans portion 2102. Kids then have the opportunity to add more relationship types (listed below) in the portion 2104.

FIG. 8B shows an exemplary user interface 2200 for a parent for viewing and selecting fans, in accordance with various embodiments. The user interface 2200 includes a current fans portion 2202 and a portion 2204 for inviting others to a wish management system (e.g., WishExpress). Adults likewise see their Fans with active wishes up top. The second list contains people that the member does not have an active wish exchange with. In some embodiments, this list is supplied by the member's Facebook contacts. In some embodiments, anyone with a WE account is listed at the top of the list. In some embodiments, the member can: click View to see the fan's dashboard, click Get Wish to request a new wish, or click Give Wish to see new specifications or details.

FIG. 8C shows an exemplary graphical user interface 2300 for viewing a fan's dashboard, in accordance with various embodiments. Once a particular fan is selected from the previous fan selection page (e.g., graphical user interface 2100 or 2200), then the user sees their fan's dashboard. In some embodiments, items are only displayed if the fan has decided to “Share on WishExpress.” Otherwise, it displays as a generic “ . . . is getting/giving wish” message. In some embodiments, the exception is parents, they can see everything their kid is doing. The member may also see tabs of their most popular other active fans. As many tabs as possible displays depending on device width. In some embodiments, the last tab is “Others” which links back to the fan selection page.

FIG. 8D shows another portion of exemplary graphical user interface 2300 after scrolling down, in accordance with various embodiments. In some embodiments, because the member can see their fan's wishes, they have the ability to “Gift Wishs” for their fans thereby initiating purchase and payment for the item, experience, etc., that is wished for.

FIG. 8E shows an exemplary graphical user interface 2400 after clicking a gift wish button in graphical user interface 2300, in accordance with various embodiments. In some embodiments, upon clicking “Gift Wish” the member confirms the one-time charge. In some embodiments, gifting does not draw from the member's wallet but rather, they're asked to purchase the exact cost of the particular item.

FIG. 8F shows another portion of exemplary graphical user interface 2400, in accordance with various embodiments. The user or member can click “Yes—Buy Wish” to confirm purchase or click “No—Cancel” to cancel which returns the member to the fan's dashboard. The “Back” button returns the member to fan's dashboard.

FIG. 8G shows an exemplary graphical user interface 2500 for managing a child's dashboard, in accordance with various embodiments. In some embodiments, when the fan is a parent's kid, then the parent has full delegation over their child. Thus, the parent can manage the dashboard as if they were the child. The parent can make mark-offs (e.g., of completed tasks) and add/edit wishes.

FIG. 8H shows another portion of graphical user interface 2500 after scrolling down, in accordance with various embodiments. Parents can also establish additional controls (per each of their kids) at the bottom of that kid's dashboard when viewed in the “Fans” section. For example, parents can require approval for all fan connections (bottom option). Then per fan, parents can decide whether their kid's fan connection is allowed (can be easily turned on or off), whether they're allowed to exchange wishes (favors) with each other, or whether the fan can gift goodies to the kid.

There may be a variety of user registration and invitation rules in accordance with one or more embodiments, including guardrails on use by children. Table I shows an exemplary set of user registration and invitation rules, in accordance with some embodiments.

TABLE I
exemplary user registration and invitation rules

```
A kid's first fan connection must be their parent (guardian)
A kid's parent must approve the kid's other fan connections
  A parent can, however, set up automatic approval
Adults may register without a kid
A kid may register without a parent, however, the account is worthless
until the parent joins too
  Until a kid's parent joins, all the kid can really do is add Goodies
  They can't connect to other users
  They can't set up favor-based wishes with others
  They can't receive WeCoins
Users should not have more than one account. In other words, we should
determine whether an invited person is already a member. If so, the fan
connection is made. If not, the person enters into registration flow.
Adults must register with Facebook-Connect
Registration for kids in order of WE's preference:
  1. Facebook-Connect: if the kid is old enough to have a FB account
  2. Email as username: if the kid is 13 or older
  3. Username and Password created by kid and “Go-get-them” flow to
invite associated parent
```

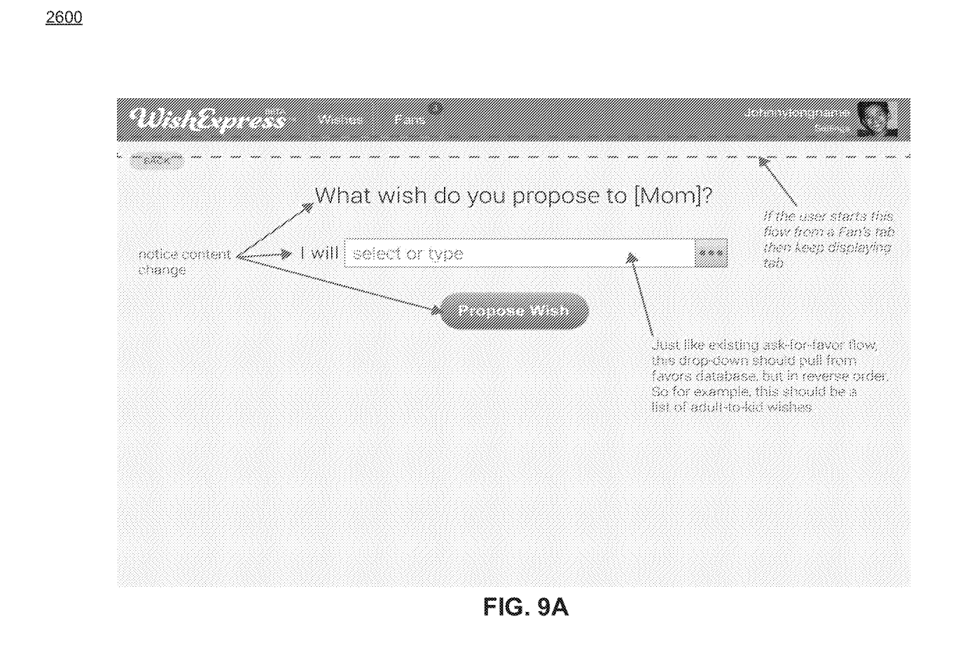

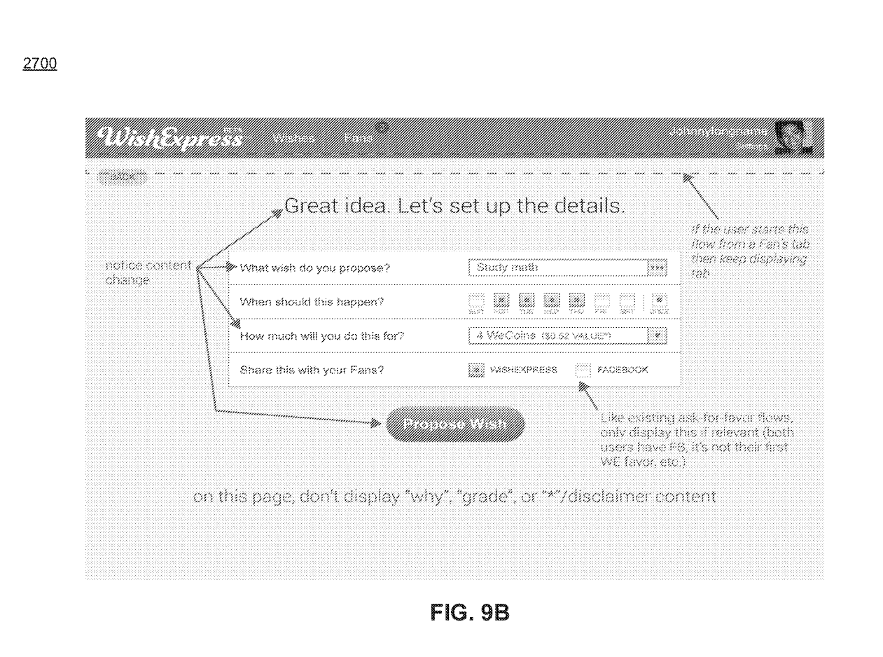

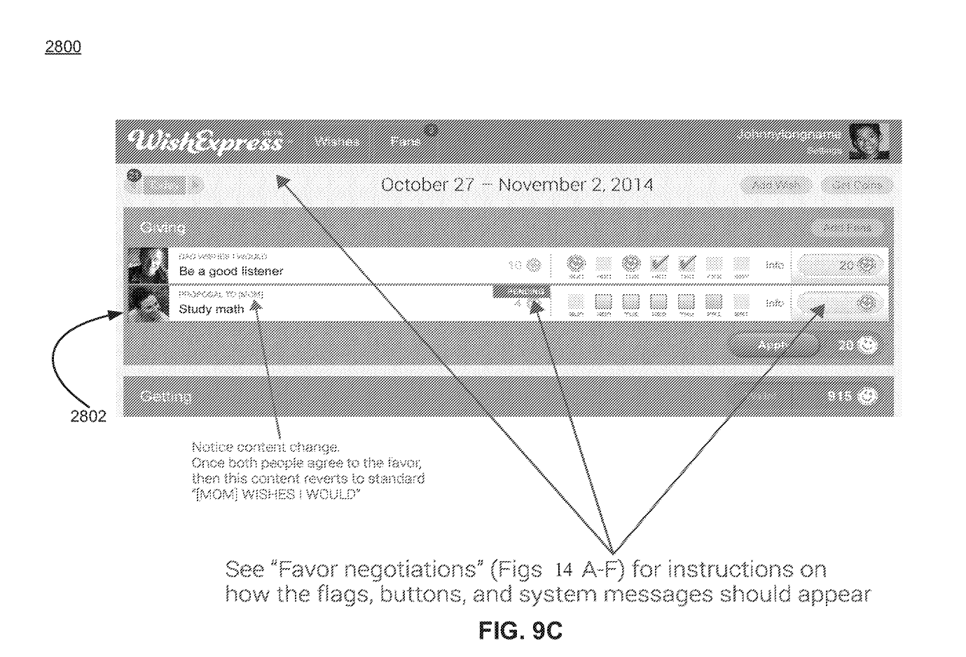

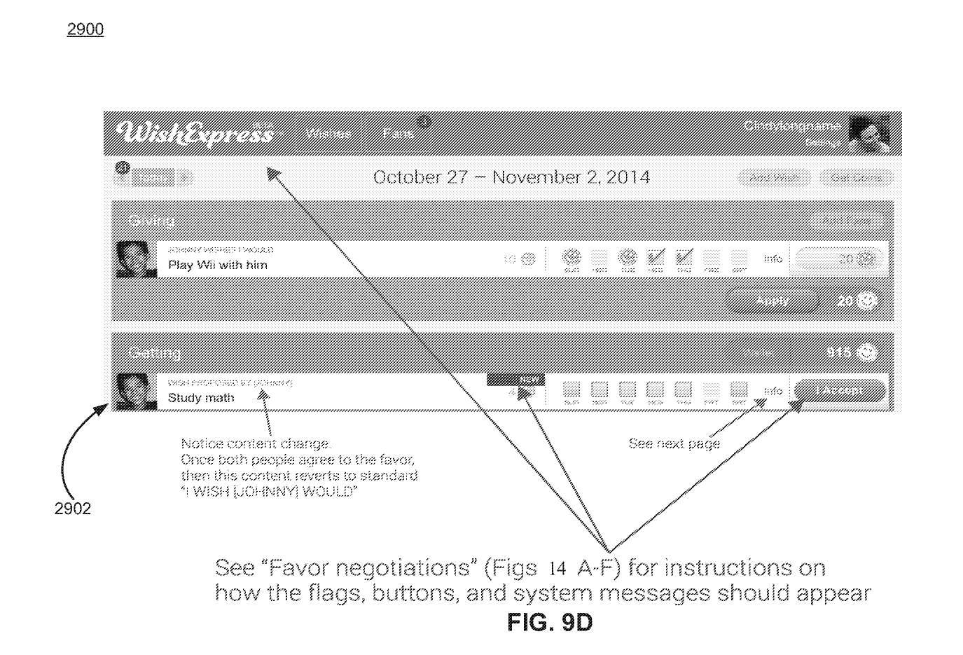

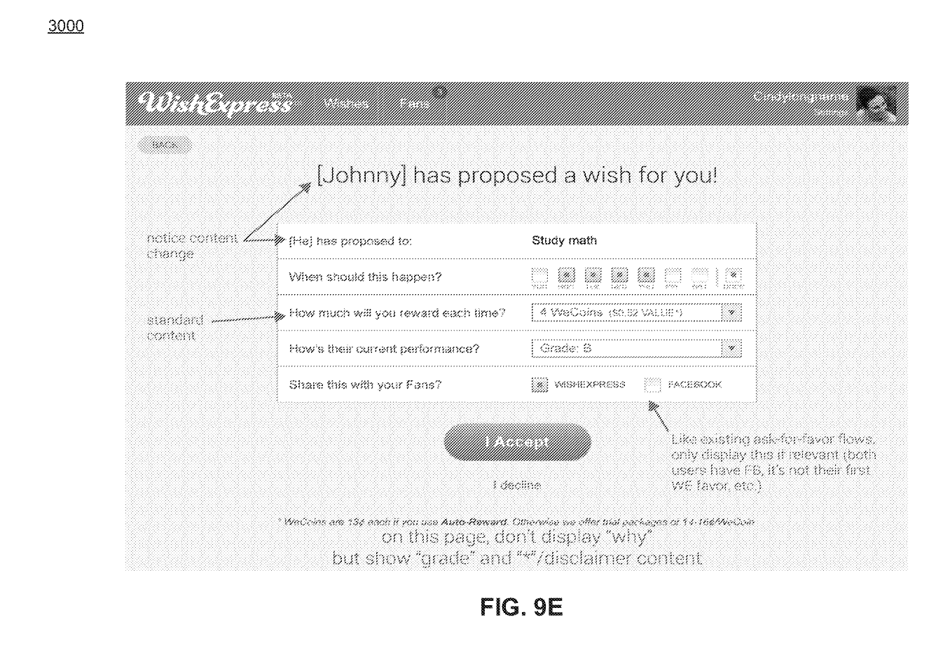

FIGS. 9A-F show user interface webpages and a workflow in accordance with one or more embodiments, including a wish, shown as a task “wish” proposal, which may be part of a negotiation process.

FIG. 9A shows an exemplary graphical user interface 2600 for submitting a wish to another person, in accordance with various embodiments. FIG. 9A depicts a wish being submitted to a child's mother. If the user or member clicked “Get Wish” on a fan page or fan's tab (e.g., FIGS. 8A-B or 8E), graphical user interface 2600 can be displayed. In some embodiments, if the user clicks “Get Wish” from the fan's tab, the upper portion of the graphical user interface remains from graphical user interface 2400. The content below the upper portion changes as shown in graphical user interface 2600. Similar to the existing ask-for-favor graphical user interfaces and flow, the dropdown of graphical user interface 2600 displays options from a favors database. In some embodiments, the favors may be displayed in reverse order, e.g., a list of adult-to-kid wishes when the wish is being proposed to a parent (e.g., a mother or a father).

FIG. 9B shows an exemplary graphical user interface 2700 for configuring the details for a wish, in accordance with various embodiments. If the user clicks “Get wish” from the fan's tab, the upper portion of the graphical user interface remains from graphical user interface 2400. The content below the upper portion changes as shown in graphical user interface 2700. In some embodiments, similar to other ask-for-favor flows, the share with social network (e.g., Facebook) options are shown if relevant (e.g., both users have Facebook and it is not their first WE favor, etc.). In some embodiments, the “why,” “grade,” or “*”/disclaimer content is not shown.

FIG. 9C shows an exemplary graphical user interface 2800 for a pending wish, in accordance with various embodiments. FIG. 9C depicts an exemplary dashboard (e.g., of graphical user interface 100) with a pending wish (e.g., to a parent). Exemplary dashboard portion 2802 shows the wish marked as “PROPOSAL TO [MOM],” a pending status, and without a number of WeCoins. Upon acceptance of the proposal, the wish will be shown as “[MOM] WISHES I WOULD.” Favor negotiations are described with respect to FIGS. 14A-F including instructions covering how the flags, buttons, and system messages appear.

FIG. 9D shows an exemplary graphical user interface 2900 for accepting a proposed wish, in accordance with various embodiments. FIG. 9D depicts an exemplary dashboard (e.g., of graphical user interface 100) with a pending wish (e.g., from a parent). Exemplary dashboard portion 2902 shows the wish as “WISH PROPOSED BY [JOHNNY],” a new status, with days to mark-off, an “Info” link for details (e.g., graphical user interface 3000), and an “I Accept” button. Upon acceptance of the proposal, the wish will be shown as “I WISH [JOHNNY] WOULD.” Favor negotiations are described with respect to FIGS. 14A-F including instructions covering how the flags, buttons, and system messages appear.

FIG. 9E shows an exemplary graphical user interface 3000 for viewing the details of a wish, in accordance with various embodiments. The exemplary graphical user interface 3000 may be substantially similar to graphical user interface 2700. The exemplary graphical user interface 3000 shows the parent's view including that the wish was proposed by Johnny and the details. In some embodiments, similar to other ask-for-favor flows, the share with social network (e.g., Facebook) options are shown if relevant (e.g., both users have Facebook and it is not their first WE favor, etc.). In some embodiments, the “why,” “grade,” or “*”/disclaimer content is not shown.

In some embodiments, parent approval is required on ask-for-wish flows or submissions unless the parent has auto-approval turned on. In some embodiments, the proposing of a favor can also be sent to a Facebook connection even if that person is not yet a WE Fan connection. In this case, the experience will be like inviting a new fan with a favor request with the difference being the message (e.g., due to the person not being a WE Fan connection when the message is sent).

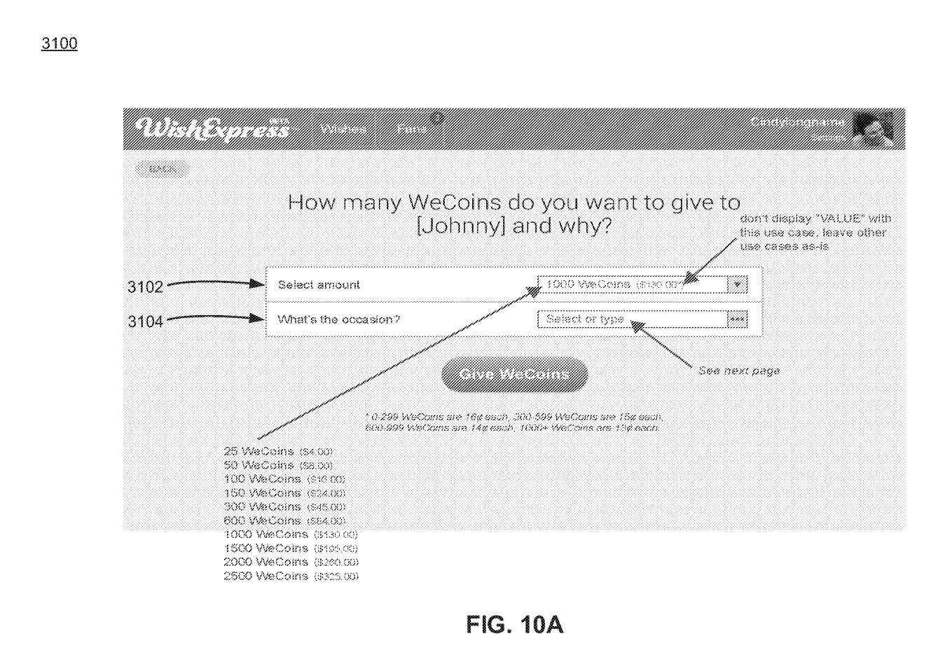

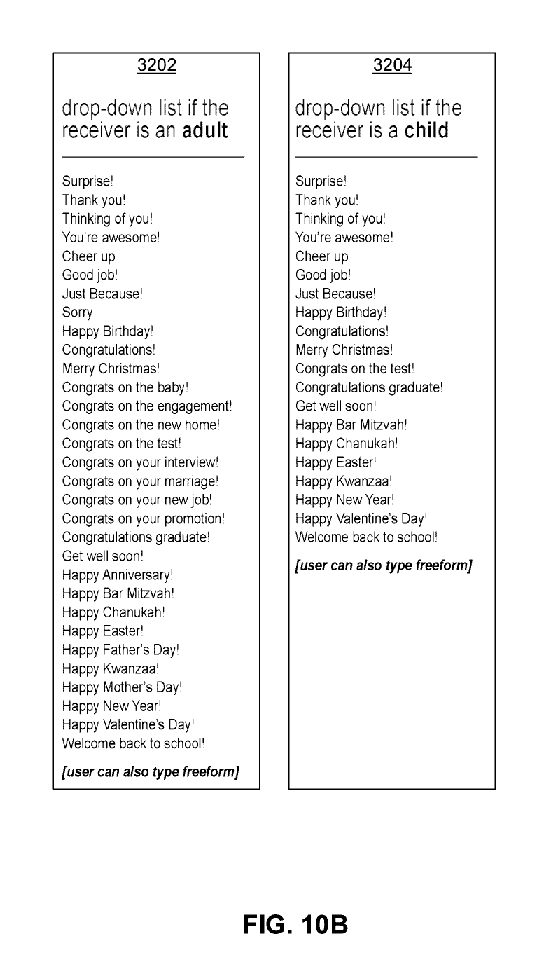

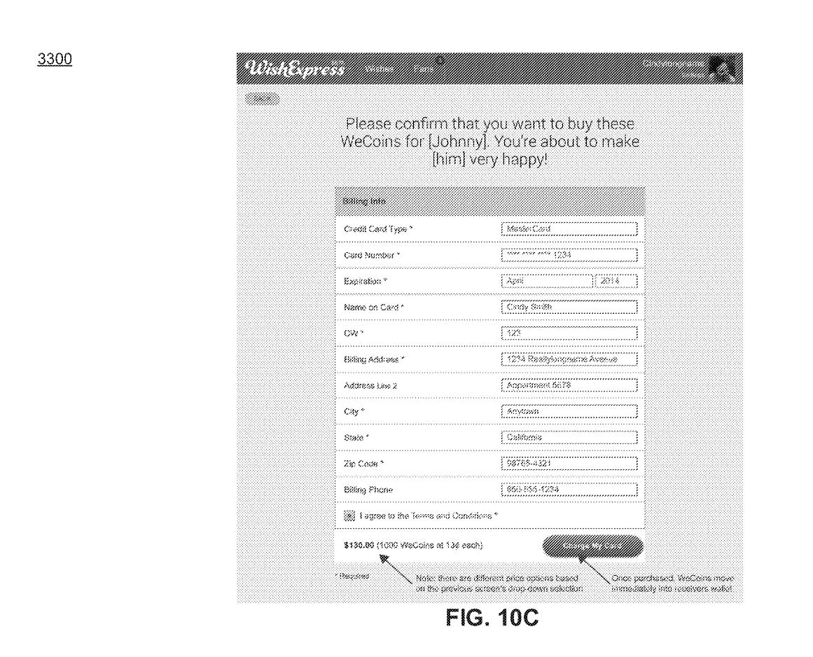

FIGS. 10A-E show user interface webpages and a workflow in accordance with one or more embodiments, including gifting digital system currency, shown as “WeCoins.”

FIG. 10A shows an exemplary graphical user interface 3100 for giving digital currency to another user, in accordance with various embodiments. FIG. 10A depicts the graphical user interface 3100 for a parent to give digital currency (e.g., WeCoins) to a child. The area 3102 of the graphical user interface 3100 allows selection from a dropdown of how much digital currency (e.g., WeCoins), he or she is going to give. The area 3104 the graphical user interface 3100 allows selection from a dropdown of an occasion for giving the currency. The user can then click the “Give WeCoins” button to initiate the transfer of the currency.

FIG. 10B shows exemplary dropdowns for the graphical user interface 3100 to allow selection of an occasion, in accordance with various embodiments. FIG. 10B includes a drop-down list 3202 if the receiver is an adult and drop-down list 3204 if the receiver is a child.

FIG. 10C shows an exemplary graphical user interface 3300 for confirming and setting up payment for the digital currency, in accordance with various embodiments. The graphical user interface 3300 allows a user to enter billing information, see the amount of digital currency being purchased, see the amount of money to be spent, and initiate the payment with a “Charge My Card” button.

FIG. 10D shows an exemplary graphical user interface 3400 including a dashboard (e.g., dashboard 100) after transferring digital currency to another user. FIG. 10D depicts a parent's dashboard after sending his or her child digital currency (e.g., WeCoins). For example, the graphical user interface 3400 includes an entry 3402 indicating that 1000 WeCoins were transferred to Johnny for his birthday. Entry 3402 further includes an “Info” link which is a link to a credit card receipt. The entry 3402 is recorded at the date of purchase and moves accordingly through a user's history. The graphical user interface 3400 further includes entry 3404 which shows an entry on a graphical user interface accessed by the receiver (e.g., child). The entry 3404 indicates that 1000 WeCoins have been received and includes a link to say thanks for the gift. The entry 3404 is recorded at the date of purchase and moves accordingly through a user's history. The entry 3404 may display at the top of the child's list for a period of time.

In some embodiments, digital currency (e.g., WeCoins) can also be given/gifted to a Facebook connection even if that person is not yet a WE Fan connection. In this case, the experience is like inviting a new fan with a favor request with the difference being that the message is associated with a giving/gifting of digital currency.

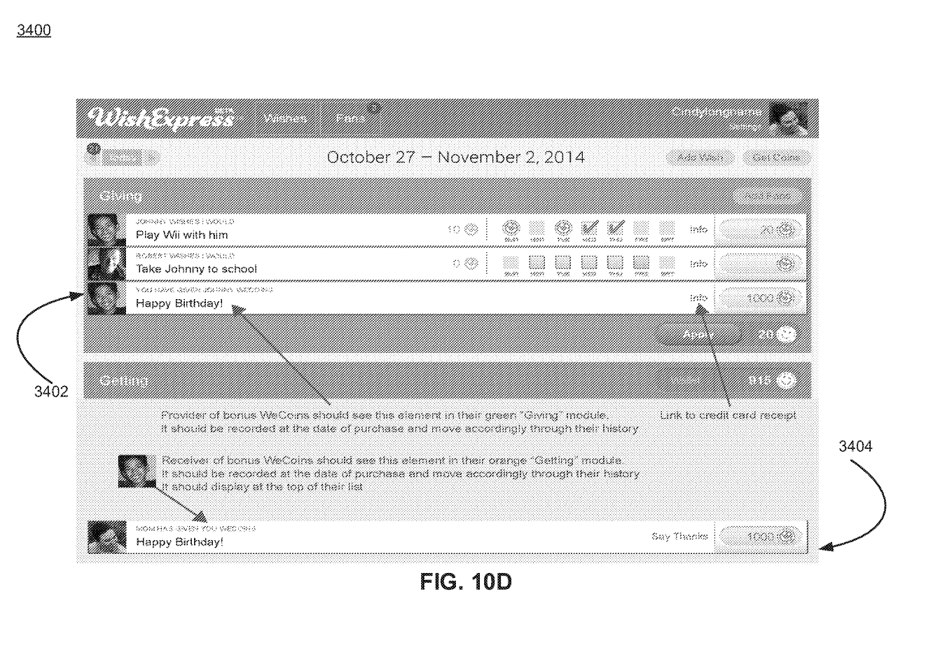

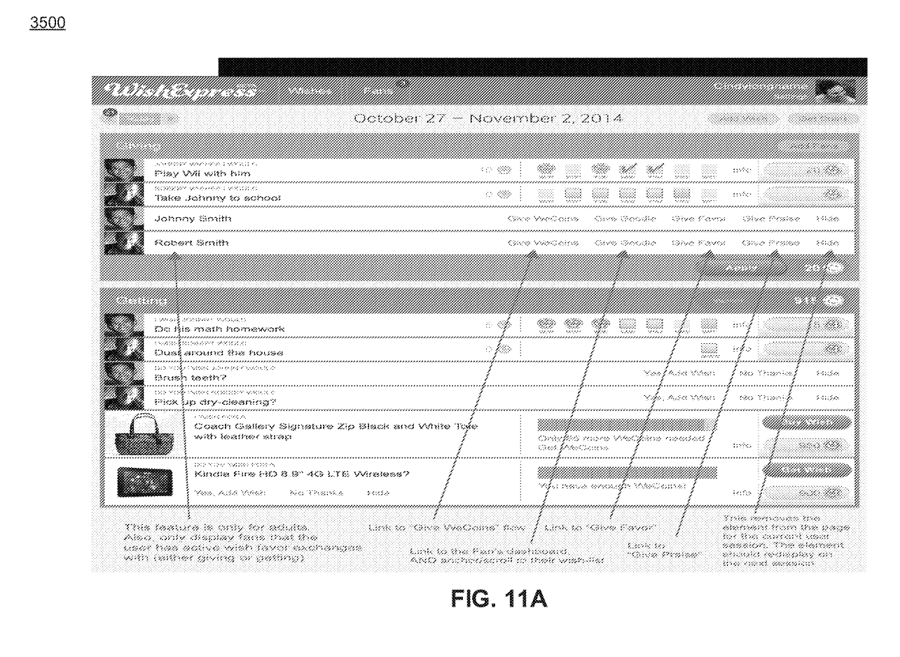

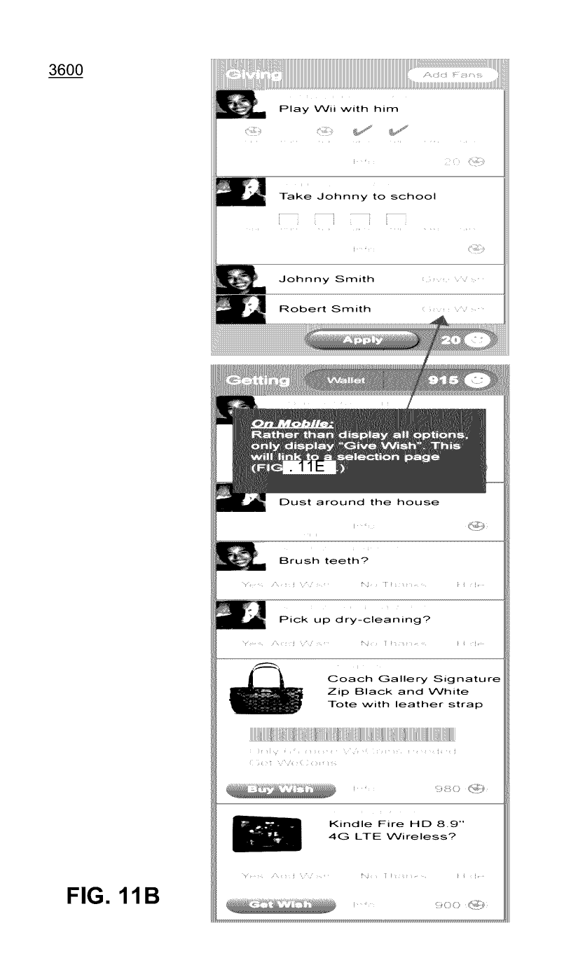

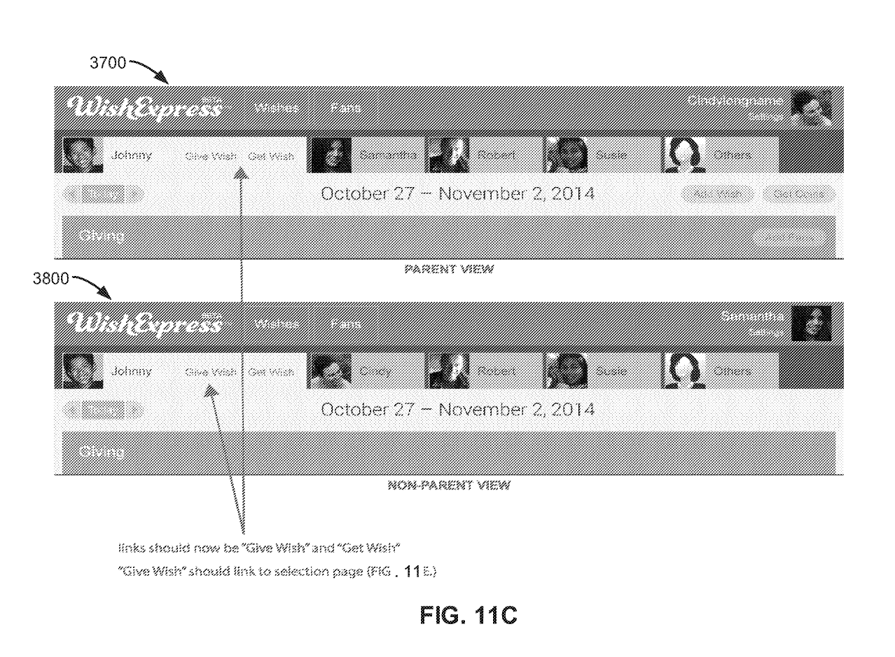

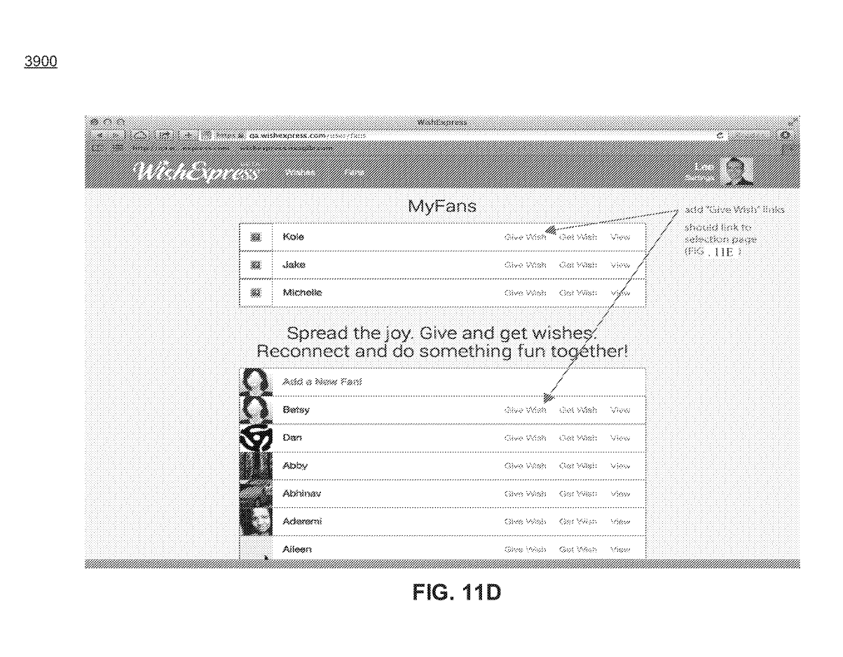

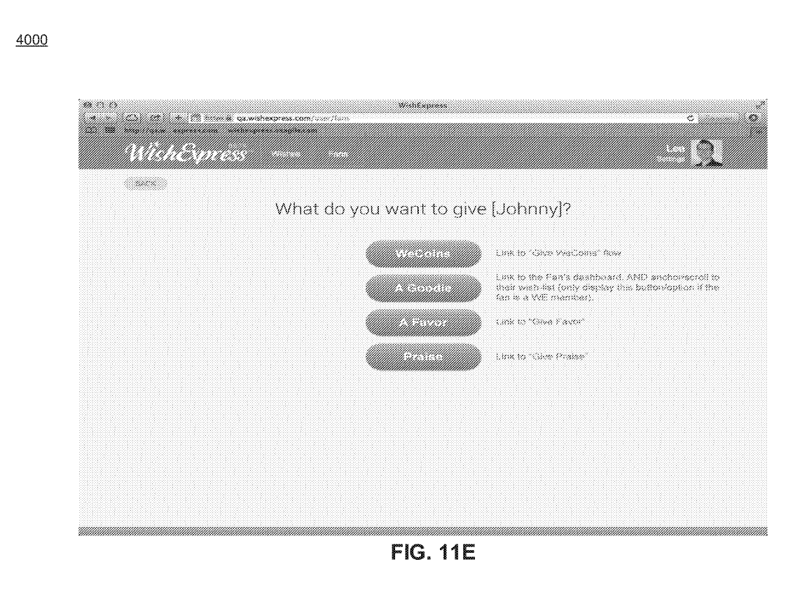

FIGS. 11A-E show user interface webpages and mobile webpages, and a workflow in accordance with one or more embodiments, including parent and non-parent adult webpages.

FIG. 11A shows an exemplary graphical user interface 3500 for interacting with other users, in accordance with various embodiments. FIG. 11A depicts the graphical user interface 3500 for an adult. The graphical user interface 3500 show entries or rows for children and fans that a user has active wish favor exchanges with (e.g., either giving or receiving). The entries include links for giving digital currency (e.g., “Give WeCoins”), giving an item or a goodie (e.g., “Give Goodie”), giving a favor (e.g., “Give Favor”), giving praise (e.g., “Give Praise”), or hiding the entry (e.g., “Hide”). In some embodiments, the hiding of the entry or element from the page for the current user session. The entry may thus be redisplayed on the next user session.

FIG. 11B shows an exemplary graphical user interface 3600 for giving and getting wishes and interacting with other users for a mobile device, in accordance with various embodiments. In some embodiments, the graphical user interface 3600 is substantially similar to graphical user interface 3500. In some embodiments, the exemplary graphical user interface 3600 includes a “Give Wish” option instead of other options (e.g., of graphical user interface 3500).

FIG. 11C shows exemplary graphical user interface 3700 and 3800 after user selection, in accordance with various embodiments. The graphical user interface 3700 depicts a parent's view after selecting a child (e.g., Johnny via a tab). The graphical user interface 3700 allows the parent to give a wish (e.g., “Give Wish”) or get a wish (e.g., “Get Wish”) to/from the child. The graphical user interface 3800 depicts a non-parent's view after selecting a user (e.g., Johnny via a tab). The graphical user interface 3800 allows the non-parent to give a wish (e.g., “Give Wish”) or get a wish (e.g., “Get Wish”) to/from the user. In some embodiments, the “Give Wish” link brings a user to the graphical user interface 4000 of FIG. 11E.

FIG. 11D shows an exemplary graphical user interface 3900 of Fans and people that can be invited, in accordance with various embodiments. The graphical user interface 3900 includes links for giving a wish (e.g., “Give Wish”) or getting a wish (e.g., “Get Wish”) to/from fans and people that can be invited to WishExpress. The graphical user interface 3900 further includes links for viewing information (e.g., View) about other users and people that can be invited to WishExpress. In some embodiments, the “Give Wish” link brings a user to the graphical user interface 4000 of FIG. 11E.

FIG. 11E shows an exemplary graphical user interface 4000 for giving a wish, in accordance with various embodiments. In some embodiments, the graphical user interface 4000 is substantially similar to graphical user interface 600 (e.g., of FIG. 2A). The graphical user interface 4000 includes a link to give digital currency (e.g., WeCoins), a link to select an item (e.g., “A Goodie”), a link to give a favor (e.g., “A Favor”), and praise (e.g., “Give Praise”). The link to give digital currency brings a user to a graphical user interface to give digital currency, as described herein. In some embodiments, the link to select an item or goodie brings a user to the Fan's dashboard (e.g., dashboard 100) and anchors or scrolls to the Fan's wish-list (e.g., getting module 104). In some embodiments, the link to give a user an item or a goodie is displayed upon the Fan being a WE member.

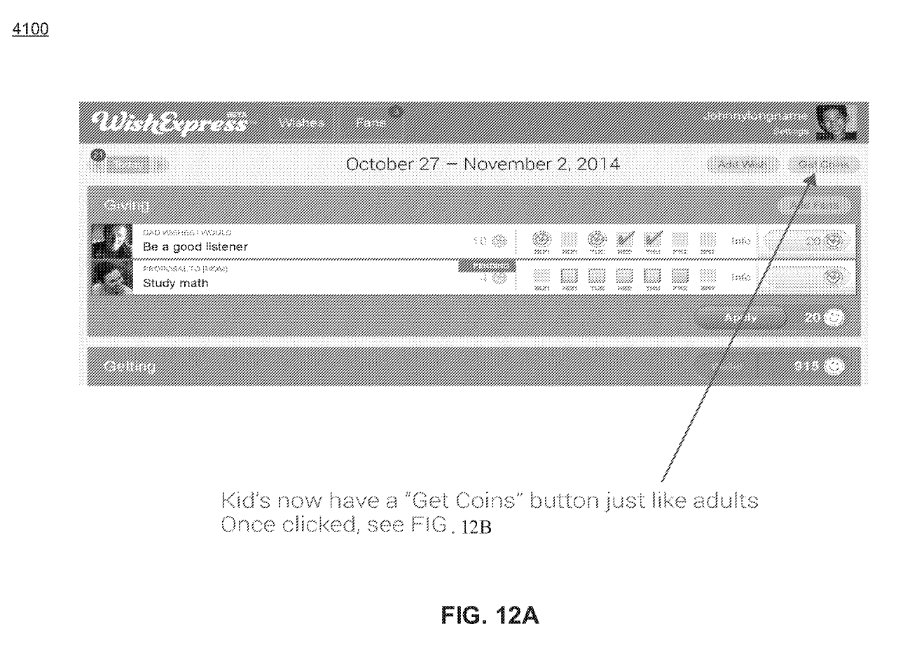

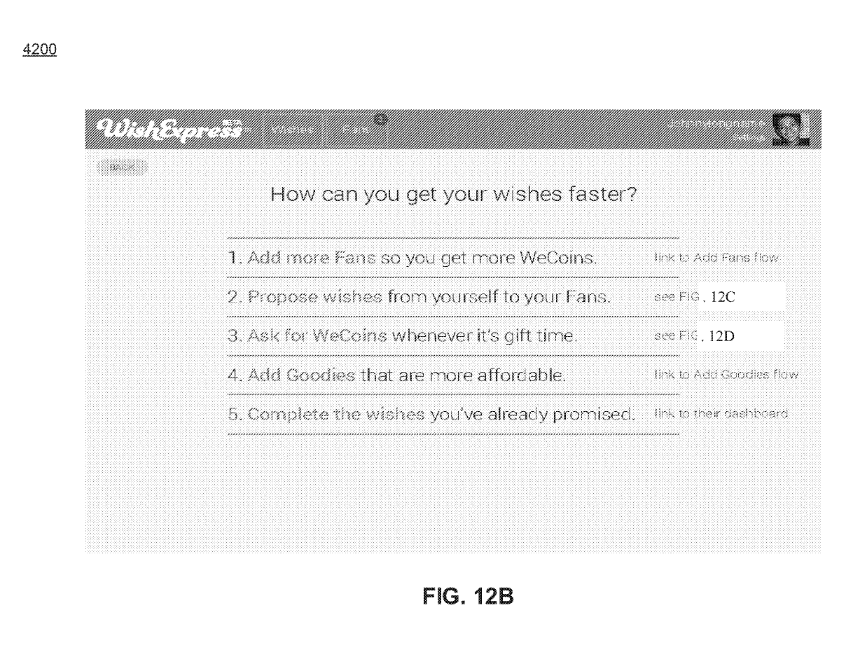

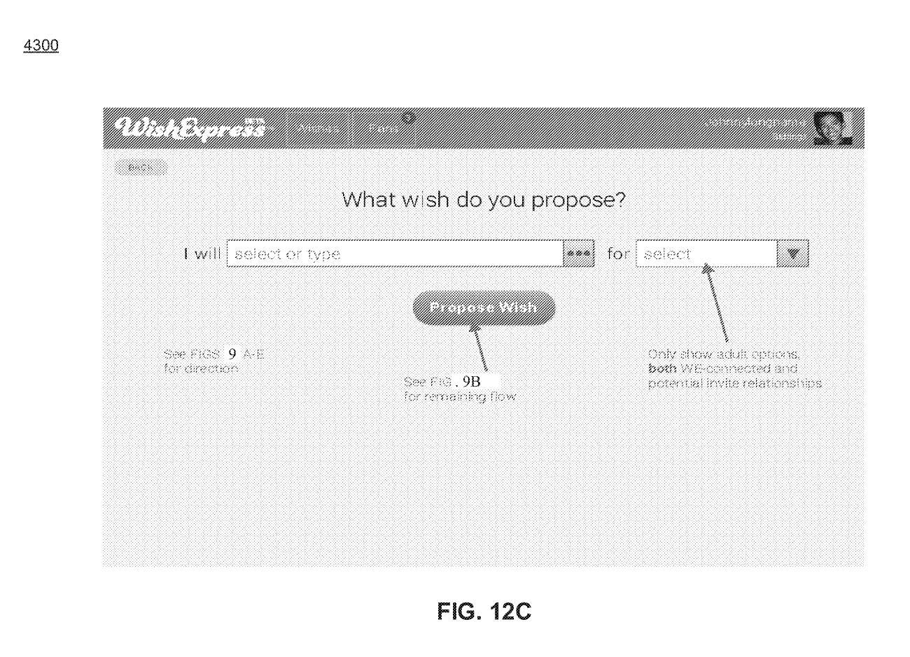

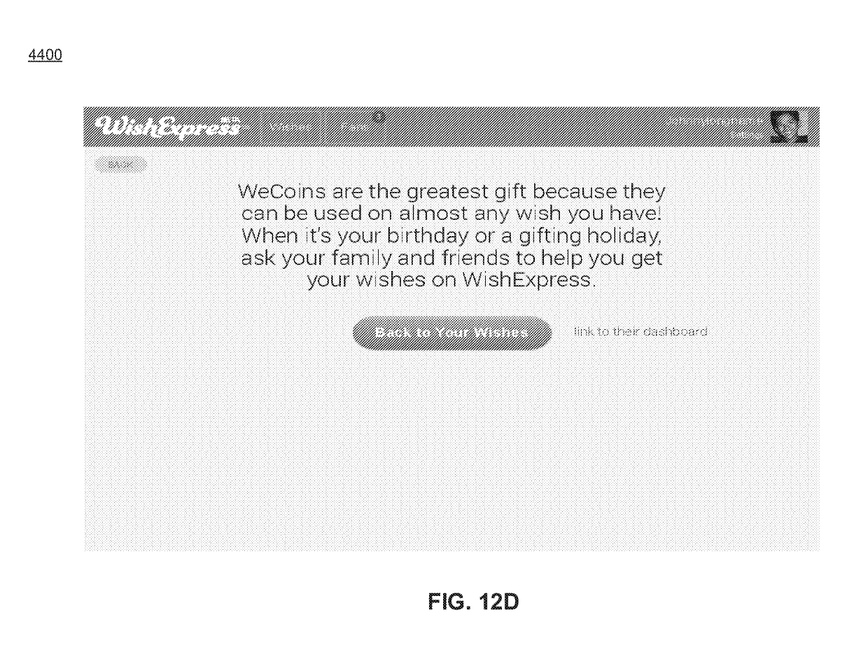

FIGS. 12A-D show user interface webpages and a workflow in accordance with one or more embodiments, including kid webpages with task selections, shown as “giving,” and wish proposal.

FIG. 12A shows an exemplary graphical user interface 4100 including a button or link to get more digital currency, in accordance with various embodiments. FIG. 12A depicts the graphical user interface 4100 presented to a child user with a “Get Coins” link which is also shown to adults. In some embodiments, clicking the “Get Coins” link brings a user to graphical user interface 4200 of FIG. 12B.

FIG. 12B shows an exemplary graphical user interface 4200 including options for getting wishes, in accordance with various embodiments. FIG. 12B depicts the graphical user interface 4200 for assisting a child in getting more digital currency (e.g., WeCoins) faster and thereby wishes (e.g., items, activities, favors, etc.) faster. The graphical user interface 4200 includes a link to get more fans (e.g., “Add more Fans”), a link to propose wishes (e.g., “Propose wishes”), a link to ask for digital currency (e.g., “Ask for WeCoins”), a link to add items (e.g., “Add Goodies”), and view wishes (e.g., “Complete the wishes”). The link to get more fans brings a user to an add fans page (e.g., graphical user interface 2100 of FIG. 8A). The link to propose wishes brings a user to the graphical user interface 4300 of FIG. 12C. The link to ask for digital currency brings a user to graphical user interface 4400 of FIG. 12D. The link to add items brings a user to a page for adding items to his or her wish list (e.g., the graphical user interface 600 of FIG. 2A). The link to view wishes brings a user back to his or her dashboard (e.g., dashboard).

FIG. 12C shows a graphical user interface 4300 for proposing a wish, in accordance with various embodiments. The graphical user interface 4300 allows selection of a task and selection of a person. The graphical user interface 4300 further includes a “propose wish” button to submit the wish. In some embodiments, the user may be brought to the graphical user interface 2700 of FIG. 9B and other graphical user interfaces of FIGS. 9A-E.

FIG. 12D shows an exemplary graphical user interface 4400 for informing a user interested about digital currency, in accordance with various embodiments. In some embodiments, the graphical user interface 4400 includes a message of “WeCoins are the greatest gift because they can be used on almost any wish you have! When it's your birthday or a gifting holiday, ask your family and friends to help you get your wishes on WishExpress.” The graphical user interface 4400 may further include a link for a user to view his or her wishes (e.g., “Back to Your Wishes”).

FIGS. 13A-L show user interface webpages and a workflow in accordance with one or more embodiments, including configuration for trial use.

FIG. 13A shows an exemplary graphical user interface 4500 of a new adult member's dashboard prior to rewarding digital currency, in accordance with various embodiments. The graphical user interface 4500 depicts a new adult member's dashboard prior to rewarding digital currency (e.g., WeCoins). The graphical user interface 4500 includes an entry 4502 of a child that wishes to be connected on a wish management system (e.g., WishExpress and/or system 19000-21000). The graphical user interface 4500 further includes a profile label 4504 associated with an adult profile (including an image) and a label 4506 indicating that a wish is active or pending.

FIG. 13B shows an exemplary graphical user interface 4600 of a new child member's dashboard prior to earning digital currency (e.g., WeCoins) and accepting a parent's wish. The graphical user interface 4600 includes a link 4602 (e.g., “I promise”) for accepting a wish and a label 4604 indicating that there is a new wish.

FIG. 13C shows an exemplary graphical user interface 4700 of a new child member's dashboard prior to earning digital currency (e.g., WeCoins) after accepting a parent's wish, in accordance with various embodiments. The graphical user interface 4700 may be displayed after a child user has clicked the link 4602. The child may click boxes 4702 to indicate that the child has completed the tasks associated with the wish on Sunday and Monday of the current week.

FIG. 13D shows an exemplary graphical user interface 4800 of a new child member's dashboard after marking off (earning) placeholder/trial digital currency (e.g., WeCoins), in accordance with various embodiments. The graphical user interface 4800 may be displayed after the child marks off boxes 4702. The graphical user interface 4800 includes a message 4802 that indicates that the child is owed coins, and checks 4806 indicating that the task has been marked-off as completed on the associated days. The child may then click an apply button 4804 to save or submit the marked-off or completed days.

FIG. 13E shows an exemplary graphical user interface 4900 of a new child member's dashboard after earning placeholder/trial digital currency (e.g., WeCoins), in accordance with various embodiments. The graphical user interface 4900 includes smiley faces 4902 for days that the child earned digital currency (e.g., WeCoins).

FIG. 13F shows an exemplary graphical user interface 5000 of a new adult member's dashboard after a child earns placeholder/trial digital currency (e.g., WeCoins), in accordance with various embodiments. The graphical user interface 5000 includes an indicator 5002 indicating that digital currency (e.g., WeCoins) needs to be purchased and not completed indicators 5006 indicating that the task has not been completed (e.g., not yet completed or was not completed) on the associated days. In some embodiments, the graphical user interface 5000 includes a link 5004 (e.g. “Buy WeCoins”) to purchase digital currency.

FIG. 13G shows an exemplary graphical user interface 5100 of a new adult member's viewing purchase page, in accordance with various embodiments. The graphical user interface 5100 allows an adult to select digital currency to purchase. The graphical user interface 5100 may be displayed after a parent clicks the link 5004. In some embodiments, the graphical user interface 5100 may be displayed in response to an adult's (e.g., parent's) digital currency balance falling below a threshold or going to zero. In some embodiments, digital currency can be purchased at a rate of 13.3 cents with automatic purchases of additional digital currency when a user's account balance of digital currency falls below a threshold or becomes zero.

FIG. 13H shows an exemplary graphical user interface 5200 for entering payment information to purchase digital currency (e.g., WeCoins), in accordance with various embodiments. The graphical user interface 5200 may be substantially similar to the graphical user interface 1700 of FIGS. 5B-C. The graphical user interface 5200 includes a payment button or link 5202 (e.g., “Charge My Card”).

FIG. 13I shows an exemplary graphical user interface 5300 of a new adult member's dashboard after the user has purchased digital currency (e.g., WeCoins), in accordance with various embodiments. The graphical user interface 5300 may be displayed after the link 5202 has been clicked. The graphical user interface 5300 includes an entry or row 5302 indicating that the user or member purchased digital currency and further includes a link (e.g., “Info”) to view payment information.

FIG. 13J shows an exemplary graphical user interface 5400 of a new child member's dashboard after a parent has purchased digital currency (e.g., WeCoins), in accordance with various embodiments. The graphical user interface 5400 indicates that there is digital currency in the child's wallet 5402. If there is enough digital currency to have a wish fulfilled, this is indicated with a “Get Wish” button or link 5404 which allows the child to use the digital currency to purchase the associated item, ticket, etc.

FIGS. 13K-L show an exemplary graphical user interface elements for indicating how much digital currency a user has compared to the cost of an item. The progress bar 5502 indicates that the user has 50% real coins needed for the item or goodie and 20% trial coins (e.g., waiting for an adult to purchase the coins). The progress bar 5504 indicates that the user has 60% real coins needed for the item or goodie and 30% trial coins (e.g., waiting for an adult to purchase the coins). The progress bar 5506 indicates that the user has 70% real coins needed for the item or goodie and 30% trial coins (e.g., waiting for an adult to purchase the coins). Since the user does not have 100% real/spendable coins, the item or goodie cannot be purchased. The progress bar 5508 indicates that the user has 100% real coins needed for the item or goodie and the item can be purchased. For example, this can occur whether the adult (e.g., parent) finally buys real coins, or the child gets more coins from another source, once the child has 100% real/spendable coins, the child can get the item or goodie.

The progress bar 5510 indicates that the user has 0% real coins needed for the item or goodie and 70% trial coins (e.g., waiting for an adult to purchase the coins). The progress bar 5512 indicates that the user has 0% real coins needed for the item or goodie and 100% trial coins (e.g., waiting for an adult to purchase the coins). Since trial coins are not spendable until an adult buys them, the item or goodie cannot yet be redeemed. The progress bar 5514 indicates that the user has 10% real coin needed for the item or goodie and 90% trial coins (e.g., waiting for an adult to purchase the coins). It is noted that a user (e.g., kid) may start getting coins from other sources.

FIGS. 14A-F show a workflow in accordance with one or more embodiments, including a wish, shown as a “favor,” a negotiation process between a wish receiving user, shown as “receiver” and a wish granting user, shown as “provider” and “fan.”

FIG. 14A shows an exemplary table 6000 of a receiver's view, a provider's view, and a generic fan's view when a wish receivers wishes for the new favor, in accordance with various embodiments. In some embodiments, mark-offs for completing the task are not allowed until both parties accept.

FIG. 14B shows an exemplary table 6100 of a receiver's view, a provider's view, and a generic fan's view when a wish provider suggests a new favor, in accordance with various embodiments.

FIG. 14C shows an exemplary table 6200 of a receiver's view, a provider's view, and a generic fan's view when a wish receiver changes an existing favor, in accordance with various embodiments. For example, a parent may wish that a child is nice to his brother and the parent changes the favor to wish that the child is nice to his sister.

FIG. 14D shows an exemplary table 6300 of a receiver's view, a provider's view, and a generic fan's view when a wish provider changes an existing favor, in accordance with various embodiments. For example, a parent may wish that a child is nice to his brother and the child changes the favor to being nice to his sister.

FIG. 14E shows an exemplary table 6400 of a receiver's view, a provider's view, and a generic fan's view when a wish receiver retires an existing favor, in accordance with various embodiments. For example, a parent may wish that a child is nice to his brother and the parent retires the wish after the child has been nice to his brother for two months. In some embodiments, mark-offs for completing the task are not allowed after both parties agree to retire the existing favor.

FIG. 14F shows an exemplary table 6500 of a receiver's view, a provider's view, and a generic fan's view when a wish provider retires an existing favor, in accordance with various embodiments. For example, a parent may wish that a child is nice to his brother and the child retires the wish after the child has been nice to his brother for two months. In some embodiments, mark-offs for completing the task are not allowed after both parties agree to retire the existing favor.

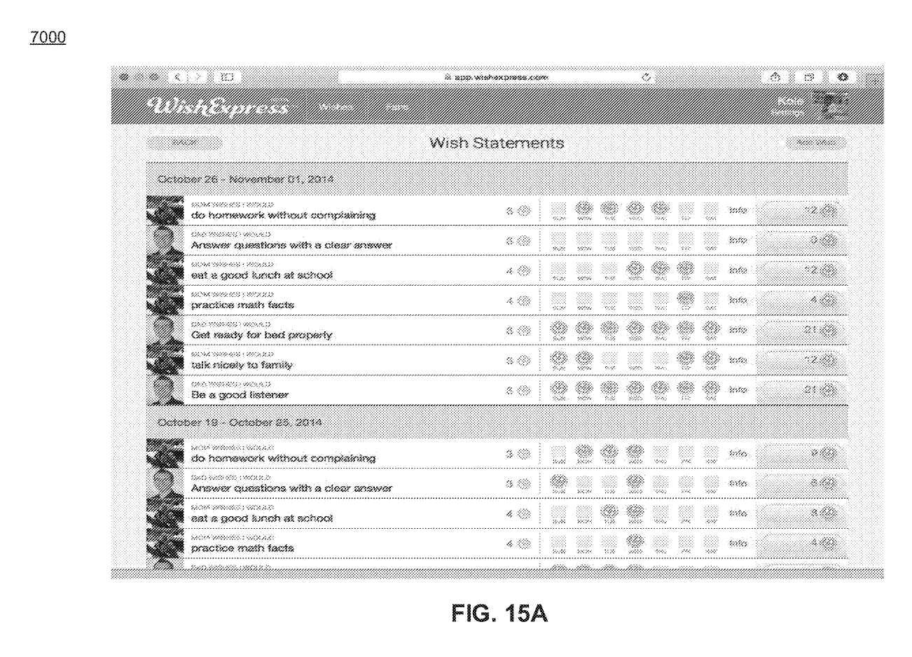

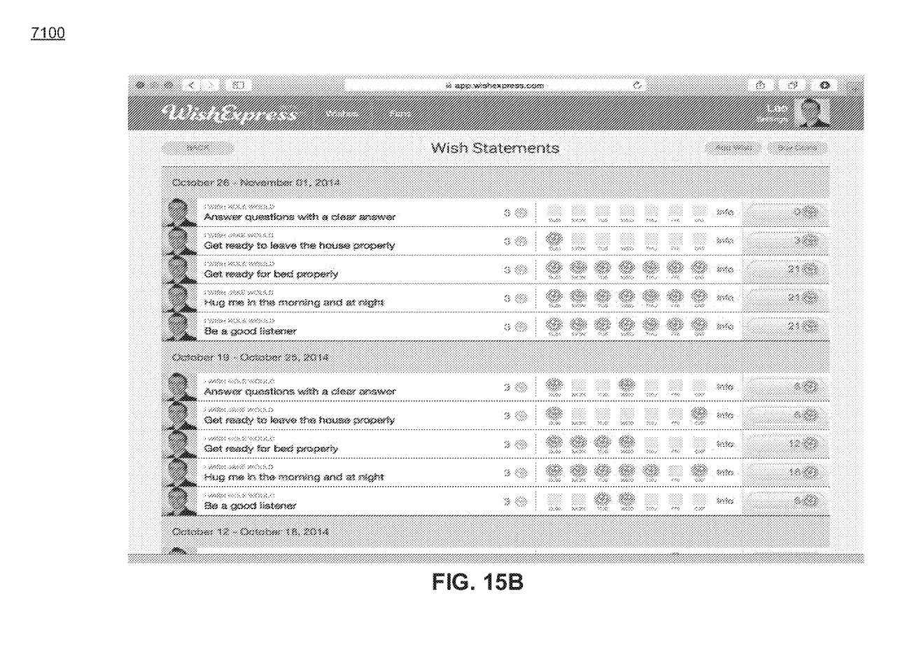

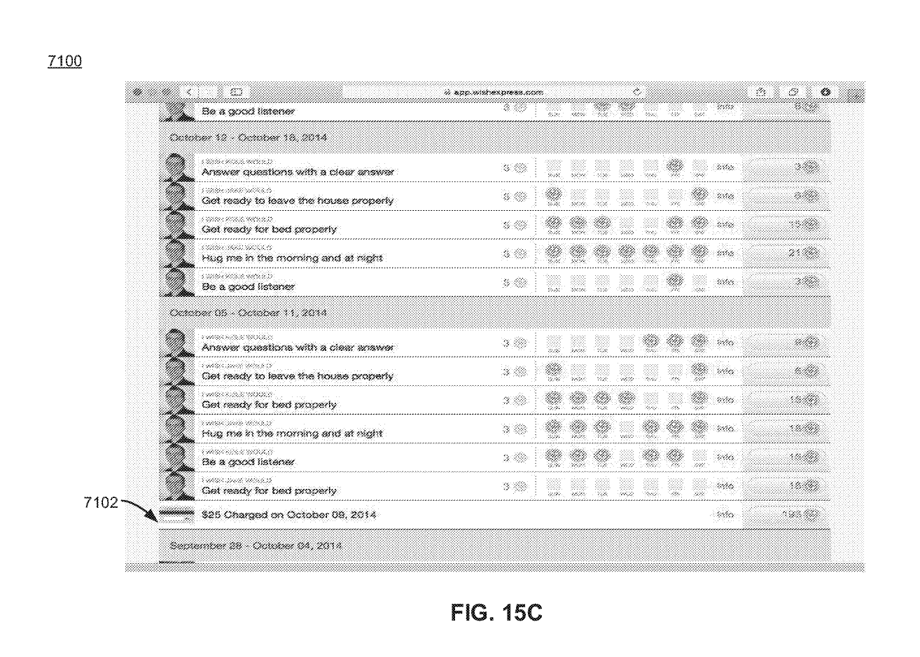

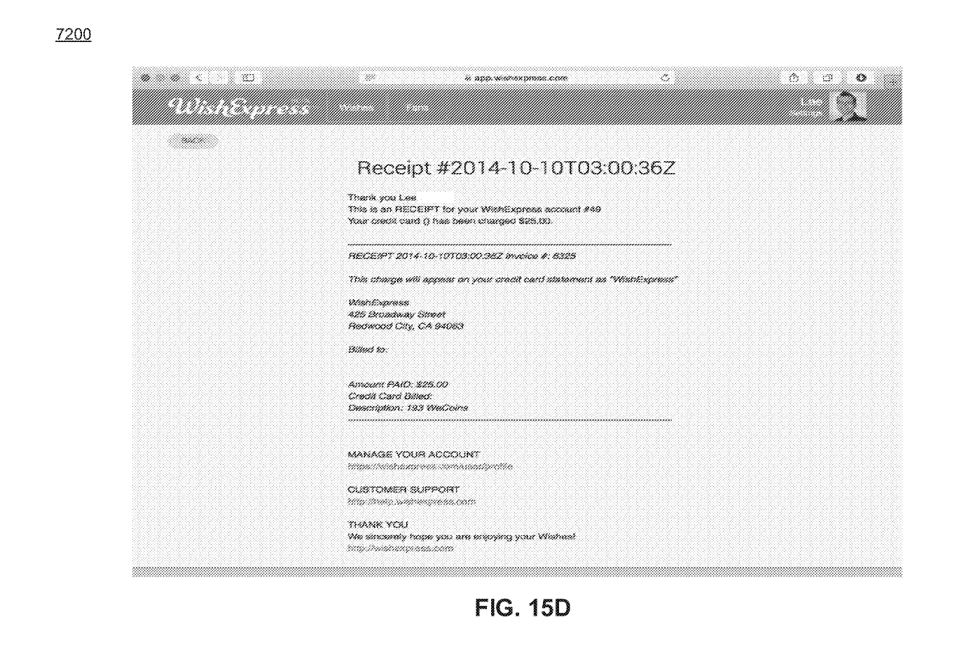

FIGS. 15A-D show user interface webpages and a workflow in accordance with one or more embodiments, including activity history.

FIG. 15A shows an exemplary graphical user interface 7000 for viewing a history of wishes (e.g., wishes provided and received), in accordance with various embodiments. FIG. 15A depicts an exemplary history of a child including wishes provided (e.g., favors or tasks completed). For example, each week, a member's history gets logged into their “Wish Statements” which is a list organized chronologically and can be (infinitely) scrollable. Each item displays, read-only, as it would on their dashboard, with “Info” link for additional details.

FIG. 15B shows an exemplary graphical user interface 7100 for viewing a history of wishes (e.g., wishes provided and received), in accordance with various embodiments. FIG. 15B depicts an exemplary history of a parent including wishes received (e.g., for favors or tasks completed by a child).

FIG. 15C shows another portion of exemplary graphical user interface 7100 including a history of wishes and a credit card charge 7102.

FIG. 15D shows an exemplary graphical user interface 7200 with credit card charge receipt information. In some embodiments, clicking on a credit card charge's “Info” link will display the receipt. This can be the same content that is emailed to the member at the time of the transaction. The “Back” button brings a user back to history pages (e.g., FIGS. 15A-C). The other text links along bottom go to associated pages.

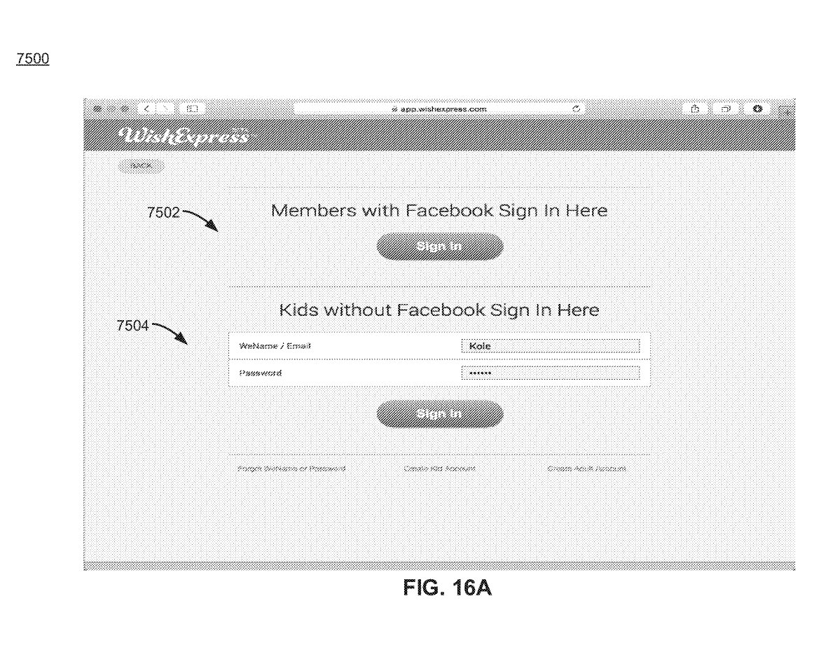

FIGS. 16A-B show user interface webpages and a workflow in accordance with one or more embodiments, including a sign in process.

FIG. 16A shows an exemplary graphical user interface 7500 for signing into a wish exchange service or system (e.g., WishExpress), in accordance with various embodiments. The exemplary graphical user interface 7500 depicts options for users with and without a social network (e.g., Facebook) account.

In some embodiments, the wish exchange service requires adults to create their account using a social network (e.g., Facebook) account. In some embodiments, there are other registration methods for adults. Kids however (17 years old and under), have the ability to create an account without a social network (e.g., Facebook) account, in addition to the option of creating an account with a social network (e.g., Facebook) account. Therefore, existing adult members (and kids with a social network account) can sign in using a top module 7504. Kids without a social network account, sign in using a lower module 7504 with the WeName/Email and Password created during registration. Prospects who have not registered yet, can create accounts by using the subordinate text links along the bottom. These links go into registration flows or processes. Existing kid members who have forgotten their credentials can recover through text link along bottom (e.g., Forgot “WeName or Password”).

FIG. 16B shows an exemplary graphical user interface 7600 for requesting a forgotten username or password, in accordance with various embodiments. Kids trying to recover their WeName or Password can do so by entering either their email in the top option 7602, or their parent's email in the bottom option 7604. There are different buttons for recovering a WeName (e.g., Get WeName) or password (e.g., “Get Password”).

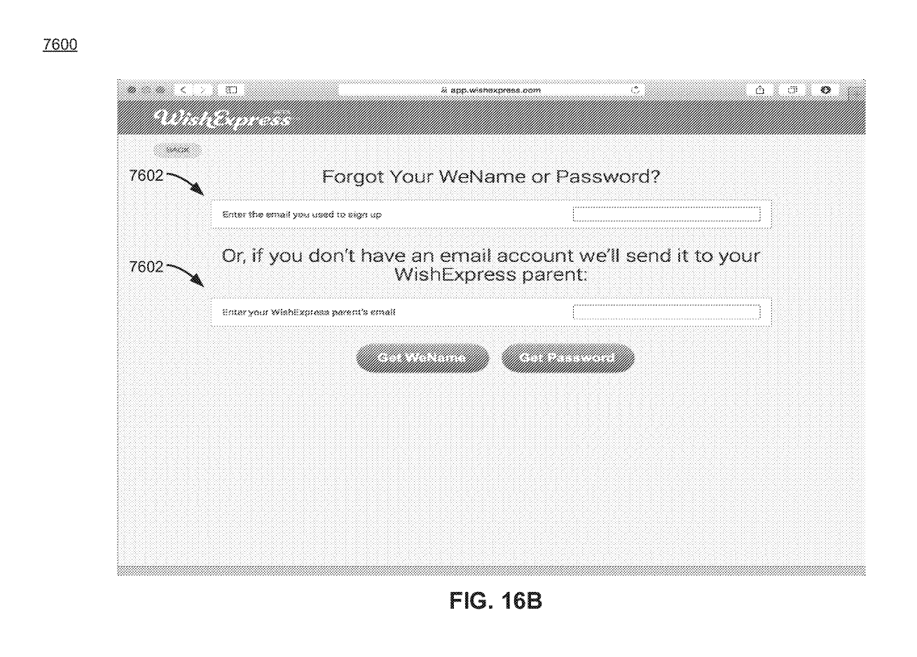

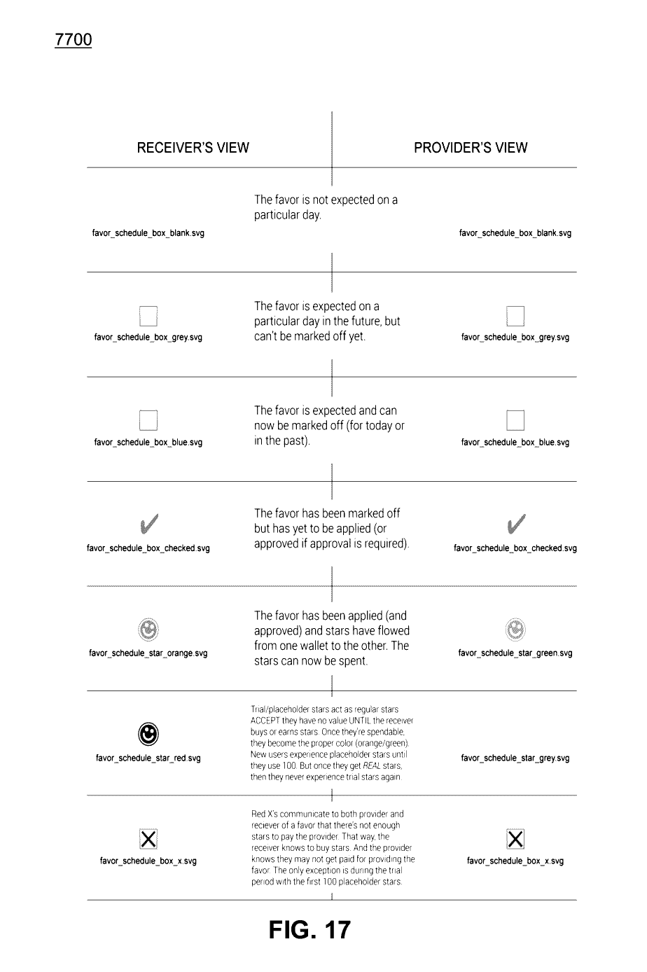

FIG. 17 shows a legend 7700 for user interface webpages in accordance with one or more embodiments, including descriptions of symbols used in user various interface webpages.

FIG. 18 shows a graphical user interface 7800 or webpage displaying curated content for the recommendation engine 20004.

Table II shows exemplary tasks and wishes having curated content and showing to which group of wish receiving users and wish granting users the wishes are applicable.

TABLE II
Exemplary tasks, wishes, and associated information

| | | adult | child | | | child | | |
|---|---|---|---|---|---|---|---|---|
| | KID LIFE-SKILLS | to | to | | adult to | to | child | adult to |
| WishCase | CATEGORY | child | adult | couples | adult | child | to self | self |
| complete a book | Academic/Betterment | x | | | | | x | x |
| finish homework | Academic/Betterment | x | | | | | x | |
| improve English grade | Academic/Betterment | x | | | | | x | |
| improve Foreign Language | Academic/Betterment | x | | | | | x | |
| grade | | | | | | | | |
| improve History grade | Academic/Betterment | x | | | | | x | |
| improve Math grade | Academic/Betterment | x | | | | | x | |
| improve Science grade | Academic/Betterment | x | | | | | x | |
| improve Social Studies grade | Academic/Betterment | x | | | | | x | |
| improve Spelling grade | Academic/Betterment | x | | | | | x | |
| read from book | Academic/Betterment | x | | | | | x | x |
| study/practice English | Academic/Betterment | x | | | | | x | |
| study/practice Foreign | Academic/Betterment | x | | | | | x | |
| Language | | | | | | | | |
| study/practice History | Academic/Betterment | x | | | | | x | |
| study/practice Math | Academic/Betterment | x | | | | | x | |
| study/practice Science | Academic/Betterment | x | | | | | x | |
| study/practice Social Studies | Academic/Betterment | x | | | | | x | |
| practice Spelling | Academic/Betterment | x | | | | | x | |
| act age | Behavior | x | | | | | x | |
| answer when spoken to | Behavior | x | | | | | x | |
| be a good listener | Behavior | x | | | | | x | x |
| be direct and speak mind | Behavior | x | | x | | | x | x |
| be home for dinner | Behavior | x | x | x | | | x | x |
| be kind to others | Behavior | x | | | | | x | x |
| be responsible | Behavior | x | | | | | x | x |
| behave properly | Behavior | x | | | | | x | |
| calm down and relax | Behavior | x | x | x | | | x | x |
| close mouth while chewing | Behavior | x | | | | | x | |
| close the door when using | Behavior | x | | | | | x | |
| bathroom | | | | | | | | |
| compliment others | Behavior | x | | | | | x | x |
| control emotions | Behavior | x | | | | | x | x |
| do what parents ask | Behavior | x | | | | | | |
| do what you're supposed to | Behavior | x | | | | | | |
| do | | | | | | | | |
| eat with utensils | Behavior | x | | | | | x | |
| encourage others | Behavior | x | | | | | x | x |
| get organized | Behavior | x | | x | | | x | x |
| get ready for school on time | Behavior | x | | | | | x | |
| go to bed on time | Behavior | x | | | | | x | x |
| hold door for others | Behavior | x | | | | | x | |
| keep hands to self | Behavior | x | | | | | x | |
| make eye contact while | Behavior | x | | | | | x | |
| talking | | | | | | | | |
| make good choices | Behavior | x | | | | | x | x |
| not be bossy | Behavior | x | | | | | x | x |
| not be late | Behavior | x | | x | | | x | x |
| not be mean | Behavior | x | | | | | x | |
| not be naughty | Behavior | x | | | | | x | |
| not be rude, crude, or | Behavior | x | | | | | x | x |
| disgusting | | | | | | | | |
| not bite people | Behavior | x | | | | | x | |
| not brag | Behavior | x | | | | | x | x |
| not call people names | Behavior | x | | | | | x | |
| not complain | Behavior | x | | | | | x | x |
| not fight with brother/sister | Behavior | x | | | | | x | |
| not get in trouble at school | Behavior | x | | | | | x | |
| not gossip | Behavior | x | | x | | | x | x |
| not hit people | Behavior | x | | | | | x | |
| not interrupt | Behavior | x | | | | | x | |
| not kick people | Behavior | x | | | | | x | |
| not make fun of people | Behavior | x | | | | | x | x |
| not play with food | Behavior | x | | | | | x | |
| not push people | Behavior | x | | | | | x | |
| not put people down | Behavior | x | | | | | x | x |
| not swear | Behavior | x | | x | | | x | x |
| not talk with food in mouth | Behavior | x | | | | | x | |
| not tease people | Behavior | x | | | | | x | x |
| not waste time | Behavior | x | | x | | | x | x |
| not whine | Behavior | x | | | | | x | |
| not yell at people | Behavior | x | | | | | x | |
| pay attention | Behavior | x | | | | | x | x |
| play nice with others | Behavior | x | | | | | | |
| play nice with brother/sister | Behavior | x | | | | | x | |
| practice good manners | Behavior | x | | | | | x | |
| respect others | Behavior | x | | | | | x | x |
| say Please and Thank You | Behavior | x | | | | | x | |
| share with others | Behavior | x | | | | | x | x |
| sit up straight | Behavior | x | | | | | x | x |
| solve problems | Behavior | x | | | | | x | x |
| spend less money | Behavior | x | | x | | | x | x |
| spend more time with family | Behavior | x | x | x | | | x | x |
| spend more time with friends | Behavior | x | | x | | | x | x |
| spend time with me | Behavior | x | | | x | | | |
| stay off brother/sister | Behavior | x | | | | | | |
| talk like a big kid | Behavior | x | | | | | x | |
| talk nicely to others | Behavior | x | | | | | x | x |
| tell the truth | Behavior | x | | | | | x | x |
| use words | Behavior | x | | | | | x | |
| wait for turn | Behavior | x | | | | | x | |
| wake up on time | Behavior | x | | x | | | x | x |
| blow nose when needed | Health + Fitness | x | | | | | x | |
| brush and floss teeth | Health + Fitness | x | | | | | x | x |
| drink plenty of water | Health + Fitness | x | | | | | x | x |
| eat all vegetables | Health + Fitness | x | | | | | x | |
| eat healthy foods | Health + Fitness | x | | x | | | x | x |
| eat less junk food | Health + Fitness | x | | x | | | x | x |
| exercise | Health + Fitness | x | | x | | | x | x |
| finish all meals | Health + Fitness | x | | | | | x | |
| finish breakfast | Health + Fitness | x | | | | | x | |
| finish dinner | Health + Fitness | x | | | | | x | |
| finish lunch | Health + Fitness | x | | | | | x | |
| get a haircut | Health + Fitness | x | | | | | x | x |
| go on a bike ride | Health + Fitness | x | | | | | x | x |
| go on a run | Health + Fitness | x | | | | | x | x |
| go on a walk | Health + Fitness | x | | | | | x | x |
| keep hands washed | Health + Fitness | x | | | | | x | |
| keep nails trimmed and clean | Health + Fitness | x | | | | | x | |
| not bite finger nails | Health + Fitness | x | | | | | x | |
| not overeat | Health + Fitness | x | | x | | | x | x |
| not pee on floor | Health + Fitness | x | | | | | | |
| not pick nose | Health + Fitness | x | | | | | x | |
| not play video games too long | Health + Fitness | x | | | | | x | x |
| not watch too much TV | Health + Fitness | x | | | | | x | x |
| play outside | Health + Fitness | x | | | | | x | |
| practice sports | Health + Fitness | x | | | | | x | x |
| shower | Health + Fitness | x | | | | | x | |
| sneeze into arm | Health + Fitness | x | | | | | x | |
| take medicine | Health + Fitness | x | | x | | | x | x |
| take vitamins | Health + Fitness | x | | x | | | x | x |
| try out for cheerleading | Health + Fitness | x | | | | x | x | |
| try out for sports | Health + Fitness | x | | | | x | x | |
| clean the attic | Helping + Independence | x | | x | | | x | x |
| clean the basement | Helping + Independence | x | | x | | | x | x |
| clean the bathroom | Helping + Independence | x | | x | | | x | x |
| clean the bedroom | Helping + Independence | x | | x | | | x | x |
| clean the counters | Helping + Independence | x | | x | | | x | x |
| clean the garage | Helping + Independence | x | | x | | | x | x |
| clean the house | Helping + Independence | x | | x | | | x | x |
| clean the living room | Helping + Independence | x | | x | | | x | x |
| clean the oven | Helping + Independence | x | | x | | | x | x |
| clean the refrigerator | Helping + Independence | x | | x | | | x | x |
| clean the shed | Helping + Independence | x | | x | | | x | x |
| clean the windows | Helping + Independence | x | | x | | | x | x |
| clean the yard | Helping + Independence | x | | x | | | x | x |
| clear table after meal | Helping + Independence | x | | x | | | x | x |
| conserve water | Helping + Independence | x | x | x | | | x | x |
| contribute to savings account | Helping + Independence | x | | | | | x | x |
| dress self | Helping + Independence | x | | | | | x | |
| dust the house | Helping + Independence | x | | x | | | x | x |
| feed and water pet | Helping + Independence | x | | | | | x | |
| give pet a bath | Helping + Independence | x | | | | | x | |
| help prepare meal | Helping + Independence | x | | | | | x | x |
| help with grocery shopping | Helping + Independence | x | | | | | x | x |
| help with laundry | Helping + Independence | x | | | | | x | x |
| help with yard work | Helping + Independence | x | | | | | x | x |
| help with younger | Helping + Independence | x | | | | | x | |
| brother/sister | | | | | | | | |
| keep bedroom clean | Helping + Independence | x | | | | | x | x |
| make bed in morning | Helping + Independence | x | | x | | | x | x |
| mop the floors | Helping + Independence | x | | x | | | x | x |
| mow lawn | Helping + Independence | x | | x | | | x | x |
| not litter | Helping + Independence | x | | | | | x | |
| plant a garden | Helping + Independence | x | | x | | | x | x |
| plant flowers | Helping + Independence | x | | x | | | x | x |
| put away groceries | Helping + Independence | x | | | | | x | |
| put away toys and things | Helping + Independence | x | | | | | x | |
| put dirty clothes in hamper | Helping + Independence | x | | x | | | x | x |
| rake the leaves | Helping + Independence | x | | x | | | x | x |
| recycle | Helping + Independence | x | x | x | | | x | x |
| reduce waste | Helping + Independence | x | x | x | | | x | x |
| replace empty toilet paper | Helping + Independence | x | | | | | x | |
| set the table | Helping + Independence | x | | x | | | x | x |
| shovel the snow | Helping + Independence | x | | x | | | x | x |
| sleep in own bed all night | Helping + Independence | x | | | | | x | |
| sweep the floors | Helping + Independence | x | | x | | | x | x |
| take out trash | Helping + Independence | x | | x | | | x | x |
| take pet outside | Helping + Independence | x | | | | | x | x |
| throw trash in garbage can | Helping + Independence | x | | | | | x | |
| trim trees and bushes | Helping + Independence | x | | x | | | x | x |
| turn off unused electronics | Helping + Independence | x | | x | | | x | x |
| turn off unused lights | Helping + Independence | x | | x | | | x | x |
| vacuum | Helping + Independence | x | | x | | | x | x |
| wash bedding | Helping + Independence | x | | x | | | x | x |
| wash the car | Helping + Independence | x | | x | | | x | x |
| wash the dishes | Helping + Independence | x | | x | | | x | x |
| water plants | Helping + Independence | x | | x | x | | x | x |
| donate toys to less fortunate | Spirit + Expression | x | | | | x | x | |
| draw | Spirit + Expression | x | | | | | x | x |
| go to church | Spirit + Expression | x | | | | | x | x |
| make a movie | Spirit + Expression | x | | x | | | x | x |
| meditate | Spirit + Expression | x | | x | | | x | x |
| overcome a fear | Spirit + Expression | x | | | | | x | x |
| paint | Spirit + Expression | x | | | | | x | x |
| practice instrument | Spirit + Expression | x | | | | | x | x |
| pray | Spirit + Expression | x | | x | | | x | x |
| sculpt | Spirit + Expression | x | | | | | x | x |
| show confidence | Spirit + Expression | x | | | | | x | x |
| try out for band | Spirit + Expression | x | | | | x | x | |
| try out for choir | Spirit + Expression | x | | | | x | x | |
| try out for debate | Spirit + Expression | x | | | | x | x | |
| try out for drama | Spirit + Expression | x | | | | x | x | |
| try out for orchestra | Spirit + Expression | x | | | | x | x | |
| try out for student government | Spirit + Expression | x | | | | x | x | |
| try out for yearbook | Spirit + Expression | x | | | | x | x | |
| committee | | | | | | | | |
| volunteer for a worthy cause | Spirit + Expression | x | x | x | x | | x | x |
| write a story | Spirit + Expression | x | | x | | | x | x |
| write in journal | Spirit + Expression | x | | | | | x | x |
| encourage me | Equity | x | | x | | | | |
| take me boating | Activity | | x | | | | | |
| take me bowling | Activity | | x | | | | | |
| take me camping | Activity | | x | | | | | |
| take me climbing | Activity | | x | | | | | |
| take me fishing | Activity | | x | | | | | |
| take me go kart racing | Activity | | x | | | | | |
| take me golfing | Activity | | x | | | | | |
| take me hiking | Activity | | x | | | | | |
| take me ice skating | Activity | | x | | | | | |
| take me on a bike ride | Activity | | x | | | | | |
| take me on a run | Activity | | x | | | | | |
| take me on a walk | Activity | | x | | | | | |
| take me on an out-of-town trip | Activity | | x | | | | | |
| take me roller skating | Activity | | x | | | | | |
| take me skiing | Activity | | x | | | | | |
| take me sledding | Activity | | x | | | | | |
| take me snowboarding | Activity | | x | | | | | |
| take me to a baseball game | Activity | | x | | | | | |
| take me to a basketball game | Activity | | x | | | | | |
| take me to a concert of my | Activity | | x | | | | | |
| choice | | | | | | | | |
| take me to a football game | Activity | | x | | | | | |
| take me to a hockey game | Activity | | x | | | | | |
| take me to a movie of my | Activity | | x | | | | | |
| choice | | | | | | | | |
| take me to a museum | Activity | | x | | | | | |
| take me to a restaurant of my | Activity | | x | | | | | |
| choice | | | | | | | | |
| take me to a soccer game | Activity | | x | | | | | |
| take me to an amusement | Activity | | x | | | | | |
| park | | | | | | | | |
| take me to get doughnuts | Activity | | x | | | | | |
| take me to get ice cream | Activity | | x | | | | | |
| take me to get my ears | Activity | | x | | | | | |
| pierced | | | | | | | | |
| take me to get my nails done | Activity | | x | | | | | |
| take me to play bocce | Activity | | x | | | | | |
| take me to play laser tag | Activity | | x | | | | | |
| take me to play miniature golf | Activity | | x | | | | | |
| take me to play paintball | Activity | | x | | | | | |
| take me to the arcade | Activity | | x | | | | | |
| take me to the beach | Activity | | x | | | | | |
| take me to the library | Activity | | x | | | | | |
| take me to the mall | Activity | | x | | | | | |
| take me to the park | Activity | | x | | | | | |
| take me to the pool | Activity | | x | | | | | |
| take me to the races | Activity | | x | | | | | |
| take me to the theater | Activity | | x | | | | | |
| take me to the zoo | Activity | | x | | | | | |
| spend quality time with kids | | | | | | | | |
| make math fun | | | | | | | | |
| make spelling fun | | | | | | | | |
| make reading fun | | | | | | | | |
| stop being obnoxious | | | | | | | | |
| practice martial arts . . . | | | | | | | | |
| take first aid class . . . | | | | | | | | |
| follow the house rules | | | | | | | | |
| learn/lessons | | | | | | | | |
| more wishful stuff | | | | | | | | |

While the invention has been described with respect to a limited number of embodiments, those skilled in the art, having benefit of this disclosure, will appreciate that other embodiments can be devised which do not depart from the scope of embodiments as disclosed herein.

### Computer System Environment

FIG. 23 shows an exemplary computer system 23000, in accordance with various embodiments. Computer system 23000 depicts the components of a basic computer system in accordance with embodiments of the present invention providing the execution platform for certain hardware-based and software-based functionality. In general, computer system 23000 comprises at least one CPU 23001, a system memory 23015, and at least one graphics processor unit (GPU) 23010. The CPU 23001 can be coupled to the system memory 23015 via a bridge component/memory controller (not shown) or can be directly coupled to the system memory 23015 via a memory controller (not shown) internal to the CPU 23001. The system memory 23015 includes wish system 23050 configured for wish management, wish exchange, wish negotiation, tracking accomplishments, wish fulfillment, etc., as described herein.

The GPU 23010 may be coupled to a display 23012. One or more additional GPUs can optionally be coupled to system 23000 to further increase its computational power. The GPU(s) 23010 is coupled to the CPU 23001 and the system memory 23015. The GPU 23010 can be implemented as a discrete component, a discrete graphics card designed to couple to the computer system 23000 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 23014 can be included for the GPU 23010 for high bandwidth graphics data storage.

The CPU 23001 and the GPU 23010 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 23010 can also be implemented in, and performed by, a suitably equipped CPU 23001. Additionally, while embodiments herein may make reference to a GPU, it should be noted that the described circuits and/or functionality can also be implemented and other types of processors (e.g., general purpose or other special-purpose coprocessors) or within a CPU.

System 23000 can be implemented as, for example, a desktop computer system or server computer system having a powerful general-purpose CPU 23001 coupled to a dedicated graphics rendering GPU 23010. In such an embodiment, components can be included that add peripheral buses, specialized audio/video components, TO devices, and the like. Similarly, system 23000 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 23000 can also be implemented as a “system on a chip”, where the electronics (e.g., the components 23001, 23015, 23010, 23014, and the like) of a computing device are wholly contained within a single integrated circuit die. Examples include a hand-held instrument with a display, a car navigation system, a portable entertainment system, and the like.

In one exemplary embodiment, GPU 23010 is operable for general-purpose computing on graphics processing units (GPGPU) computing. General-purpose computing on graphics processing units (GPGPU) programs or applications may be designed or written with the Compute Unified Device Architecture (CUDA) framework and Open Computing Language (OpenCL) framework. GPU 23010 may execute Compute Unified Device Architecture (CUDA) programs and Open Computing Language (OpenCL) programs. It is appreciated that the parallel architecture of GPU 23010 may have significant performance advantages over CPU 23001.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of fulfilling a wish, the method comprising:
receiving a request for the wish from a wish receiving user, wherein the wish has a first currency value;
sending a notification to a wish granting user of the wish;
receiving a payment for currency to be assigned to a first account, wherein the first account is associated with the wish granting user;
transferring a portion of currency from the first account to a second account associated with the wish receiving user;
determining if the second account has a currency balance that is at least one of greater than and equal to the first currency value;
in response to determining that the second account has the currency balance is at least one of greater than and equal to the first currency value, transferring an amount of the first currency value to a third account; and
sending payment associated with the wish to a supplier of the wish for fulfillment thereof.

2. The method as described in claim 1, wherein the wish is associated with a task and the associated task has a second currency value.

3. The method as described in claim 2 further comprising:
sending a notification to the wish granting user of the associated task;
receiving an indication of completion of the associated task;
sending a confirmation request associated with the completion of the associated task;
in response to receiving a confirmation of completion of the associated task, transferring another portion of the currency in an amount of the second currency value from the first account to the second account associated with the wish receiving user.

4. The method as described in claim 1, wherein the first account is associated with a parent and the second account is associated with a child.

5. The method as described in claim 1, wherein the supplier is a business and the wish is associated with an item for purchase.

6. The method as described in claim 2 further comprising:
publishing the wish and the associated task to a social network.

7. The method as described in claim 1, wherein the wish is associated with an experience.

8. The method as described in claim 3, wherein the sending of the notification of the wish and associated task to the wish granting user further comprises:
sending a request for approval of the wish and the associated task.

9. The method as described in claim 1, wherein the first value of currency is based on a tax rate, a shipping cost associated with an item, and a price of the item, wherein the item is associated with the wish.

10. The method as described in claim 1, wherein the wish supplier is capable of providing at least one of expertise, time, and guidance.

11. A system for facilitating wish fulfillment, the system comprising:
a processor;
a wish discovery engine, executing on the processor, configured to receive a wish discovery request and configured to generate in response, to the wish discovery request, a list of wishes that are available from a wish supplier, and configured to receive a wish request from the list of wishes;
a currency transaction engine, executing on the processor, configured to exchange currency, wherein the currency transaction engine is further configured to transfer currency among a plurality of users and to transfer currency from a user to a wish supplier in exchange for a wish supplier providing a wish to the user, and wherein the wish supplier is a merchant.

12. The system as described in claim 11 further comprising:
a social network component, executing on the processor, configured to receive a wish and configured to publish the wish to a social network.

13. The system as described in claim 11, wherein the user is a child and the wish supplier is an online merchant.

14. The system as described in claim 13, wherein the wish is associated with a task for completion by the child.

15. The system as described in claim 11 further comprising:
a tracking engine, executing on the processor, configured to track accomplishment of the task associated with the wish.

16. The system as described in claim 11 further comprising:
a suggestion engine, executing on the processor, configured to generate suggestions to aid and encourage desired behavior from the user.

17. The system as described in claim 11, wherein the currency transaction engine is further configured to transfer currency to the merchant based on a first amount of currency of the user being at least one of greater than or equal to a second amount of currency associated with the wish.

18. The system as described in claim 11, wherein the wish is associated with a physical item.

19. The system as described in claim 11 wherein the wish is selected from the group consisting of products, experiences, and betterments.

20. The system as described in claim 11 further comprising:
a recommendation engine, executing on the processor, configured to generate a recommended listing of wishes, wherein the listing of wishes comprises a plurality of products that the wish supplier is capable of selling.

21. The system as described in claim 11, wherein the recommendation engine is further configured to generate wish recommendations based on criteria comprising user benefit.

22. The system as described in claim 11, wherein the currency transaction engine is configured for transferring currency from the plurality of users to the user.

23. A method for tracking and fulfilling wishes, the method comprising:
receiving a request for a wish and an associated task from a wish receiving user, wherein the wish has a first currency value and the associated task has a second currency value, and wherein the wish receiving user has a plurality of wishes;
receiving a payment for currency to be assigned to a first account;
receiving an indication of completion of the associated task;
transferring a portion of the currency in an amount of the second currency value from the first account to a second account;
determining that the second account has a currency balance that is at least one of greater than and equal to a respective amount of currency associated with each of the plurality of wishes;
determining that the second account has a currency balance that is at least one of greater than or equal to the first currency value;
transferring an amount of the currency associated with the wish to a third account; and
sending payment associated with the selected wish to a merchant of an item associated with the wish for fulfillment.

24. The method as described in claim 23, wherein completion of the associated task is automatically confirmed.

25. The method as described in claim 23 further comprising:
sending a notification of the wish and the associated task to a user account associated with a parent.

26. The method as described in claim 23 further comprising:
sending a confirmation request associated with the completion of the associated task; and
in response to receiving a confirmation of completion of the associated task, performing the transferring of the portion of the currency in the amount of the second currency value from the first account to the second account.

27. The method as described in claim 23 further comprising:
determining a plurality of wishes that can be fulfilled based on the currency balance of the second account being at least one of greater than or equal to each respective currency value of each of the plurality of wishes;
sending a respective indicator for each wish of the plurality of wishes that can be fulfilled;
receiving a selected wish from the plurality of wishes that can be fulfilled;
in response to the selected wish, sending payment to the merchant for fulfillment of the selected wish.

28. A computer implemented method of fulfilling a wish, said method comprising:
a) receiving a request from a wishing user for an item, wherein said item is selected from a set of items available from a plurality of vendors, wherein said item costs a first currency value;
b) receiving an indication of a task to be performed by said wishing user for earning a second currency value, wherein said task to be performed is selected from a listing of available tasks associated with said wishing user;
c) sending an acceptance request to a supervising user indicating said item and said task;
d) responsive to a confirmation of said acceptance request, performing the following:
d1) receiving funds from an account associated with said supervising user for payment of said item;
d2) receiving indications from said wishing user that said task has been completed;
d3) responsive to a confirmation from said supervising user that said task has been completed, transferring said second currency value to an account associated with said wishing user;
d4) if said task is a reoccurring task, repeating d2) and d3) for respective task completions;
e) responsive to a sum total of currency within said account associated with said wishing user reaching said first currency value, purchasing said item for said wishing user.

29. A method as described in claim 28 wherein said e) comprises:
e1) responsive to a sum total of currency within said account associated with said wishing user reaching said first currency value, sending said wishing user a fulfillment notification that said item is available for fulfillment;
e2) responsive to a selection of said item in said fulfillment notification by said wishing user, purchasing said item for said wishing user and deducting said first currency value from said sum total.
